(19) United States
(12) Patent Application Publication
(10) Pub. No.: US 2025/0315458 A1
(43) Pub. Date: Oct. 9, 2025

(54) ANSWER ASSISTANCE COMPUTING SYSTEM

(71) Applicant: Intercom, Inc., San Francisco, CA (US)

(72) Inventors: Robert CLANCY, Dublin (IE); Fergal Charles REID, Dublin (IE); Mario KOSTELAC, Zagreb (HR); David Gerald BRODIGAN, Dublin (IE); Molly Cullen MAHAR, Haarlem (NL); Cathal Joseph HORAN, Dublin (IE); Pedro TABACOF, Dublin (IE); Pratik BOTHRA, London (GB); Fedor Alexandre PARFENOV, London (GB); Edward George Francis HELSBY, London (GB)

(21) Appl. No.: 19/174,789

(22) Filed: Apr. 9, 2025

Related U.S. Application Data
(60) Provisional application No. 63/631,973, filed on Apr. 9, 2024.

(51) Int. Cl. G06F 16/3329; G06F 16/338; G06F 16/906; G06F 16/93; G06N 5/022

(52) U.S. Cl. CPC G06F 16/3329; G06F 16/338; G06F 16/906; G06F 16/93; G06N 5/022

(57) ABSTRACT

Technology is disclosed for programmatically generate answers for a user that are responsive to aspects of a conversation, which may be occurring in near real-time. In one implementation, a conversation record is processed to determine a conversation representation and corresponding representation embedding. The representation embedding is used to determine a set of relevant passages of documents within a knowledge base. An answer-generation input instruction for a language model is generated based on the conversation representation, aspects of the relevant passages, and an answer-format instruction. The language model is directed to produce an answer output that includes accessible, passage-level citations for each portion of the answer derived from a particular passage the knowledge base, enabling a user to directly access the relevant passage. The generated answer, along with the citations, is presented via a user interface, thereby improving the efficiency and quality of user assistance.

### BACKGROUND

Customer support software is an integral component of modern business operations, providing the means for customer service agents (CSAs) to interact with customers effectively. These interactions can take place through various channels, such as live chat or telephone conversations. The primary objective of customer support software is to facilitate the resolution of customer inquiries, issues, and requests in a timely and satisfactory manner. The efficiency and quality of customer support can have a profound impact on customer satisfaction and loyalty.

In the realm of customer support, CSAs are tasked with the responsibility of providing accurate and helpful information to customers during their conversations. This requires access to a wide range of data, including product details, service policies, and customer history. The ability to quickly retrieve and convey this information is paramount to the success of the customer support process. As such, customer support software often includes features designed to assist CSAs in managing and navigating these conversations, such as searchable knowledge bases, customer interaction histories, and automated ticketing systems.

Despite the advancements in customer support software, the dynamic and often unpredictable nature of customer interactions presents ongoing challenges. Customers may present complex or novel issues that are not easily addressed through standard procedures or pre-defined responses. In these situations, CSAs are expected to exercise judgment and adaptability to meet the customer's individual needs. The effectiveness of customer support software in supporting these complex interactions is a continual area of development, aiming to enhance the CSA's ability to deliver high-quality service across all customer touchpoints.

### SUMMARY

Various aspects of the disclosed technology are directed towards systems, methods, and computer storage media that enhance the capabilities of customer support software by providing an answer assistance computing system. Embodiments of the computing system include functionality to assist users, such as customer service agents (CSAs), in delivering high-quality service by leveraging language models to process a conversation record and generate relevant answers to queries determined from the conversation record. In particular, this disclosure provides technologies to programmatically generate answers responsive to aspects of a conversation, such as a conversation between a CSA and a customer, and provide a generated answer to the CSA.

For instance, at a high level and according to one embodiment, aspects of a conversation record are processed to determine a representation of the conversation record (referred to as a conversation representation). The conversation representation is used as a query to perform a search in a knowledge base to identify a set of passages within documents of the knowledge base that are relevant to the query. The set of relevant passages is used with the conversation representation to generate a prompt instructing a language model to generate an answer responsive to the conversation representation. The prompt can include an instruction directing the language model to generate citations to be included in the answer and corresponding to portions of the answer that are derived from specific passages in the knowledge base. In some embodiments, the citations include direct links to the relevant passages corresponding to the portion of the answer generated by the passage. A representation of the answer including the citations are provided to the user, such as a CSA, via a user interface (UI) of a support software tool, such as a customer support software application. For example, the answer representation may be presented, via the UI, with the chat log or transcript of the conversation. Thus the user, such as a CSA, is presented automatically, an answer responsive to the conversation with citations and functionality enabling the user to access the passage(s) supporting the answer, thereby enhancing the transparency and trustworthiness of the information provided to a customer by the user. In this regard, the disclosed embodiments facilitate the quick retrieval of accurate and helpful information during customer interactions, which may occur through various channels such as live chat or telephone conversations.

Some embodiments of the answer assistance computing system include functionality for updating the conversation history record in near real-time during an ongoing conversation. Such embodiments allowing for the generation of updated answers as the conversation evolves. This dynamic approach ensures that users, such as CSAs, are equipped with the latest and the most relevant information, thereby improving the efficiency and quality of customer support.

This Summary is provided to introduce a selection of concepts in a simplified form that are further described below in the Detailed Description. This Summary is not intended to identify the main features or the main aspects of the disclosed subject matter, nor is it intended to be used as an aid in determining the scope of the claimed subject matter.

### BRIEF DESCRIPTION OF THE DRAWINGS

FIG. 1 depicts a diagram of an example computing system in which one or more embodiments of the present disclosure can be practiced, in accordance with various embodiments of the present disclosure;

FIG. 2 depicts an example diagram of a model implementing a specialized chatbot platform that uses language models to determine answers from knowledge bases, in accordance with various embodiments of the present disclosure;

FIG. 3 depicts an example diagram of a model implementing a start state agent of a specialized chatbot platform that uses a language model to determine answers from a knowledge base, in accordance with various embodiments of the present disclosure;

FIG. 4 depicts an example diagram of a model implementing answer search component of a specialized chatbot platform that uses language models to determine answers from knowledge bases, in accordance with various embodiments of the present disclosure;

FIG. 5 depicts an example diagram of a model implementing a feedback state agent of a specialized chatbot platform that uses a language model to determine answers from a knowledge base, in accordance with various embodiments of the present disclosure;

FIG. 6A provides an example chat interface between a chatbot and a user, in accordance with embodiments of the present disclosure;

FIG. 6B provides an example chat interface between a chatbot and a user showing the delivery of responses word by word from the chatbot to the user, in accordance with embodiments of the present disclosure;

FIG. 6C provides an example chat interface between a chatbot and a user showing a response from the chatbot with a corresponding source of the response, in accordance with embodiments of the present disclosure;

FIG. 6D provides an example chat interface between a chatbot and a user showing responses from the chatbot including a request for feedback, request for clarification, and a response with a prompt to route to a human, in accordance with embodiments of the present disclosure;

FIG. 6E provides an example chat interface between a chatbot and a user showing a response from the chatbot that routes the chat with the user to a human, in accordance with embodiments of the present disclosure;

FIG. 6F depicts an example diagram of a specialized chatbot platform facilitating the handling of multimedia input in the end-user input, in accordance with various embodiments of the present disclosure;

FIG. 6G depicts an example diagram of a specialized chatbot platform facilitating the handling of multimedia input in the ingested content, in accordance with various embodiments of the present disclosure;

FIG. 6H depicts another example diagram of a specialized chatbot platform facilitating the handling of multimedia input in the end-user input, in accordance with various embodiments of the present disclosure;

FIG. 6I depicts an example diagram of a specialized chatbot platform facilitating the augmenting of the user context utilizing data from external systems, in accordance with various embodiments of the present disclosure;

FIG. 7A provides an example interface of a customer support application, including, among other things, an inbox and a chat interface, in accordance with embodiments of the present disclosure;

FIG. 7B provides an example chat interface of a customer support application, including an AI-assisted chat tool, in accordance with embodiments of the present disclosure;

FIG. 7C provides an example chat interface of a customer support application implementing the AI-assisted chat tool on the chat interface of FIG. 7B, in accordance with embodiments of the present disclosure;

FIG. 7D provides an example chat interface of a customer support application implementing an AI-assisted chat tool to search for answers in knowledge base using a language model, in accordance with embodiments of the present disclosure;

FIG. 7E provides an example interface for adding a conversational snippet from a communication record to a knowledge base, in accordance with embodiments of the present disclosure;

FIG. 8A provides an example interface of a chatbot tool of a customer support application, in accordance with embodiments of the present disclosure;

FIG. 8B provides an example interface of an audience selection tool of a chatbot tool of a customer support application, in accordance with embodiments of the present disclosure;

FIG. 8C provides another example interface of an audience selection tool of a chatbot tool of a customer support application, in accordance with embodiments of the present disclosure;

FIG. 8D provides an example interface of a content management tool of a chatbot tool of a customer support application, in accordance with embodiments of the present disclosure;

FIG. 8E provides an example interface of a communication channel selection tool of a chatbot tool of a customer support application, in accordance with embodiments of the present disclosure;

FIG. 8F provides an example interface of a chatbot behavior settings tool of a chatbot tool of a customer support application, in accordance with embodiments of the present disclosure;

FIG. 8G provides another example interface of a chatbot behavior settings tool of a chatbot tool of a customer support application, in accordance with embodiments of the present disclosure;

FIG. 8H provides an example interface of a custom answers tool of a chatbot tool of a customer support application, in accordance with embodiments of the present disclosure;

FIG. 8I provides an example interface of a chatbot introduction customization tool and a language settings tool of a chatbot tool of a customer support application, in accordance with embodiments of the present disclosure;

FIG. 8J provides an example interface of a chatbot identity customization tool of a chatbot tool of a customer support application, in accordance with embodiments of the present disclosure;

FIG. 8K provides an example interface of a scheduling tool of a chatbot tool of a customer support application, in accordance with embodiments of the present disclosure;

FIG. 8L provides an example interface of a chat workflow design tool of a chatbot tool of a customer support application for setting up a handover from the chatbot to human support, in accordance with embodiments of the present disclosure;

FIG. 8M provides another example interface of a chat workflow design tool of a chatbot tool of a customer support application for setting up a handover from the chatbot to a chat workflow, in accordance with embodiments of the present disclosure;

FIG. 8N provides another example interface of a chat workflow design tool of a chatbot tool of a customer support application for designing a chat workflow, in accordance with embodiments of the present disclosure;

FIG. 8O provides another example interface of a chat workflow design tool of a chatbot tool of a customer support application for designing a chat workflow that implements the chatbot at a later block in the chat workflow instead of an initial block of a chat workflow, in accordance with embodiments of the present disclosure;

FIG. 8P provides an example interface of an inactive conversations settings tool of a chat workflow design tool of a chatbot tool of a customer support application for designing a chat workflow, in accordance with embodiments of the present disclosure;

FIG. 8Q provides an example chat interface between a chatbot and a user showing a request for feedback, in accordance with embodiments of the present disclosure;

FIG. 8R provides an example interface of output from a chatbot analysis tool of a chatbot tool of a customer support application, in accordance with embodiments of the present disclosure;

FIG. 8S provides another example interface of output from a chatbot analysis tool of a chatbot tool of a customer support application, in accordance with embodiments of the present disclosure;

FIG. 8T provides another example interface of a chatbot analysis tool of a chatbot tool of a customer support application, in accordance with embodiments of the present disclosure;

FIG. 8U provides another example interface of output from a chatbot analysis tool of a chatbot tool of a customer support application, in accordance with embodiments of the present disclosure;

FIG. 8V provides another example interface of output from a chatbot analysis tool of a chatbot tool of a customer support application, in accordance with embodiments of the present disclosure;

FIG. 8W provides another example interface of output from a chatbot analysis tool of a chatbot tool of a customer support application, in accordance with embodiments of the present disclosure;

FIG. 8X provides another example interface of output from a chatbot analysis tool of a chatbot tool of a customer support application, in accordance with embodiments of the present disclosure;

FIG. 8Y provides another example interface of output from a chatbot analysis tool of a chatbot tool of a customer support application, in accordance with embodiments of the present disclosure;

FIG. 9 is a flow diagram showing a method for implementing a specialized chatbot platform that uses language models to determine answers from knowledge bases, in accordance with embodiments of the present disclosure;

FIG. 10 is a flow diagram showing a method for implementing a chatbot using a language model to determine a subset of documents from a knowledge base in response to a user's query, in accordance with embodiments of the present disclosure;

FIG. 11 is a flow diagram showing a method for implementing a specialized chatbot platform that uses language models to determine answers from knowledge bases and handing off the conversation to a human, in accordance with embodiments of the present disclosure;

FIG. 12 is a flow diagram showing a method for implementing a specialized chatbot platform that uses language models to determine answers from knowledge bases based on customer data of the user, in accordance with embodiments of the present disclosure;

FIG. 13 is a flow diagram showing a method for using a language model to extract conversational snippets, in accordance with embodiments of the present disclosure;

FIG. 14 is a flow diagram showing a method for implementing an answer assistance computing system by programmatically generating answers for a user that are responsive to aspects of a conversation, and to provide the generated answer to the user, in accordance with an embodiment of the present disclosure;

FIG. 15 is a block diagram of a language model that uses particular inputs to make particular predictions, in accordance with an embodiment of the present disclosure; and

FIG. 16 is a block diagram of an example computing device in which embodiments of the present disclosure can be employed.

### DETAILED DESCRIPTION

The present disclosure relates to an answer assistance computing system that is integrated with customer support software to enhance the quality and efficiency of customer service interactions. In particular, this disclosure provides technologies to programmatically generate answers for a user, such as a CSA, that are responsive to aspects of a conversation, such as a conversation between the CSA and a customer, and to provide the generated answer to the CSA. As further described herein, in various embodiments, the answer is generated to include citations corresponding to particular portions of the answered and indicating a passage within a document of a knowledge base that is used to generate that portion of the answer. In some implementations, the citations may include links directly to the passages of the document, rather than the document itself. In this way, these embodiments of the answer assistance computing system provide an answer that is responsive to the conversation with citations and functionality enabling the user to access the passage(s) supporting the answer, thereby enhancing the transparency and trustworthiness of the information provided to a customer by the user.

According to one embodiment, a conversation record or conversation history is accessed. The conversation history comprises a data file that is a text record of a conversation, which may be occurring in near-real time. For example, as a CSA is communicating with a customer, the chat log or transcript of the discussion is created and comprises a conversation history record. The conversation history may be determined from a chat log or chat history of a chat session or by using automatic speech recognition, such as a speech-to-text software utility on audio information of the communication, such as from a customer who is speaking with a CSA over a phone call.

From this conversation history record, a conversation representation is generated, which serves as a distilled summary and context of the conversation, or a set of one or more extracted queries that encapsulate the customer's issues or questions. In some implementations, the conversation representation is generated using a language model, such as a large language model (LLM) for instance, GPT 3.5 Turbo, or using a small language model. The language model is provided as an input, a portion of the conversation history record and an issue summarization prompt. Issue summarization prompts are designed to instruct a language model in summarizing complex topics, discussions, or content into a concise and coherent summary. In one embodiment, the portion of the conversation history includes recent conversation parts, such as the back-and-forth messages exchanged in the conversation; for instance, some implementations determine and use the five most recent conversation parts to determine the conversation representation.

After the conversation representation is generated, it is used to generate an embedding, referred to as a representation embedding. The embedding captures the semantic essence of the conversation representation in a vector space that enables a computation of similarity of the representation embedding with other text embeddings. In this way, other texts, including passages within documents of a knowledge base, can be identified that are relevant to the conversation representation based on a similarity comparison of corresponding embeddings. Some implementations use Sentence Bidirectional Encoder Representations from Transformers (SBERT) to generate the embedding.

Continuing this example, a knowledge base is accessed to identify information relevant to the conversation representation for use to generate an answer responsive to the conversation representation. In various implementations, the knowledge base comprises a repository of documents each containing one or more passages that may be relevant to queries of the conversation representation. For example, documents in the knowledge base can include, without limitation, help center information, such as technical documentation, user manuals, FAQs, policy documents, product guides; internal documentation; conversation histories or portions thereof, which may include portions of past conversations or summaries of conversations between a user, such as a CSA, and a customer regarding an issue and its resolution; other information specifically curated for the knowledge base, and other information sources potentially relevant for addressing customer queries. In some instances, a document may comprise a plurality of related files or electronic documents, as well as multimedia content.

In certain embodiments, documents in the knowledge base can include excerpts of conversation histories or portions thereof that are extracted by a language model, referred to herein as “conversation excerpts.” In some implementations, in order to generate each conversation excerpt, the language model is provided as an input, a past conversation history, such as a past conversation record between a CSA and a customer, an issue identification prompt, and a source identification prompt. Issue identification prompts are designed to instruct a language model to identify questions and/or issues from a conversation history record, such as unique questions and/or issues presented by the customer to the CSA and a corresponding response from the CSA to the customer. Source identification prompts are designed to instruct a language model to identify the portion of the conversation history, such as the message from the customer that includes the question and the subsequent message from the CSA providing a response to the customer's question. In this regard, for each question and/or issue identified from each conversation history record by the language model, the identified portions of the conversation histories can be stored as a corresponding conversation excerpt. For example, the conversation excerpt can include the message from the customer that includes the question and the subsequent message from the CSA providing a response to the customer's question, so that past messages can be used to answer future questions from customers.

In preparation for use within the system of this example, these documents are segmented into discrete units or chunks known as passages. Each passage, typically 100 words or more, is designed to represent a self-contained piece of information that can be utilized to address potential customer queries. This segmentation facilitates the system's ability to efficiently parse and match relevant content to the specific issues raised during customer service interactions. Accordingly, a particular information source can be ingested into the knowledge base by determining one or more passages of text associated with the information source. In some instances, the information source is a text document, and text associated with the document is determined and used to generate the passages. In other instances the information source may comprise other non-textual formats, such as multimedia, and a textual summary or textual description of the source is first generated or determined. The textual summary or description is then segmented to determine passages for the information source. For example, in one implementation, an LLM trained on multimedia content, such as video or images, is programmatically employed to generate a textual description of an information source that comprises multimedia or image content. The textual description can then be segmented in to passages that are associated with the information source.

For each document in the knowledge base, an embedding is computed for the passages of the document thereby allowing for the computation of semantic similarity between embeddings. In this way, passage embeddings may be compared to representation embeddings to determine passages that are semantically relevant to a conversation representation. Accordingly, a query is performed on the knowledge base to determine a set of passages that are relevant to a conversation history record by determining a set of passages in the knowledge base that have corresponding passage embedding that are similar to the representation embedding corresponding to the conversation representation. In particular, the set of the passages that are relevant to the conversation representation may be determined by computing a semantic similarity of the representation embedding to an embedding corresponding to each of the passages of the documents in the knowledge base. Those passages that are sufficiently relevant, such as satisfying a threshold of similarity, are included in the set of passages. In some implementations, all of the passages are ranked for similarity and only the top certain number of passages, corresponding to the most relevant passages, are included in the set of passages relevant to the conversation representation. For instance, the set of passages may comprise forty-five passages that are ranked in order of similarity, representing relevance, to the conversation the conversation representation. In some implementations, the similarity comparison is performed using the model msmarco-distilbert-base-tas-b if the language corresponding to the embeddings is English and Multilingual-e5-base for other languages.

Continuing with this example embodiment, the relevant passages are then used to generate a prompt for a language model, instructing it to produce an answer output that is responsive to the conversation representation. In some implementations, prior to this, the set of relevant passages is programmatically pruned according to the limitations of the language model. For instance, a programmatic pruning process may be performed automatically to determine the first number of N source documents that contain the passages with the highest relevance to the conversation representation. The value of N may be set to 15, for instance, which would comprise identifying the top 15 source documents with the corresponding high-ranking passages in regards to relevance to the conversation representation. However, N could also be 10, 20, or another number, depending on the implementation or the characteristics of the language model in use. In some implementations, a document relevance is determined for each of the documents and used for determining the number of N documents most relevant to the conversation representation. For example, for each document having passages in the set of passages relevant to the conversation representation, the relevance of the document to the conversation representation is determined based on the relevance of each passage within the document that is in the set of passages.

Additionally or alternatively, in some implementations, prior to using the set of relevant passages (or a subset of these following pruning), to generate the prompt for the language model, the set of relevant passages, or the passages corresponding to the number of N documents, are used to generate document-passage groupings. A document-passage grouping indicates a document and each passage of the document that is in the set of relevant passages. For example the indication may comprise a document ID and a passage ID or index number from an index of passages for the document. Thus in instances having a number of N documents that have the passages with the highest relevance to the conversation representation, there will be N document-passage groupings, comprising a grouping of the relevant passages for each document.

Next, an answer-generation input instruction is programmatically generated and provided to a language model, such as an LLM, to cause the language model to produce an answer output. In various embodiments, the answer-generation input instruction is generated using one or more of: (a) the conversation representation, (b) the relevant document-passage groupings, or a portion of the relevant document-passage groupings), and (c) an answer-format instruction. For example, the answer-generation input instruction instructs the language model to use the document-passage groupings (or a portion of the document-passage groupings) to generate an answer output that is responsive to the conversation representation (such as a query in the conversation representation) and based on the answer-format instruction. In some embodiments, answer-generation input instruction logic is used to generate the answer-generation input instruction. The answer-generation input instruction logic can include computer instructions, programming routines, rules, or templates used for generating the answer-generation input instruction.

In some implementations, the number of relevant document-passage groupings included in the answer-generation input instruction is based on a target token length corresponding to the language model. Thus, the number of document-passage groupings may be limited so that only the document-passage groupings having the most relevant passages are included based on the target token length. Accordingly, document-passage groupings having less relevant passages may be excluded from the answer-generation input instruction, if the target token length is small. In some implementations, the target token length is determined using an LLM tokenizer configured for the language model.

The answer-format instruction is programmatically determined to direct the language model to format aspects of the answer output according to the format instruction, and may include instructions to integrate citations within the answer output. In particular, some implementations of the answer-format instruction instruct the language model to include, in the answer output, a corresponding citation for each portion of the answer output that is generated using a particular passage, from the document-passage groupings. A citation corresponds to at least a portion of the answer output, such as a sentence or a paragraph in the answer output, and indicates the passage used to generate the corresponding portion of the answer output. A citation also may indicate the document that includes the indicated passage. For example, the citations may occur within the answer output following each portion of the answer output corresponding to the citation, or the citations may generated as footnotes or endnotes of the answer output.

In some implementations, the answer-format instruction provides that each citation include a direct link to the location of its indicated passage in a document. That is, in these implementations, the citation does not merely link to the document that has the indicated passage, but the citation links directly to the passage within the document. For example, the direct link may comprise an anchor link, hyperlink, a URL, pointer, or similar link.

Further, some implementations of the answer-format instruction instruct the language model to include, in a citation, source information regarding the cited document. Source information includes information about the document, for example and without limitation, information regarding the type of document (e.g., a conversation record or snippet of a conversation, help center documentation, internal documentation, log, etc.); a creation date of the document; a last modification date of the document indicating how recently the document was updated; whether the document is internal to the user (for example, the CSA) or accessible to a customer, or publicly accessible; an indication of the number of times the document has been previously cited in past answer outputs, which may be used to determine that a particular document is used often for generating answers; or a CSA user feedback rating based on prior occurrences of the document's passages in past answer outputs. In this way, the citations serve to indicate the information about source of the information used to generate the answer output, thereby enhancing the transparency and trustworthiness of the generated answer.

Continuing with this example embodiment, the generated answer-generation input instruction is provided as an input prompt to the language model. In response, the language model provides an output comprising an answer output. The answer output is received from the language model and processed to determine a representation of the answer (referred to as an answer representation) that can be provided, via a user interface (UI), to the user. For example, the answer output may be presented via a graphical user interface to a CSA.

In some implementations, the answer output further includes visualization instructions for presenting the answer representation via a UI. Further, some implementations of the UI comprise a first UI element presenting aspects of the conversation history, which may comprise the transcript of an ongoing conversation, and a second UI element for presenting the answer representation. In some instances, the second UI element is positioned proximate the first UI element so that a user (for example a CSA) can view and interface with the conversation and also view the answer representation including citations, thereby enabling the user to access the passages that are indicated by the citations.

In some implementations, the process of generating and providing an answer representation to a user, such as a CSA, based on a conversation history record is continuously updated as the conversation continues. In this way, the user may be continuously presented with an answer representation that is relevant to the current conversation with a customer. For instance, as the conversation evolves and new, more recent conversation parts are added to the conversation history, those more recent conversation parts are used to ultimately determine a new answer representation.

Some embodiments of the answer assistance computing system technology disclosed herein are implemented on a chatbot platform. Chatbots are a useful tool to help customer support teams. For example, chatbots can include rules to route users to correct units of customer support/success organizations. As another example, chatbots can directly handle simple user queries based on explicit rules where a specific intent (e.g., a distinct user goal or request in the query) can be identified in the query.

### Overview of Technical Problems, Technical Solutions, and Technological Improvements

Generally, and at a high level, embodiments described herein facilitate programmatically implementing a specialized answer assistance computing system that uses language models to generate answers from semantically similar passages of documents of knowledge bases. In this regard, embodiments described herein facilitate using a language model to determine aspects of a conversation with a user in order to compute the semantic similarity of the conversation to answers determined from passages of documents of a knowledge base (e.g., manually curated files, historical conversation files, extracted snippets from conversations, Uniform Resource Locators (“URLs”), and/or any other data within a knowledge base). For example, aspects of a conversation, such as a query occurring within the conversation or a summary of the conversation or portions thereof, can be programmatically identified and extracted from conversations between a user (e.g., an existing customer, a potential customer or any individual providing questions to customer support) and a chatbot. The similarity of sentence embeddings between the aspects of the conversation and sentences of documents in the knowledge base can be computed in order to determine whether the answer within a threshold semantic similarity is provided in a document in the database. A language model can then utilize the semantically similar document(s) in the database to generate an answer to the user query, which may be provided to the user or provided through a chatbot.

Advantageously, efficiencies of computing and network resource utilization can be enhanced using implementations described herein. In particular, embodiments of an answer assistance computing system that utilize a language model to generate an answer that is responsive to the conversation with citations and functionality enabling a user to access the passage(s) supporting the answer, provides for a more efficient use of computing and network resources than conventional methods of manually accessing knowledge base information, searching for relevant information in the knowledge base, which may require iterative searching, and manually adapting, from the search results, an answer to be suitable for a context of the conversation. The technology described herein decreases the number of computer input/output operations related to manually intensive operations, thereby decreasing computation costs and decreasing network resource utilization (e.g., higher throughput, lower latency, and decreasing packet generation costs due to fewer packets being sent) when the information is located over a computer network.

Further, embodiments of the technologies disclosed herein improve upon existing customer support software by addressing the dynamic and unpredictable nature of customer interactions. In particular, some of these embodiments enable CSAs to adapt to complex or novel issues that arise during conversations by providing them with contextually appropriate answers generated from the knowledge base, and direct-to-passage citations to confirm the generated answer, understand the context of the information source(s) used to generate the answer, or drill down for additional, relevant information. Accordingly, embodiments of the technology not only streamline the information retrieval process, by reducing inefficiency, but also enhance the transparency and reliability of the support provided.

Furthermore, some embodiments of the technologies operate on conversation histories to generate conversation representations for a query, rather than using a single manually provided statement of an issue (which may need to be provided by a CSA or customer) to generate the query. In this way, embodiments of the technologies disclosed herein, particularly those embodiments that use a language model to generate the conversation representation, are more robust and capable of providing relevant information when the query is not fully framed.

Additionally, some embodiments include functionality for updating the conversation history in real-time, allowing for the iterative refinement of answers as the conversation progresses, thereby ensuring that users, such as CSAs, can maintain an effective and satisfactory dialogue with customers.

### Additional Description of the Embodiments

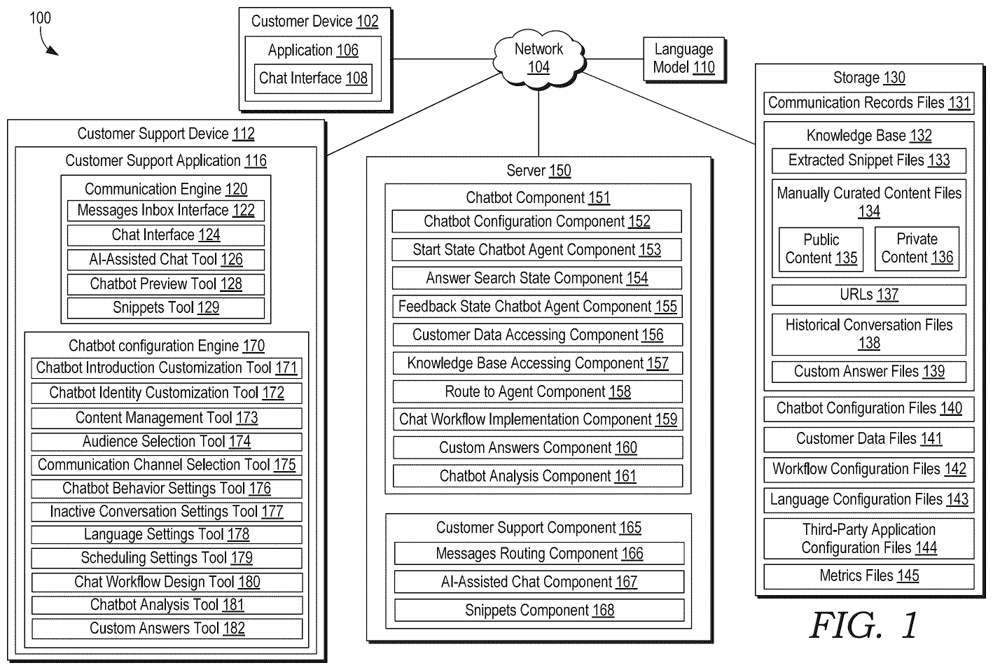

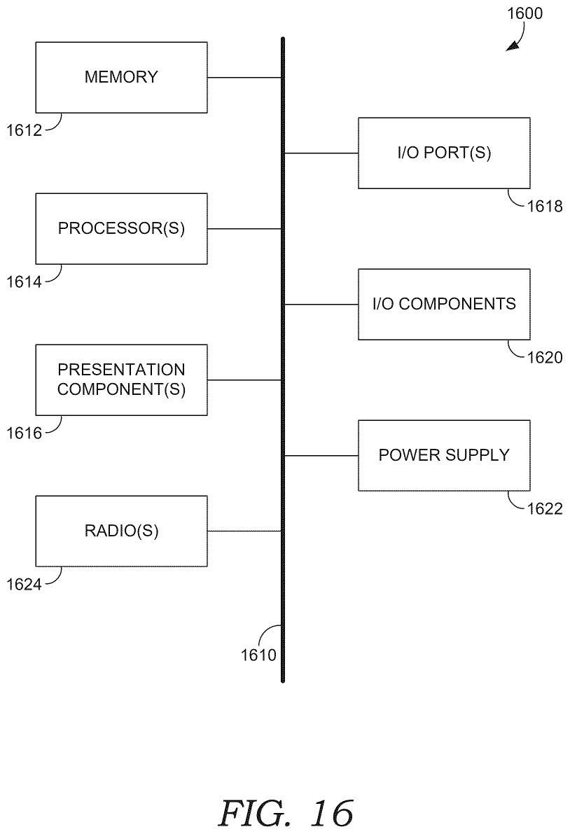

Turning to FIG. 1, a block diagram of example environment 100 suitable for use in implementing embodiments of the disclosure is shown. Generally, environment 100 is suitable for, among other things, facilitating conversations between a customer (e.g., an existing customer, a potential customer or any individual providing questions to customer support), a chatbot (e.g., as implemented by chatbot component 151) and/or a CSA (e.g., or any support personnel), facilitating configuration of a chatbot for communication with customers, facilitating configuring a knowledge base of the chatbot, facilitating the design of chat workflows for customers, and facilitating the analysis of chatbot conversations. Environment 100 includes customer device 102, customer support device 112, and server 150. In various embodiments, customer device 102, customer support device 112, and/or server 150 are any kind of computing device, such as computing device 1600 described below with reference to FIG. 16. Examples of computing devices include a personal computer (PC), a laptop computer, a mobile or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, some combination thereof, or any other suitable computer device.

In various implementations, the components of environment 100 include computer storage media that stores information including data, data structures, computer instructions (e.g., software program instructions, routines, or services), and/or models (e.g., machine learning models) used in some embodiments of the technologies described herein. For example, in some implementations, customer device 102, customer support device 112, language model 110, server 150, and/or storage 130 may comprise one or more data stores (or computer data memory). Further, although customer device 102, customer support device 112, server 150, language model 110, and storage 130 are each depicted as a single component in FIG. 1, in some embodiments, customer device 102, customer support device 112, server 150, language model 110, and/or storage 130 are implemented using any number of data stores, and/or are implemented using cloud storage.

The components of environment 100 communicate with each other via a network 104. In some embodiments, network 104 includes one or more local area networks (LANs), wide area networks (WANs), and/or other networks. Such networking environments are commonplace in offices, enterprise-wide computer networks, intranets, and the Internet.

In the example illustrated in FIG. 1, customer device 102 includes application 106, customer support device 112 includes customer support application 116, and server 150 includes chatbot component 151 and customer support component 165. In various embodiments, application 106, customer support application 116, chatbot component 151, customer support component 165, and/or any of the elements illustrated in FIG. 1 are incorporated, or integrated, into an application(s) (e.g., a corresponding application on customer device 102, customer support device 112, and/or server 150, respectively), or an add-on(s) or plug-in(s) to an application(s). In some embodiments, the application(s) 106 and/or 116 is any application capable of facilitating a chat between a customer, a chatbot (e.g., chatbot component 151), and/or a CSA, such as a standalone application, a mobile application, a web application, and/or the like. In some implementations, the application(s) 106 and/or 116 comprises a web application, for example, that may be accessible through a web browser, hosted at least partially server-side, and/or the like.

In various embodiments, the functionality described herein is allocated across any number of devices. In some embodiments, application(s) 106 and/or 116 are hosted at least partially server-side, such that chat interface 108, communication tool 120, chatbot tool 170, chatbot component 151, customer support component 165, and/or any of the elements illustrated in FIG. 1 coordinate (e.g., via network 104) to perform the functionality described herein. In another example, communication tool 120, chatbot tool 170, chatbot component 151, customer support component 165, and/or any of the elements illustrated in FIG. 1 (or some portion thereof) are integrated into a common application executable on a single device. Although some embodiments are described with respect to an application(s), in some embodiments, any of the functionality described herein is additionally or alternatively integrated into an operating system (e.g., as a service), a server (e.g., a remote server), a distributed computing environment (e.g., as a cloud service), and/or otherwise. These are just examples, and any suitable allocation of functionality among these or other devices may be implemented within the scope of the present disclosure.

An example workflow of the configuration illustrated in FIG. 1 includes customer device 102, such as a desktop, laptop, or mobile device such as a tablet or smart phone, and application 106 provides one or more user interfaces. A customer accesses application 106, such as a web browser or mobile application, and navigates to a website or application of a business. The customer navigates to a chat interface 108 through application 106 allowing the customer to chat with a chatbot and/or customer support of the business. In this regard, the customer is able to communicate with the business, such as through a chatbot associated with the business via chatbot component 151 and/or a CSA of the business (e.g., where the CSA utilizes a corresponding chat interface 124 of the customer support device 112). In some embodiments, the chat interface 108 of application 106 may be implemented through an application programming interface (API), software development kit (SDK), webhooks, and/or the like of chatbot component 151 and/or customer support component 165. In some embodiments, chat interface 108 is an application, such as a React.js application, that is embedded into application 106.

Customer support device 112 is a desktop, laptop, or mobile device such as a tablet or smart phone, and application 116 provides one or more user interfaces. In some embodiments, an end user, such as a CSA of the business, chats, or accesses a chat (e.g., a conversation with the customer), with a customer through chat interface 124 of communication tool 120. Additionally or alternatively, a chatbot via chatbot component 151 chats, or accesses a chat (e.g., a conversation) with a customer through chat interface 108 of application 106 and an end user, such as a CSA of the business, chats, or accesses a chat between the chatbot and the customer through chat interface 124 of communication tool 120.

In some embodiments, chatbot component 151 facilitates programmatically implements a specialized chatbot platform that uses language models to determine answers from semantically similar documents of knowledge bases. For example, chatbot component 151 facilitates using a language model 110 to determine aspects of a conversation with a user in order to compute the semantic similarity of the conversation to answers provided in documents of a knowledge base 132 (e.g., extracted snippet files 133, manually curated files 134, such as public content 135 and/or private content 136, URLs 137, historical conversation files 138, and/or the like) and provide responses to the customer through chat interface 108.

In some embodiments, chatbot component 151 facilitates providing multimodal responses to the customer through chat interface 108. For example, chatbot component 151 facilitates using language model 110 as a multimodal language model to determine semantically similar images, audio, and/or video provided in documents of a knowledge base 132 (e.g., images, audio, and/or video stored in extracted snippet files 133, manually curated files 134, such as public content 135 and/or private content 136, URLs 137, historical conversation files 138, and/or the like). In another example, chatbot component 151 facilitates providing responses that include images, audio, and/or video that are included in the semantically similar answers of documents of a knowledge base 132. In another example, chatbot component 151 can provide responses that include images, audio, and/or video, generated by language model 110 where the language model is a multimodal generative language model.

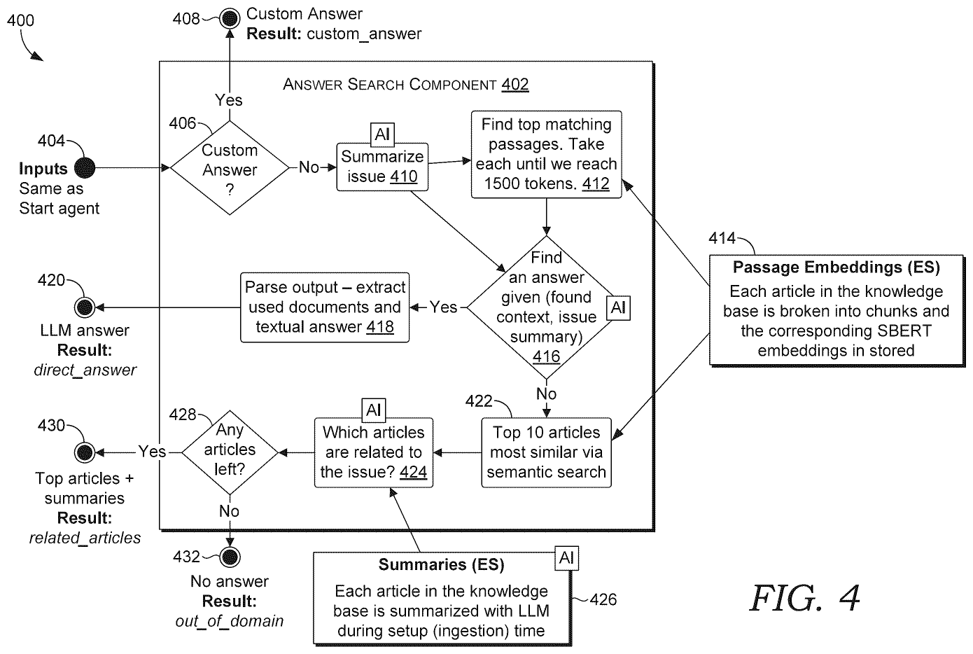

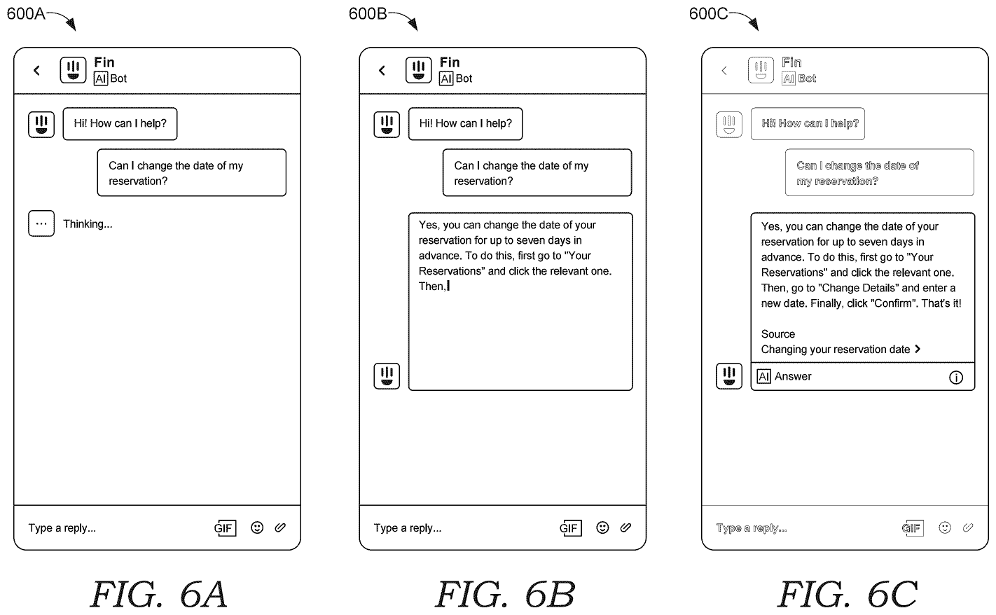

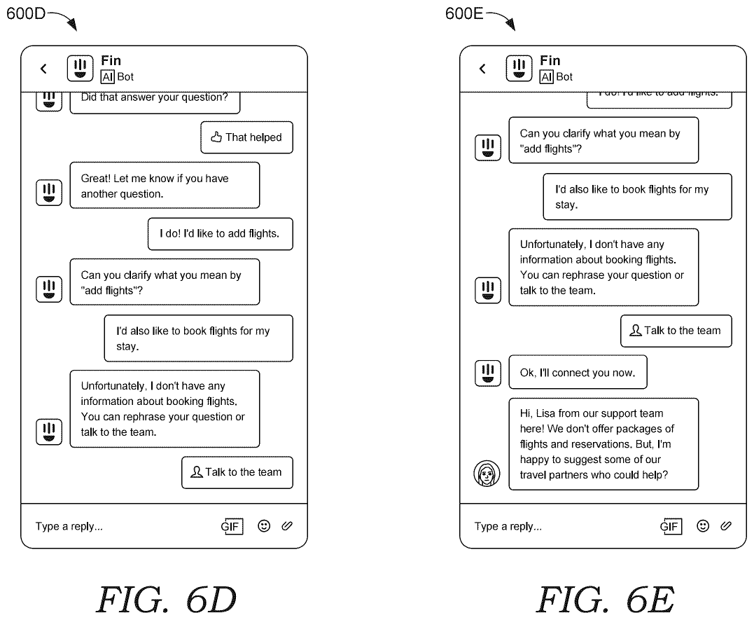

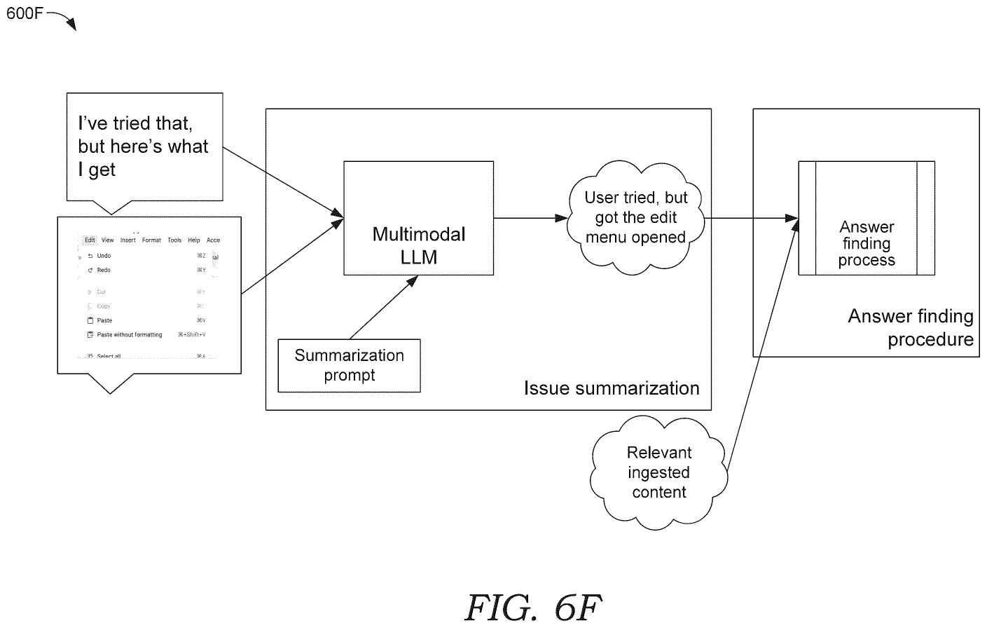

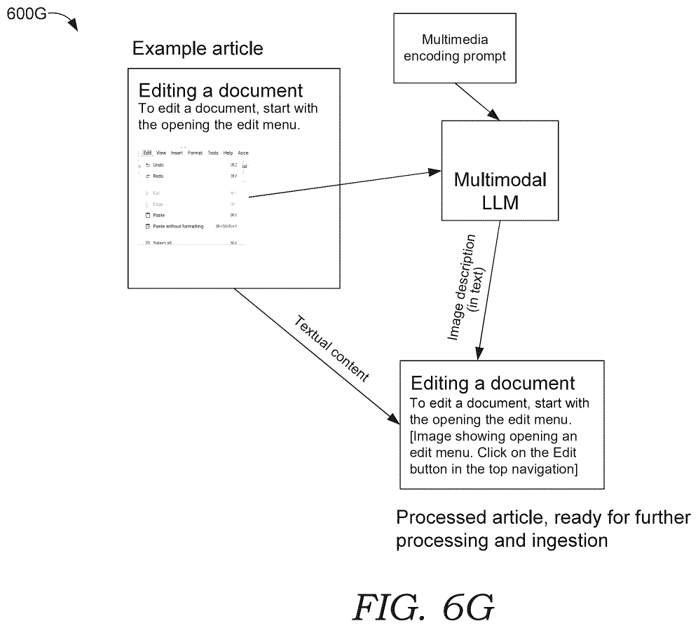

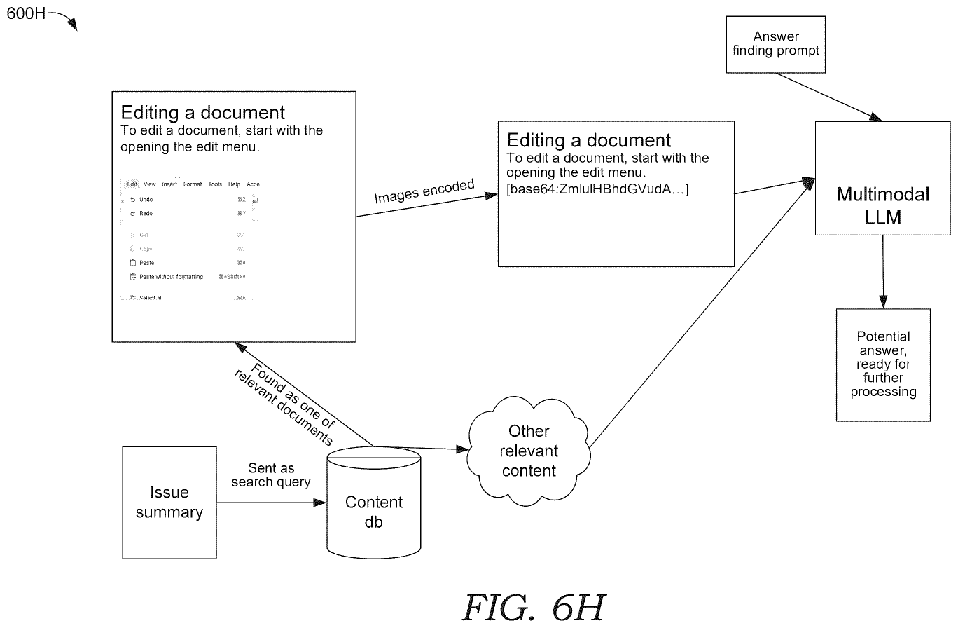

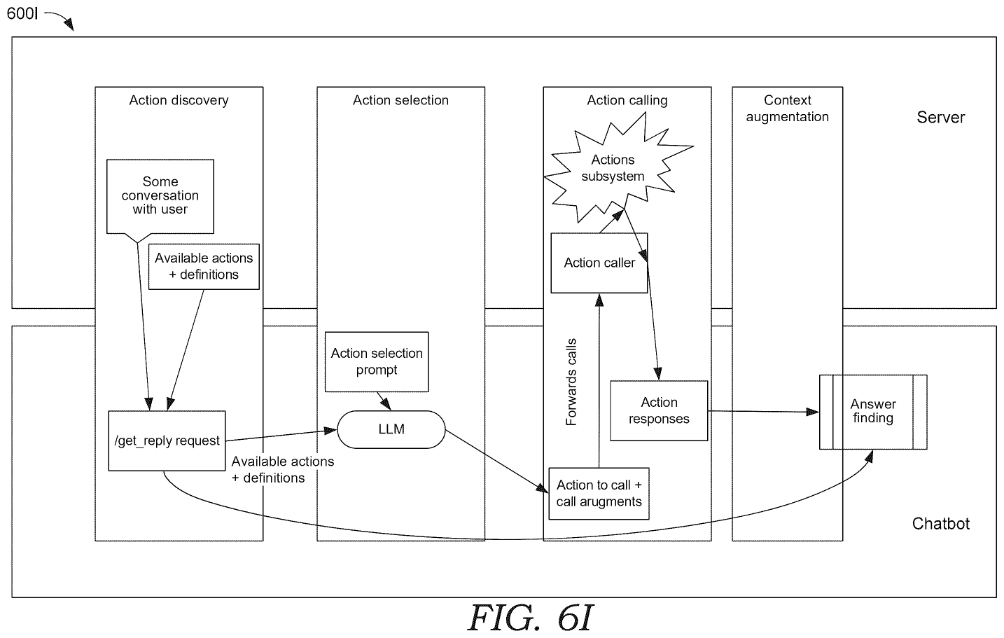

In some embodiments, chatbot component 151 facilitates handling multimedia input (e.g., images, videos, gifs, voice notes, etc.), both in the ingested content and/or as the end-user input. An example of chatbot component 151 facilitating the handling of multimedia input in the end-user input is shown in diagram 600F of FIG. 6F. As shown in diagram 600F, handling the multimedia in the end-user input can be performed during the issue summary phase (e.g., as described with respect to answer search state component 154 of FIG. 1, block 410 of FIG. 4, etc.). For example, when an end-user sends a message with some multimedia (e.g., with or without additional text), the multimedia (e.g., and/or additional text) is sent to a multimodal LLM to generate a textual representation of the user issue, which is then fed into the rest of the pipeline (e.g., as described with respect to answer search state component 154 of FIG. 1).

An example of chatbot component 151 facilitating the handling of multimedia input in the ingested content is shown in diagram 600G of FIG. 6G. As shown in diagram 600G, handling the multimedia in the ingested content can be performed during the ingestion process (e.g., via knowledge base accessing component 157). For example, when a multimedia object is encountered during the ingestion process (e.g., or accessed by knowledge base accessing component 157), the multimedia object can be transformed (e.g., a representation of the multimedia object can be generated and stored and associated with the multimedia object) into a textual representation of the multimedia object by leveraging the multimodal LLM. In this regard, in some embodiments, textual representation of the multimedia object can be generated by the multimodal LLM as a part of a preprocessing pipeline before the ingestion happens.

Another example of chatbot component facilitating the handling of multimedia input in the end-user input is shown in diagram 600H of FIG. 6H. As shown in diagram 600H, the image of diagram 600G of FIG. 6G when encountered during the “answer finding” process (e.g., as described with respect to answer search state component 154 of FIG. 1, block 410 of FIG. 4, etc.), is transformed into a textual representation that the multimodal LLM recognizes as an image.

In this regard, the multimodal LLM can provide the image as a part of the answer and/or the textual representation of the image as a part of the answer to the query.

In some embodiments, chatbot component 151 facilitates using a language model 110 to determine aspects of a conversation with a user in order to interact with external systems (e.g., external sources), such as an external application through third-party application configuration files 144, in order to provide a response or take an action with respect to the user. For example, chatbot component 151 may retrieve information from an ecommerce store, such as a price of an item or an answer to the user that allows the user to purchase an item, and provide the relevant response to the user. As another example, chatbot component 151 may retrieve information from an ecommerce system to determine whether historical customer data of the user indicates whether the customer qualifies for a particular offer or discount.

In some embodiments, chatbot component 151 facilitates augmenting the user context by utilizing data from external systems (e.g. reading order information from an ecommerce platform). An example of chatbot component 151 facilitating the augmenting of the user context by reading the data from external sources is shown in diagram 600I of FIG. 6I. As shown in diagram 600I, in some embodiments, there can be a number of processes connected to chatbot component 151 to facilitate using external data, such as action discovery and definition, action selection, action calling, and context augmentation. In some embodiments, action discovery and definition can be performed as part of an application calling a subsystem to the chatbot component 151. For example, during a call to the subsystem of chatbot component 151, the actions that are available for use are determined based on the current context and customer settings (e.g., not all users may have access to all actions). The list of available actions can include action definitions, with names, IDs, descriptions and parameter definitions, and can be sent along other conversation data. In some embodiments, the list of available actions can be retrieved using a get_reply call. A specific example of a get_reply call is as follows:

```
search_for_answer
{
  “conversation”: {
    ...
    “parts”: [
      ...
      {
        “author”: {
          “id”: “5103890”,
          “type”: “bot”
        },
        “text”: “Alright, how can I help you?”
      },
      {
        “author”: {
          “id”: “641c08a73463b681f342960d”,
          “type”: “user”
        },
        “text”: “I dont remember if I have a PRODUCT NAME 1 or a PRODUCT
NAME 2. Could you let me know which one do I have?”
      }
    ],
    ...
    “available_actions”: [
      {
        “id”: 44539,
        “name”: “Get ECOMMERCE PLATFORM Orders”,
        “description”: “Use this action to lookup recent ecommerce platform orders for
this user”,
        “parameters”: [ ]
      }
    ],
    ...
  },
  ...
}
```

In the specific example of the get_reply call above, there is one action defined. However, a get_reply call can be generated with any number of actions available. In some embodiments, if action has parameters, the action can be described with the following fields: name: text; description: text; type: enum (data type); required: boolean (true/false); and default_value: any value.

Continuing with diagram 600I, in some embodiments, the action selection process can include chatbot component 151 facilitating choosing which actions to call in order to augment the user's context based on the user's issue summary, current conversation, and available actions. In this regard, the action selection process can choose to call 0, 1, or more actions of the given conversation state. The output of the action selection process can be a list of actions to call, and arguments for each action call (e.g., call action “Get ECOMMERCE PLATFORM Order” with “order_id: <some_order_id_from_conversation>”). In some embodiments, the action calling process can include chatbot component 151 facilitating calling back into server 150, asking for the response of called actions (e.g., after action selection is performed). Server 150 can call external system (e.g., via third-party application configuration files 144) and proxies the response. In some embodiments the response is redacted as users (e.g., teammates) can define which fields are returned back in the response. In some embodiments, the context augmentation process can include chatbot component 151 facilitating augmenting the context in the “answer finding” stage (e.g., as described with respect to answer search state component 154 of FIG. 1, block 410 of FIG. 4, etc.) with received responses (e.g., after a response is received from the action calling process). In this regard, action responses can be included in the same prompt as relevant passages from the knowledge base in order to facilitate utilizing data from external systems to provide an answer to a query.

Returning to FIG. 1, data regarding the conversations can be stored in any suitable storage location, such as storage 130, customer support device 112, server 150, some combination thereof, and/or other locations as communication records files 131.

At a high level, chatbot (e.g., implemented by chatbot component 151) can include a number of agents (e.g., a program that, for each user turn, based on the conversation transcript and/or other factors, computes the next appropriate action to take in the conversation, and performs the action), such as a start agent (e.g., start state chatbot agent component 153) and a feedback agent (e.g., feedback state chatbot agent component 155). In this regard, computing the next action (e.g., a sub procedure of an agent that causes the effect on the conversation and can be implemented in a general programming language, such as Python, and can perform any operation a given language can perform, such as another call to a large language model (LLM), such as GPT3, GPT4, Anthropic's Claude, and/or the like) can be implemented as an LLM call with lightweight post-processing. In some examples, based on the chosen action and a history of previous actions, the computed action is overridden and another action is used. An example of an agent flow can include: (1) user (e.g., customer) sends a message; (2) API endpoint invokes the active agent (e.g., start state chatbot agent component 153 or feedback state chatbot agent component 155) of the conversation; (3) agent computes the best next action (e.g., from predefined set of actions); (4) agent executes the action (e.g., which can include as part of action execution, an agent yielding the control to another agent).

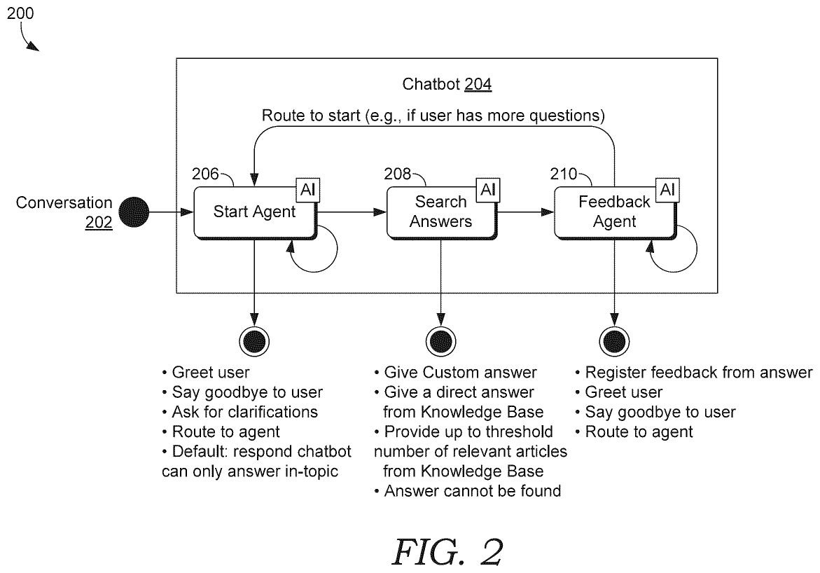

Continuing with the high-level overview, an example diagram 200 of a model implementing a specialized chatbot platform that uses language models to determine answers from knowledge bases is shown in FIG. 2. In particular, embodiments depicted in FIG. 2 utilize a start agent (e.g., start agent 206 of chatbot 204). But it is contemplated that some embodiments of the answer assistance computing system technology described herein do not utilize a start agent. Generally a start agent is useful to reduce the likelihood of generating and an answer to a question when the user, such as a CSA or customer was not asking a question. However, some embodiments of the answer assistance computing system are implemented to be internally facing; that is, the generated answers are provided to an internal user, such as a CSA, rather than a customer or external caller or chatter. Thus these embodiments can be implemented to assume the CSA asks a question or query in the conversation that is used to generate a conversation representation and then, subsequently, to generate an answer.

Accordingly and as shown in the example embodiment of FIG. 2, conversation 202 is received by start agent 206 of chatbot 204 (e.g., start state chatbot agent component 153 of FIG. 1). In some embodiments, all conversations between a user and a chatbot begin with start agent 206. For each user turn, based on conversation, start agent 206 chooses one of available actions: greet, goodbye, clarify, route to agent, default, and search for answer. When the search for answer action is triggered, start agent 206 of chatbot 204 initiates a search for answers 208 (e.g., answer search state component 154 of FIG. 1). If search for answers 208 results in a successfully generated answer, conversation control is yielded to the feedback agent 210 (e.g., feedback state chatbot agent component 155 of FIG. 1) of chatbot 204. In this regard, the following conversation turns are going to be processed by the feedback agent 210. In some embodiments, feedback agent 210 is an agent with a simpler set of actions than start agent 206, such route to agent, parse feedback, greet, and bye.

Returning to FIG. 1, to compute the next best action in conversation, the agent leverages an LLM and prompt engineering. Generally, LLMs are generic stateless machines so agent, on each user turn, makes a stateless call to an LLM. In some embodiments, the stateless call includes context, such as the relevant part of the conversation transcript, a list of available actions, explanation of each action and situations in which actions should be used, a set of instructions to choose one of the following actions, and/or the desired format of the output.

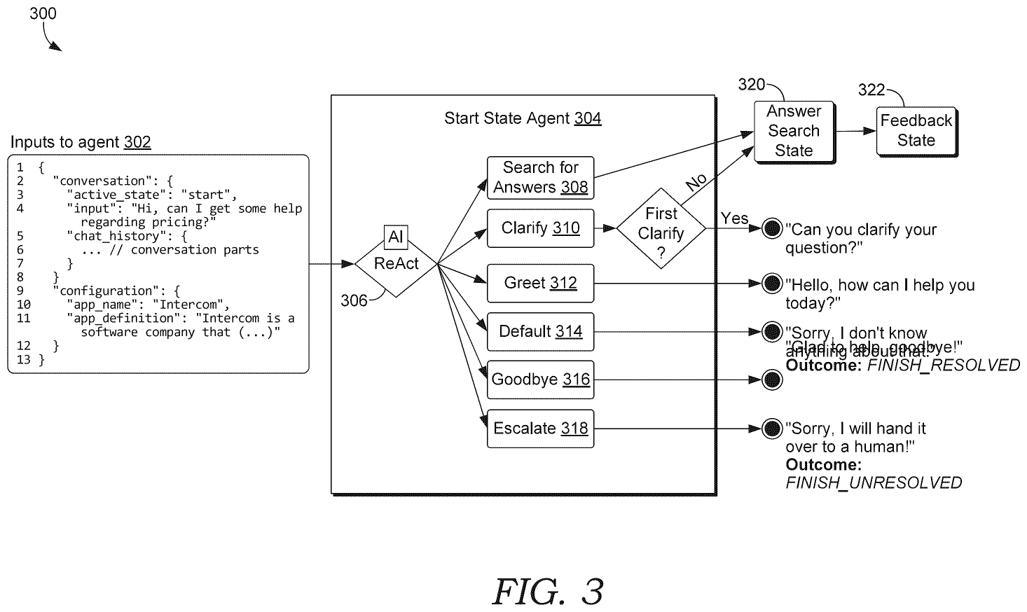

In some embodiments, start state chatbot agent component 153 is programmatically designed to elicit a clear question from the user (e.g., a customer via chat interface 108) and find an answer to the given question. An example diagram 300 of a model implementing a start state agent of a chatbot that uses a language model to determine answers from semantically similar documents of a knowledge base is shown in FIG. 3. As shown in FIG. 3, in some embodiments, input 302 is received that includes conversation data, configuration data, and/or any other input to start state agent 304 (e.g. start state chatbot agent component 153) of the chatbot (e.g., as implemented by chatbot component 151). In some embodiments, as shown in the example in FIG. 3 the start state agent 304 can be implemented as a LangChain ReAct agent 306. In some embodiments, start state agent 304 can implement a number of actions. An example of an action is search for answers action 308 that can initiate an answer search state 320 (e.g., answer search state component 154). In some embodiments, following a response with an answer, start state agent 304 can initiate feedback state 322 (e.g., feedback state chatbot agent component 155). Another example of an action is clarify action 310 that can initiate a request for clarification from the user. In some embodiments, if no further clarification is necessary following a clarification to clarify action 310, start state agent 304 initiates an answer search state 320. Another example of an action is greet action 312 that can initiate a greeting to the user. Another example of an action is goodbye action 316 that can initiate a parting remark to end the conversation (e.g., or a portion of the conversation) with the user. Another example of an action is escalate action 318 that can initiate a handover to a human (e.g., route to agent component 158 of FIG. 1). Each of the examples of actions are described in further detail below with respect to start state chatbot agent component 153 of FIG. 1.

Returning to FIG. 1, in some embodiments, start state chatbot agent component 153 includes a greet action (e.g., greet action 312 of FIG. 3). Greet action can be instructed to be used by start state chatbot agent component 153 when it is time to greet the user. Generally, the effect of the action is to add a conversation turn of the bot to greet the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to greet the user may be provided in a prompt to language model 110 by start state chatbot agent component 153. Language model 110 may return a response to start state chatbot agent component 153 to provide a greeting. Start state chatbot agent component 153 may provide the greeting to the user through chat interface 108. In some embodiments, a hard coded response corresponding to a greet action can be included by start state chatbot agent component 153, for example, in case of the language model 110 failing to follow instructions.

In some embodiments, start state chatbot agent component 153 includes a goodbye action (e.g., goodbye action 316 of FIG. 3). Goodbye action can be instructed to be used by start state chatbot agent component 153 when it is time to say goodbye the user. Generally, the effect of the action is to add a conversation turn of the bot providing a parting remark to end the conversation (e.g., or a portion of the conversation) with the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a parting remark to the user may be provided in a prompt to language model 110 by start state chatbot agent component 153. Language model 110 may return a response to start state chatbot agent component 153 to provide a parting remark. Start state chatbot agent component 153 may provide the parting remark to the user through chat interface 108. In some embodiments, a hard coded response corresponding to a goodbye action can be included by start state chatbot agent component 153, for example, in case of the language model 110 failing to follow instructions.

In some embodiments, start state chatbot agent component 153 includes a route to teammate/escalate action (e.g., escalate action 318 of FIG. 3). In some embodiments, route to teammate/escalate action can be instructed based on determining a response from the user requires a human to communicate with the user. For example, route to teammate/escalate action can be instructed to be used when a user explicitly asks to talk to a human. Generally, the effect of the action is to add a conversation turn of the bot to provide a textual response informing the user that they are being redirected to a human (e.g., a CSA) and/or instructing route to agent component 158 of chatbot component 151 to initiate a handover of the conversation to the human. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a textual response informing the user that they are being redirected to a human and/or instructing route to agent component 158 of chatbot component 151 to initiate a handover of the conversation to the human may be provided in a prompt to language model 110 by start state chatbot agent component 153. Language model 110 may return a response to start state chatbot agent component 153 to provide a textual response informing the user that they are being redirected to a human and/or instructing route to agent component 158 of chatbot component 151 to initiate a handover of the conversation to the human. Start state chatbot agent component 153 may provide the textual response informing the user that they are being redirected to a human to the user through chat interface 108. Start state agent may communicate with route to agent component 158 of chatbot component 151 to initiate a handover of the conversation to the human. In some embodiments, a hard coded response corresponding to a route to teammate/escalate action can be included by start state chatbot agent component 153, for example, in case of the language model 110 failing to follow instructions.

In some embodiments, start state chatbot agent component 153 includes a search for answer action (e.g., search for answers action 308 of FIG. 3) that initiates answer search state component 154. Search for answer action can be instructed to be used by start state chatbot agent component 153 in order to search for an answer. In some embodiments, search for answer action is only instructed to be used by start state chatbot agent component 153 when the user's issue is clear and/or worth searching for an answer. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. In some embodiments, textual content of the conversation can be provided to language model 110 to generate a summarized and/or condensed user issue. The summarized and/or condensed user issue can be provided to language model 110 in order to determine whether to implement this action and/or the answer output based on the summarized and/or condensed user issue. The answer output can then be provided by start state chatbot agent component 153 to the user through chat interface 108. Examples of search for answer action is discussed below with respect to answer search state component 154.

In some embodiments, start state chatbot agent component 153 includes a clarify action (e.g., clarify action 310 of FIG. 3). Clarify action can be instructed to be used by start state chatbot agent component 153 when the user's issue is vague and unclear. Generally, the effect of the action is to add a conversation turn of the bot to request clarification from the user, such as a clarifying question. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user. For example, an instruction to request clarification from the user (e.g., when the issue is unclear) may be provided in a prompt to language model 110 by start state chatbot agent component 153. Language model 110 may return a response to start state chatbot agent component 153 to provide a question regarding an aspect of the user's issue in order to clarify the user's issue. Start state chatbot agent component 153 may provide the question to the user through chat interface 108. In some embodiments, if the clarify action is run twice in a row, the search for answer action can be automatically initiated.

In some embodiments, start state chatbot agent component 153 includes a default action (e.g., default action 314 of FIG. 3). Default action can be instructed to be used by start state chatbot agent component 153 when the language model 110 determines that none of the other actions should be used. Generally, default action is a fallback action to make sure that an LLM has an escape hatch, as without an escape hatch LLMs may misuse other actions (e.g., by computing action input with text that is not aligned with the computed action, such as by calling a clarify action, but giving an answer from a search for answer action in action input). The effect of the action is a bot conversation turn, with one of the example texts below. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user. Examples of a textual response of the default action can include information to the user regarding what the chatbot can provide answers about, such as “I can answer questions you′d expect to find in our help center,” “I'm here to answer questions using information from our help center,” and/or “I'm most helpful when you have a question that might be found in our help center.”

A specific example of a prompt provided by start agent (e.g., start state chatbot agent component 153) to a language model 110 (e.g., with a conversation with the customer) is as follows:

“““
Human: You are a friendly and polite customer support bot working for
${customer_name}.
You're identifying the customer issue and searching for an answer.
You have access to the following tools:
- route_to_customer_support_agent: Useful ONLY when the customer explicitly asks to
talk to a customer support agent. Input to this is a polite reply to customer saying that you're
routing them to a customer support agent.
- greet: Useful when you need to greet the customer. Input to this is a greeting to give to
the customer.
- say_goodbye: Useful when customer explicitly says goodbye. Input to this is a polite
reply saying something like goodbye to the customer.
- clarify: Useful in two cases:
1. When what customer is saying is gibberish.
2. When customer is saying they have a question/problem/query/issue/etc, but they haven't
told you what it is.
Input to this is a question that you ask the customer.
- default: Useful if no other action is appropriate.
- search_for_answer: Useful when: customer is asking a question or giving some
information about their issue. Use this tool if it's not clear what other tool to use. If
customer issue is clear, use this tool to summarize the issue and search for the answer.
Input to this tool is what the customer said. Do not attempt to answer the question.
Use the following format:
Customer: the input from the human customer.
Thought: you should always think about what to do.
Action: the action to take, should be one of [route_to_customer_support_agent, greet,
say_goodbye, clarify, default, search_for_answer].
Action Input: the input to the action. The input for this action must be in German.
Observation: the result of the action.
... (this Thought/Action/Action Input/Observation can repeat N times)
Begin!
If customer expressed the issue or what they want you to do, use “search_for_answer” to
search for an answer.
If no mentioned tools are appropriate, use “default” tool as a fallback.
Conversation with customer:
Customer: Hello there
AI: Hi, I'm a customer bot. You can ask me anything about {customer_name}
Customer: I'd like to know when, I'm eligible to get a bonus.
Thought:
”””

A specific example of response to the specific example of the prompt provided by start agent (e.g., start state chatbot agent component 153) by a language model 110 is as follows:

search_for_answer
Action Input: “When I'm eligible to get a bonus?”

In some embodiments, after output from language model 110 is received, the output of the language model can be parsed with regular expressions by chatbot component 151. For example, in the specific example of response to the specific example of the prompt, the returned action (e.g., the search for answer action) is invoked with returned action input (e.g., “When am I eligible to get a bonus?”). Following the returned action and action input, in some embodiments, a programming function (e.g., a python function) representing the action (e.g., the search for answer action) can be called with a textual argument corresponding to the action input (e.g., “When am I eligible to get a bonus?”). In some embodiments, if the output of the language model 110 does not conform to the specifications and/or the returned action name of the language model 110 is not a valid action name, a recovery procedure is started.

In some embodiments, answer search state component 154 facilitates programmatically implementing the search for answer action of start state chatbot agent component 153. Generally, answer search state component 154 facilitates the delivery of truthful and grounded resolution to the user's issue in textual form. As a high level overview, in some embodiments, answer search state component 154 initially determines whether a custom answer (e.g., a manually-defined answer) exists based on aspects of the conversation that triggered the search for answer action (e.g., via custom answers component 160). If no custom answer is determined, an issue summary is generated based on aspects of the conversation with the user. A language model determines whether the answer can be found in portions of documents of the knowledge base that are most similar to the issue summary. For example, the knowledge base can include articles from various sources, a help center, FAQs, public URLs, historical conversation data (e.g., previous conversations between customers and CSAs), snippets of conversations, and multi-source answers may be provided, such as by synthesizing information from various sources of knowledge base. For example, knowledge base 132 of FIG. 1 shows examples of source, including, but not limited to, extracted snippet files 133, manually curated files 134 with public content 135 and private content 136 (e.g., content that is not shared with some or all customers), URLs 137, and historical conversation files 138. In some embodiments, embeddings corresponding to all passages from the knowledge base (e.g., knowledge base 132) are computed and stored during setup and/or are automatically computed and stored whenever knowledge base content changes.

In some embodiments, certain information sources of a knowledge base have corresponding access permissions. Accordingly, certain information in a knowledge base is made available or not available for generating an answer, according to the implementation. For example, embodiments of the answer assistance computing system that are implemented to be internally facing may be enabled to access all information source in a knowledge base, while embodiments of the answer assistance computing system that are implemented to be externally facing to the public or externally facing to customers, may be enabled to access only information sources of the knowledge base that are permitted for access by the public or customers, respectively. In this way, information in a knowledge base that is private or sensitive to a company is not used to determine passages for generating an answer, when the recipient of the answer is not authorized to access the underlying information used to generate the answer.

Returning to the high level overview of answer search state component 154, in some embodiments, if the answer can be found, the answer is provided to the user via chat interface 108. If no answer can be found, a set of summaries corresponding to a set of documents that are most similar to the issue summary are provided to the language model to determine whether any of the documents may contain the answer. If the language model determines that documents within the set of documents may contain the answer, a threshold number of document most likely to contain the answer, along with summaries of the documents, are provided to the user via chat interface 108. If the language model determines that documents within the set of documents will not contain the answer, the language model indicates that the answer could not be found. The start state chatbot agent component 153 can then determine the next action, such as a clarify action or escalation action.

In some embodiments, different language models can be utilized for different actions or portions of actions. For example, one language model (e.g., GPT3) can be utilized to summarize the issue by answer search state component 154 whereas a different language model (e.g., GPT4) can be utilized to evaluate whether an article in the knowledge contains the answer by answer search state component 154. In some embodiments, one language model (e.g., GPT3) is utilized to screen articles as an initial check whether a top article contains an answer before asking a different language model (e.g., GPT4) to determine whether the top article contains an answer in order to reduce calls to the different language model (e.g., GPT4). In some embodiments, frequently asked questions (FAQ) are pre-computed using a language model to reduce live calls to the language model. In some embodiments, answer search state component 154 can utilize information from beyond the knowledge base. In some embodiments, answer search state component 154 and other components are multilingual.

In some embodiments, answer search state component 154 can request an issue summary based on the conversation with user (e.g., the customer) from language model 110. In some embodiments, the summary of the user's issue as action input to the search for answer action provided by language model 110 (e.g., the issue summary utilized to determine the appropriate action) is ignored and a second call is provided to the language model to summarize the issue again in order to increase the quality and/or reliability of the summary of the user's issues in certain scenarios. In some embodiments, aspects of the conversation with the user, such as the issue summary generated by language model 110 and/or historical customer data of the user, can be utilized to find the relevant context for searching the knowledge base 132. In some embodiments, the issue summary as generated by language model 110 can be utilized to engineer around an LLM's limitation on input length (e.g., the context window), which can cause the computation of the output to not be based on all parts of the input over a certain length and/or cause certain portions of input over a certain length to get a different level of attention while computing the output. In some embodiments, the issue summary can be used to stuff the prompt when the answer is being extracted by answer search state component 154 by utilizing the retrieved context and the issue summary to answer the user question at hand.

In some embodiments, answer search state component 154 facilitates programmatically finding an answer from a knowledge base. An example diagram 400 of a model implementing a specialized chatbot platform that uses language models to determine answers from knowledge bases is shown in FIG. 4. As shown in FIG. 4, in some embodiments, answer search component 402 (e.g., answer search state component 154 of FIG. 1) receives input 404. In some embodiments, input 404 includes the input from start state chatbot agent component 153. A sentence embedding of input 404, or a portion thereof, is computed. In some embodiments, the sentence embedding is computed using Sentence Bidirectional Encoder Representations from Transformers (SBERT). In some embodiments, historical customer data (e.g., as accessed by customer data accessing component 156 of FIG. 1) for the user chatting with the chatbot (e.g., through chat interface 108) can be utilized to provide contextual information for the input. For example, the contextual information related to the historical customer data can be encoded into the embedding of the input.

At block 406, it is determined whether aspects of the input correspond to a custom answer (e.g., via custom answers component 160 of FIG. 1). In some embodiments, semantic search is used to determine whether aspects of the input correspond to a custom answer based on the semantic similarity of the input, or a portion thereof, to a custom answer. For example, the semantic similarity of an embedding corresponding to the input (e.g., an issue summary of the input) and an embedding corresponding to a customer answer can be computed (e.g., based on a vector search query, a dot product of the embeddings, using Microsoft Machine Reading Comprehension (“MS MARCO”) model as the model is fine-tuned for Q&A asymmetrical search, and/or the like) to determine whether a customer answer corresponds to a user's query/issue of the input. In some embodiments, historical customer data for the user chatting with the chatbot (e.g., through chat interface 108) can be utilized to provide contextual information input. For example, the contextual information related to the historical customer data can be encoded into the embedding of the input.

In some embodiments, at block 410, a call is made to the language model 110 to summarize the issue based on aspects of input 404. A sentence embedding of the issue summary generated from block 410, or a portion thereof, is computed (e.g., utilizing SBERT). In some embodiments, historical customer data for the user chatting with the chatbot (e.g., through chat interface 108) can be utilized to provide contextual information for the issue summary. For example, the contextual information related to the historical customer data can be encoded into the embedding of the issue summary.

A specific example of a prompt (e.g., as provided by answer search state component 154 via start state chatbot agent component 153) to a language model (e.g., language model 110) to request an issue summary (e.g., a summary of an issue within the conversation) is as follows:

“““
You are a customer support AI for ACME CORP, having a conversation with the ACME
CORP customer.
AI: Hi I'm Fin, an AI-powered support bot that automatically answers questions. Type
your question in the chat below and I'll do what I can to help. Don't worry, if I'm not able
to help you, I'll pass you along to a Live Support agent.
Customer: How did this Event not happen ???
---
This is a chat history of the whole conversation, and Customer could have mentioned an
issue/question/problem or issued a request.
There are two possible scenarios:
1. Customer only mentioned a single issue/problem/question/request.
2. Customer raised multiple completely unrelated issues/problems/questions/requests.
If it's #1, rewrite the customer issue in one sentence.
If it's #2, concentrate only on the last issue/problem/question/request and rewrite it in one
sentence.
Look at the whole conversation and make sure you're picking up the last
issue/problem/question/request fully!
If it's clean, leave it as is.
Customer:
”””

A specific example of response from the language model to the specific example of the prompt requesting an issue summary is as follows:
“““
“How did this Event not happen???”
”””

At block 412, a threshold number of portions from documents of a knowledge base (e.g., knowledge base 132 as accessed by knowledge base accessing component 157 of FIG. 1) that are most similar to the issue summary can be determined. In some embodiments, in block 414, portions of the knowledge base are broken into chunks, such as based on corresponding passages, sections, sentences, and/or the like, and the corresponding embeddings are pre-computed (e.g., using SBERT) and stored in the knowledge base. For example, the knowledge base can include articles from various sources, a help center, FAQs, public URLs, historical conversation data, snippets of conversations, and multi-source answers may be provided, such as by synthesizing information from various sources of knowledge base. For example, knowledge base 132 of FIG. 1 shows examples of source, including, but not limited to, extracted snippet files 133, manually curated files 134 with public content 135 and private content 136, URLs 137, and historical conversation files 138. In some embodiments, all embeddings corresponding to portions (e.g., passages) of the knowledge base (e.g., knowledge base 132) are computed and stored during setup and/or are automatically computed and stored whenever knowledge base content changes.

Returning to FIG. 4, in some embodiments, at block 412, semantic search is used to determine the portions of documents of the knowledge base that are most similar to the issue summary based on the semantic similarity of the issue summary, or a portion thereof, to portions of documents of the knowledge base. For example, the semantic similarity of an embedding corresponding to the issue summary and an embedding corresponding to each portion of documents of the knowledge base customer can be computed (e.g., based on a vector search query, a dot product of the embeddings, using MS MARCO, and/or the like) to determine the portions of documents of the knowledge base most similar to the issue summary. In some embodiments, the threshold number of portions from documents of a knowledge base extracted at block 412 correspond to an amount of tokens that are provided to the LLM (e.g., language model 110 of FIG. 1). For example, portions of documents of a knowledge corresponding to 1500 tokens may be extracted at block 412. In some embodiments, utilizing a Q&A asymmetrical search model (e.g., MS MARCO), the embedding of the issue summary can be utilized as a question and the answer can be found based on embeddings of corresponding portions of the knowledge base. A threshold number of passages (e.g., the 20 most similar passages) can be identified based on the dot product of the embeddings. In some embodiments, the location of the documents, or portions thereof, such as the identification of the article, can be determined.

At block 416, an LLM (e.g., language model 110 of FIG. 1) is prompted to evaluate whether the threshold number of portions of documents of a knowledge base (e.g., as determined at block 412) that are most similar to the issue summary indeed provide an answer to the issue summary. At block 418, if the LLM determines that the answer to the issue summary is found within one or more of the threshold number of portions of documents of the knowledge base, the output the answer is extracted. In some embodiments, the documents utilized to provide the answer are parsed by the LLM to determine the answer. In some embodiments, the document(s) utilized are provided along with the answer in response to the query. At block 420, the answer is then provided to the user (e.g., through chat interface 108 of FIG. 1).

A specific example of a prompt (e.g. as provided by answer search state component 154 via start state chatbot agent component 153 of FIG. 1) to a language model (e.g., language model 110 of FIG. 1) to find an answer given an issue summary and a threshold number of portions of documents of a knowledge base similar to the issue summary is as follows:

“““
System: You are a customer support answer service for ACME CORP, do not recommend
competitors of ACME CORP. Your job is to answer questions as accurately and efficiently
as possible.
Human: QUESTION: I want to cancel my Pro plan and make sure I will not be charged for
it, and that it will remain active as a free plan.
AI: Here is a list of passages from our knowledge base in descending order of relevance to
your query:
[{‘passage_text’: “How do I cancel my subscription?\n\n Updated over a week
ago\n \nTable of contents\n\n[Steps:](https://help.ACME.com/how-do-i-cancel-my-
subscription)\n\nIf you've tried our paid plans and it wasn't for you, you can downgrade to
the free plan at any time via your Admin page. Once you downgrade, you'll lose access to
all your ...”
Human: Lets refer to those passages as “The information I've found about your query”
Given that information I want you to reasonably reinterpret my query: I want to cancel my
Pro plan and make sure I will not be charged for it, and that it will remain active as a free
plan. and determine if you can answer my question by summarizing the relevant
information into a response to my query.
First, write either <sources_answer_q> YES</sources_answer_q> or
<sources_answer_q>NO</sources_answer_q> to indicate whether the answer to the
question is entirely contained within the source information(s).
Second, list any materially relevant quotes from the information that you used to generate
your answer.
Quote them word-for-word using <quote id=“entity_id”></quote> tags.
Provide the answer between <answer></answer> tags.
Provide as complete a solution as possible, assuming I cannot read or reference the
information to solve my problem.
Make sure to include any caveats mentioned in the information.
You do not need to reference the passages in your response.
Format your answer for optimum scanability and readability (e.g. restate the problem if
helpful, process steps as lists, and use paragraph breaks where needed).
If there are relevant links in the passages, you should include them in your response.
If the passages don't contain enough information to answer the question, you should say
<answer>UNKNOWN</answer>.
”””

A specific example of a response from the language model to the specific example of the prompt to find an answer given an issue summary and a threshold number of portions of documents of a knowledge base similar to the issue summary is as follows:

“““
□<sources_answer_q>YES</sources_answer_q>
<quote id=“129-9354025”>If you've tried our paid plans and it wasn't for you, you can
downgrade to the free plan at any time via your Admin page. Once you downgrade, you'll
lose access to all your upgraded features at the end of your billing cycle. < /quote>
<quote id=“129-9354025”>1. In your ACME CORP Admin, select your profile image (or
three horizontal lines if you're on a phone) to find Billing. 2. Hit the Change Plan button
found in the Your Subscription section. 3. In the pop-up, select the plan you'd like to change
to. If you want to cancel your subscription, scroll down below the plan options where you'll
see Downgrade to Free.</quote>
<answer>
To cancel your Pro plan and ensure you will not be charged for it while keeping your
account active as a free plan, follow these steps:
1. Log in to your ACME CORP Admin page.
2. Select your profile image (or three horizontal lines if you're on a phone) to find the
Billing section.
3. Click the “Change Plan” button found in the “Your Subscription” section.
4. In the pop-up, scroll down below the plan options and click “Downgrade to Free.”
Once you downgrade, you'll lose access to all your upgraded features at the end of your
billing cycle, and your account will remain active as a free plan.
</answer>
”””

In some embodiments, if there is an answer tag (e.g., <answer>) present in the response provided by the language model, and is different from “UNKNOWN”, the answer is determined to be found and the answer is delivered to the user. In some embodiments, the answer tag comprises a textual answer corresponding to whatever the language model returned inside answer tag and/or a link to the documents used to form an answer. An example chat interface between a chatbot and a user showing a response from the chatbot with a link to the corresponding source of the response is shown in FIG. 6C.

In some embodiments, if the language model did not find the answer to the issue summary at block 416, at block 422, a threshold number of most similar documents, or portions thereof, are identified. In this regard, if the previous stage didn't find a direct, inline answer, a prompt is provided to the language model to find content that is not directly answering the question, but might be relevant. In some embodiments, semantic search is used to determine the portions of documents of the knowledge base that are most similar to the issue summary based on the semantic similarity of the issue summary, or a portion thereof, to portions of documents of the knowledge base. For example, the semantic similarity of an embedding corresponding to the issue summary and an embedding corresponding to each portion of documents of the knowledge base customer can be computed (e.g., based on a vector search query, a dot product of the embeddings, using MS MARCO, and/or the like) to determine the portions of documents of the knowledge base most similar to the issue summary. In some embodiments, utilizing a Q&A asymmetrical search model (e.g., MS MARCO), the embedding of the issue summary can be utilized as a question and the answer can be found based on embeddings of corresponding portions of the knowledge base. A threshold number of passages (e.g., the 20 most similar passages) can be identified based on the dot product of the embeddings. In some embodiments, the location of the documents, or portions thereof, such as the identification of the article, can be determined.

In some embodiments, at block 424, a prompt is provided to a language model to determine whether an article might contain an answer relevant to the issue based on the issue summary and summaries 426 of each of the threshold number of most similar documents, or portions thereof, as identified at block 422. In some embodiments, the summaries of each of the documents of the knowledge base are precomputed and stored in the knowledge base. At block 428, if the language model determines that documents within the threshold number of documents may contain the answer, a threshold number of document most likely to contain the answer are provided to the user (e.g., via chat interface 108 of FIG. 1) at block 430. For example, if 10 documents are provided to the language model and the language model determines that 5 documents might contain the answer, the top 3 documents most likely to contain the answer are provide to the user. At block 428, if the language model determines that no documents provided likely contain the answer, the language model indicates that the answer could not be found.

A specific example of a prompt (e.g., as provided by answer search state component 154 via start state chatbot agent component 153 of FIG. 1) to a language model (e.g., language model 110 of FIG. 1) to determine documents likely to contain an answer to an issue summary is as follows:

“““
System: Here is a list of articles. For each, you have: ID, title, short summary:
”””- ID: 0; Title: General FAQs; Summary: The article contains a list of frequently asked
questions about various topics related to Intercom, including installation, access tokens,
Slack integration, ticketing, exporting data, managing teammates, and resolving login
issues.
- ID: 1; Title: Intercom features explained; Summary: This article provides an overview of
the different features offered by Intercom, including the Messenger, Next-Gen Inbox,
Tickets, Fin - The AI-Powered Bot, AI assist Features, Articles, Outbound Messages,
News, Surveys, 2-Way SMS, Product Tours, Checklists, Tooltips, Workflows, Custom
Answers, Custom Actions and Objects, and Switch, as well as information on how to set
up Intercom for your business.
- ID: 2; Title: Workflows explained; Summary: This article explains how to use Workflows
in Intercom to easily build chatbots, automate tasks, and provide support to customers
across multiple channels, with features such as triggers, templates, a visual builder,
omnichannel support, rules, conditions, updating attributes, open tickets, custom actions,
tagging conversations, and passover to other bots, and also provides information on how
to manage Workflows.
- ID: 3; Title: AI assist for Articles [Beta]; Summary: The article introduces AI assist for
Articles, a feature integrated with OpenAI's GPT 3.5 that allows teams to generate full
article versions from summaries, saving time and cognitive load for creating help center
content and providing customers with self-serve resources faster.
- ID: 4; Title: What is Automation?; Summary: Intercom is introducing new automation
features, including an AI-powered bot called Fin, the rebranding of Custom Bots and Task
Bots to Workflows, and the introduction of Basics for simple automations. Existing
features like Resolution Bot and Inbox Rules will still be available but may be deprecated
in the future. The navigation in the workspace will change depending on the features
enabled.
- ID: 5; Title: Using Fin Profiles alongside other automations; Summary: This article
explains how to use Fin Profiles alongside other automations in Intercom, such as Custom
Answers and Workflows, and provides tips for configuring and troubleshooting conflicts
between these features.
- ID: 6; Title: AI assist for Inbox; Summary: The article introduces AI assist for Inbox, a
feature that uses OpenAI's GPT 3.5 to help support reps in writing customer responses,
rephrasing messages, and summarizing conversations, ultimately saving time and
improving the customer experience. The article also provides information on how
Intercom's own support team is using these features and answers frequently asked questions
about the functionality and availability of AI assist for Inbox.
- ID: 7; Title: Custom Actions and Objects explained; Summary: This article explains how
to use Custom Actions and Objects to create personalized self-serve support experiences
in bots and Inbox without any coding.
- ID: 8; Title: 6 great ways to use Surveys; Summary: The article explains 6 great ways to
use surveys to capture and act on customer insights, from customer loyalty and satisfaction
metrics to onboarding discovery, lead generation, and understanding customer churn.
- ID: 9; Title: Articles explained; Summary: This article explains how to use Articles in
Intercom to create self-service content, sync with other knowledge bases, build a
knowledge base, provide faster support, generate AI answers, get feedback, and improve
content.
“““
Look at the list above and figure out whether given articles are related to the following
customer query.
Customer: “Can you integrate your AI chatbot with our product search to handle customer
enquiries?”
Please provide the IDs of the articles that are related to the customer query.
Wrap each article returned with <article_id> tag.
If no article is found, return <article_id>-1</article_id>
”””

A specific example of a response from the language model to the specific example of the prompt to determine documents likely to contain an answer to an issue summary is as follows:

“““
article_id>2</article_id>
<article_id>4</article_id>
”””

In some embodiments, article indices are then tied back to article identification from the knowledge base (e.g., knowledge base 132 of FIG. 1). In some embodiments, the chatbot responds with “I can't answer that directly, but I found an article that seems relevant to your question” and provides links to relevant articles. In some embodiments, if no articles are returned, the chatbot responds with “Sorry, I'm not sure how to help you with that,” or a variation thereof. In some embodiments, if the inline answer or relevant contents are found, the chatbot provides a request for feedback (e.g., “was that helpful?”) and transfers the agency over conversation to the feedback agent (e.g., Feedback state chatbot agent component 155 of FIG. 1).

Returning to FIG. 1, in some embodiments, feedback state chatbot agent component 155 facilitates programmatically implementing collecting feedback and/or routing to a human and start state chatbot agent component 153 based on aspects of the conversation with the user. In some embodiments, feedback state chatbot agent component 155 is the same type of agent as start state chatbot agent component 153 where the difference between the two agents are based on the role and conversational context. In some embodiments, feedback state chatbot agent component 155 only receives messages after and/or including the last answer and/or relevant content delivery whereas start state chatbot agent component 153 receives the entire conversation. In this regard, in some embodiments, the entire conversation is not provided to feedback state chatbot agent component 155 in order to ensure that the language model 110 does not focus on some previous feedback to the “was that useful?” message, which may compute the wrong action as the best one.

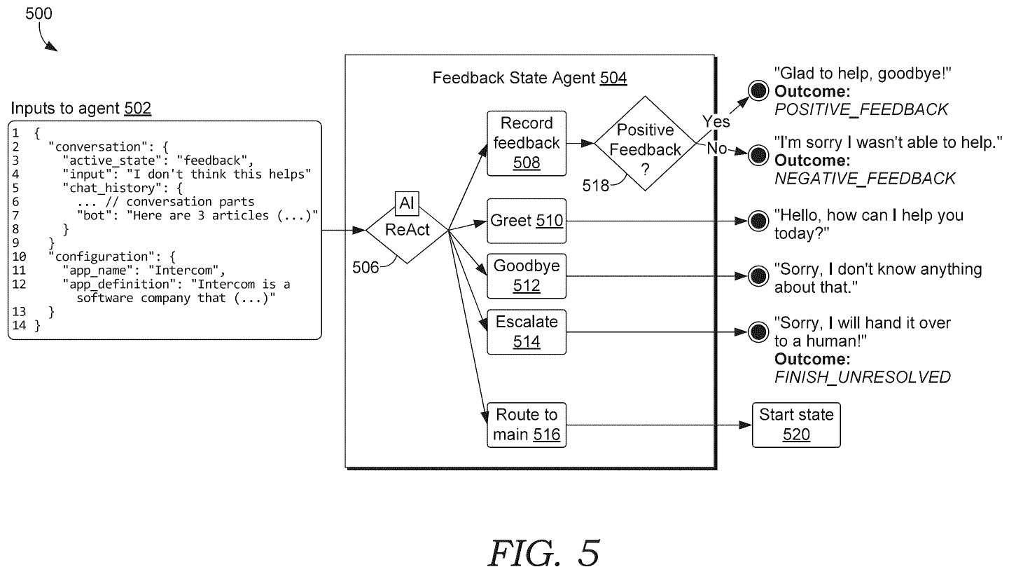

An example diagram 500 of a model implementing a feedback state agent of a chatbot is shown in FIG. 5. As shown in FIG. 5, in some embodiments, input 502 is received that includes conversation data, configuration data, and/or any other input for feedback state agent 504 (e.g. feedback state chatbot agent component 155). In some embodiments, as shown in the example in FIG. 5 the feedback state agent 504 can be implemented as a LangChain ReAct agent 506, which can implement a number of actions. For example, record feedback action 508 initiates a request for feedback. Feedback decision block 518 can then determine the type of response to the feedback based on whether the feedback is positive or negative. Greet action 510 initiates a greeting to the user. Goodbye action 512 initiates a parting remark to end the conversation. Escalate action 514 initiates a handover to a human (e.g., route to agent component 158 of FIG. 1). Route to main action 516 initiates the start state agent 520 (e.g., start state chatbot agent component 153 of FIG. 1). Each of the actions are described in further detail below with respect to feedback state chatbot agent component 155 of FIG. 1.

Returning to FIG. 1, in some embodiments, feedback state chatbot agent component 155 includes a record feedback action. Record feedback can be instructed to be used by feedback state chatbot agent component 155 in order receive feedback from a user. For example, after start state chatbot agent component 153 provides a message to the user requesting feedback (e.g., “was that helpful?”) following an attempt answer a user's query, a user's message replying to the message may trigger the record feedback action. Generally, the effect of the action is to record the feedback and add a conversation turn of the bot to with a response to user feedback appropriate for the given user feedback (e.g., “glad to help, you can ask me more questions”). For example, the feedback can be recorded (e.g., and utilized by chatbot analysis component 161) and/or parsed to determine whether there was feedback. In some embodiments, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to parse the response of the user for feedback may be provided in a prompt to language model 110 by feedback state chatbot agent component 155. Language model 110 may return a response to feedback state chatbot agent component 155 whether there was feedback and to provide a response to the feedback. Feedback state chatbot agent component 155 may record the feedback and provide the response to the feedback to the user through chat interface 108. In some embodiments, a hard coded response corresponding to a positive or negative feedback from a user can be included by feedback state chatbot agent component 155, for example, in case of the language model 110 failing to follow instructions.

In some embodiments, feedback state chatbot agent component 155 includes a greet action (e.g., greet action 510 of FIG. 5). Greet action can be instructed to be used by feedback state chatbot agent component 155 when it is time to greet the user. Generally, the effect of the action is to add a conversation turn of the bot to greet the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to greet the user may be provided in a prompt to language model 110 by feedback state chatbot agent component 155. Language model 110 may return a response to feedback state chatbot agent component 155 to provide a greeting. Feedback state chatbot agent component 155 may provide the greeting to the user through chat interface 108. In some embodiments, a hard coded response corresponding to a greet action can be included by feedback state chatbot agent component 155, for example, in case of the language model 110 failing to follow instructions.

In some embodiments, feedback state chatbot agent component 155 includes a goodbye action (e.g., goodbye action 512 of FIG. 5). Goodbye action can be instructed to be used by feedback state chatbot agent component 155 when it is time to say goodbye the user. Generally, the effect of the action is to add a conversation turn of the bot providing a parting remark to end the conversation (e.g., or a portion of the conversation) with the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a parting remark to the user may be provided in a prompt to language model 110 by feedback state chatbot agent component 155. Language model 110 may return a response to feedback state chatbot agent component 155 to provide a parting remark. Feedback state chatbot agent component 155 may provide the parting remark to the user through chat interface 108. In some embodiments, a hard coded response corresponding to a goodbye action can be included by feedback state chatbot agent component 155, for example, in case of the language model 110 failing to follow instructions.

In some embodiments, feedback state chatbot agent component 155 includes a route to teammate/escalate action (e.g., escalate action 318 of FIG. 3). In some embodiments, route to teammate/escalate action can be instructed based on determining a response from the user requires a human to communicate with the user. For example, route to teammate/escalate action can be instructed to be used when a user explicitly asks to talk to a human. Generally, the effect of the action is to add a conversation turn of the bot to provide a textual response informing the user that they are being redirected to a human (e.g., a CSA) and/or instructing route to agent component 158 of chatbot component 151 to initiate a handover of the conversation to the human. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a textual response informing the user that they are being redirected to a human and/or instructing route to agent component 158 of chatbot component 151 to initiate a handover of the conversation to the human may be provided in a prompt to language model 110 by feedback state chatbot agent component 155. Language model 110 may return a response to feedback state chatbot agent component 155 to provide a textual response informing the user that they are being redirected to a human and/or instructing route to agent component 158 of chatbot component 151 to initiate a handover of the conversation to the human. Feedback state chatbot agent component 155 may provide the textual response informing the user that they are being redirected to a human to the user through chat interface 108. Feedback state agent may communicate with route to agent component 158 of chatbot component 151 to initiate a handover of the conversation to the human. In some embodiments, a hard coded response corresponding to a route to teammate/escalate action can be included by feedback state chatbot agent component 155, for example, in case of the language model 110 failing to follow instructions.

In some embodiments, feedback state chatbot agent component 155 includes a route to start agent action (e.g., route to main action 516 of FIG. 5). Route to start agent action can be instructed to be used by feedback state chatbot agent component 155 when the user asks another question. In some embodiments, there is no visible effect in the conversation, but agency over conversation is transferred to start state chatbot agent component 153 and start state chatbot agent component 153 processes the last user message in order to determine the appropriate action.

Data regarding the prompts utilized by chatbot component 151 and/or data communicated to/from the language model 110, customer device 102, and/or customer support device 112 can be stored in any suitable storage location, such as storage 130, customer support device 112, server 150, some combination thereof, and/or other locations as communication records files 131 and/or chatbot configuration files 140.

In an example implementation, chat interface 108 provides interface functionality that allows a user (e.g., a customer) to communicate with a chatbot and/or a CSA. Generally, chat interface 108 presents one or more interaction elements that provide various interaction modalities for chatting with a chatbot and/or a CSA. In various embodiments, these tools are implemented using code that causes a presentation of a corresponding interaction element(s), and detects and interprets inputs interacting with the interaction element(s).

In an example implementation, chatbot preview tool 128 provides interface functionality that allows a user (e.g., CSA) to communicate with a chatbot, for example, to preview the functionality of the chatbot. Generally, chatbot preview tool 128 presents one or more interaction elements that provide various interaction modalities for chatting with a chatbot. In various embodiments, these tools are implemented using code that causes a presentation of a corresponding interaction element(s), and detects and interprets inputs interacting with the interaction element(s).

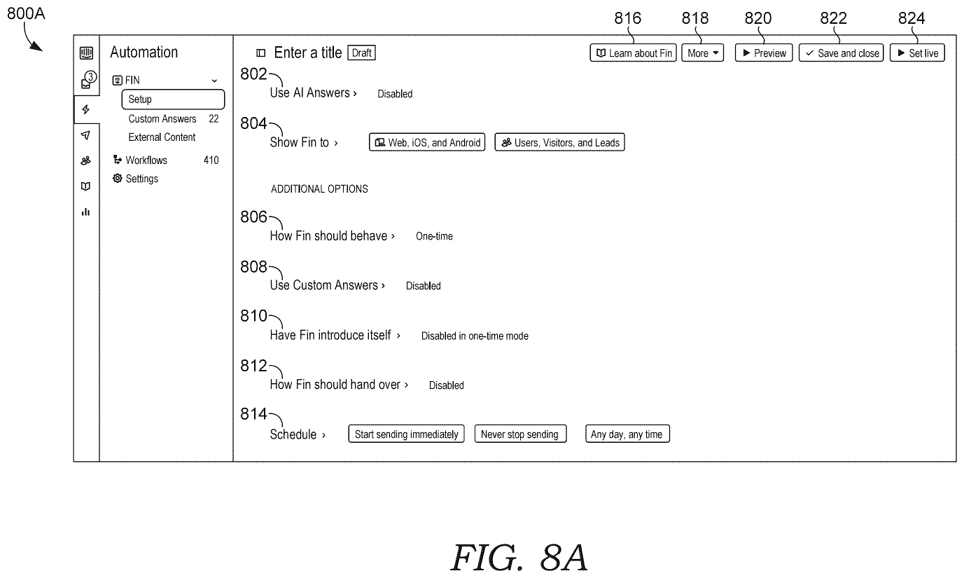

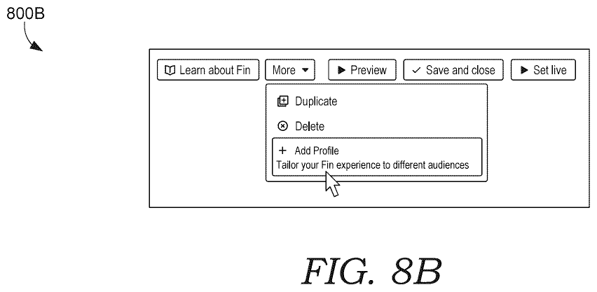

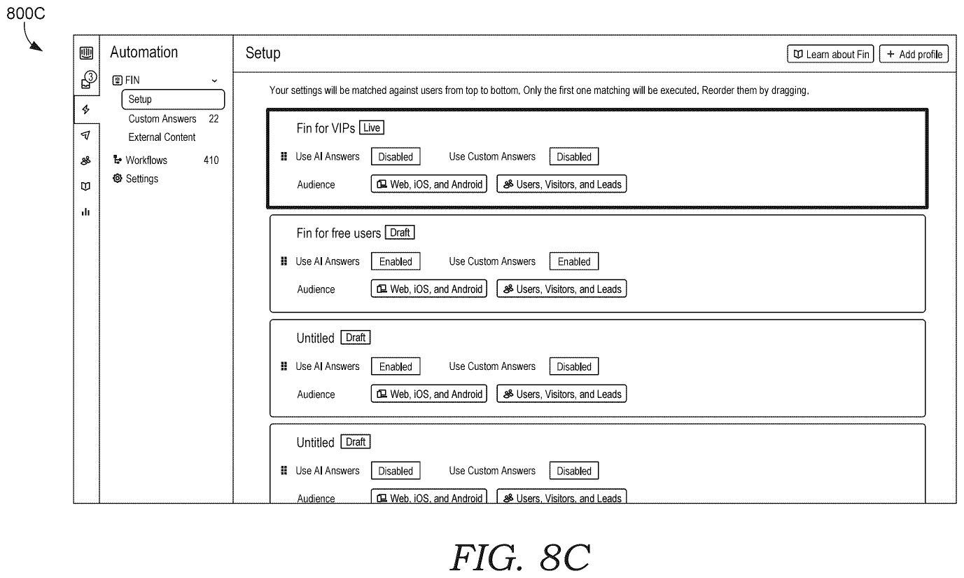

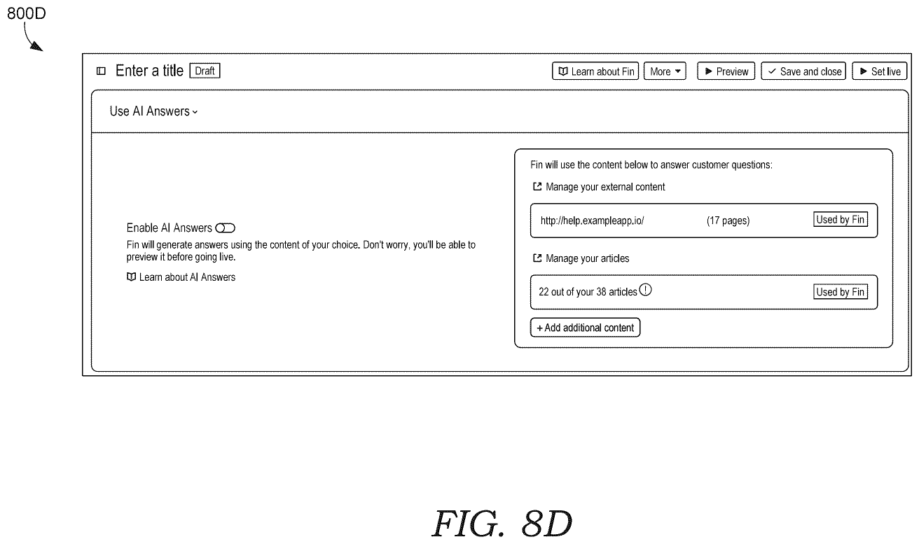

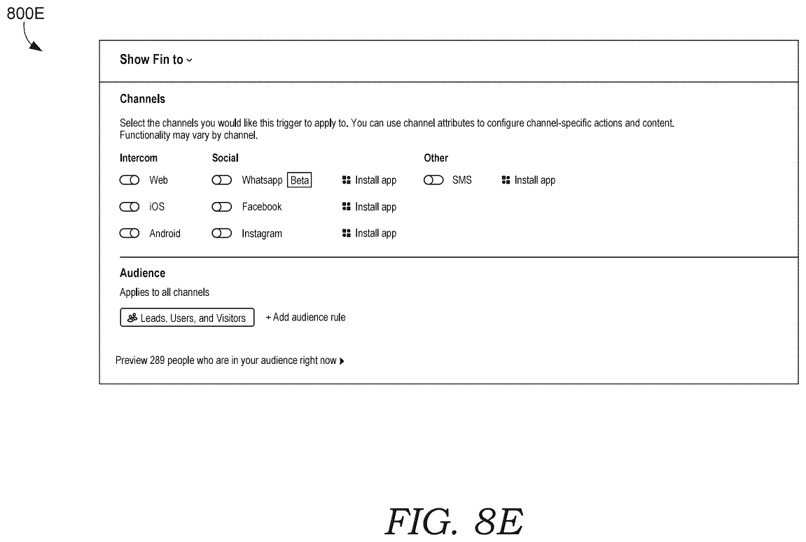

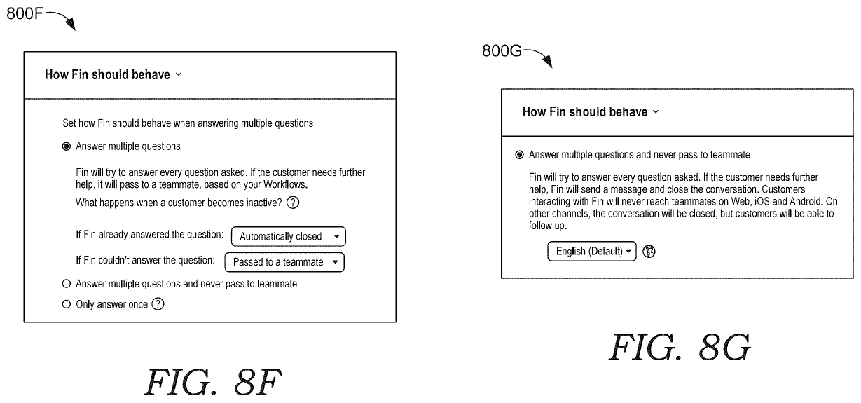

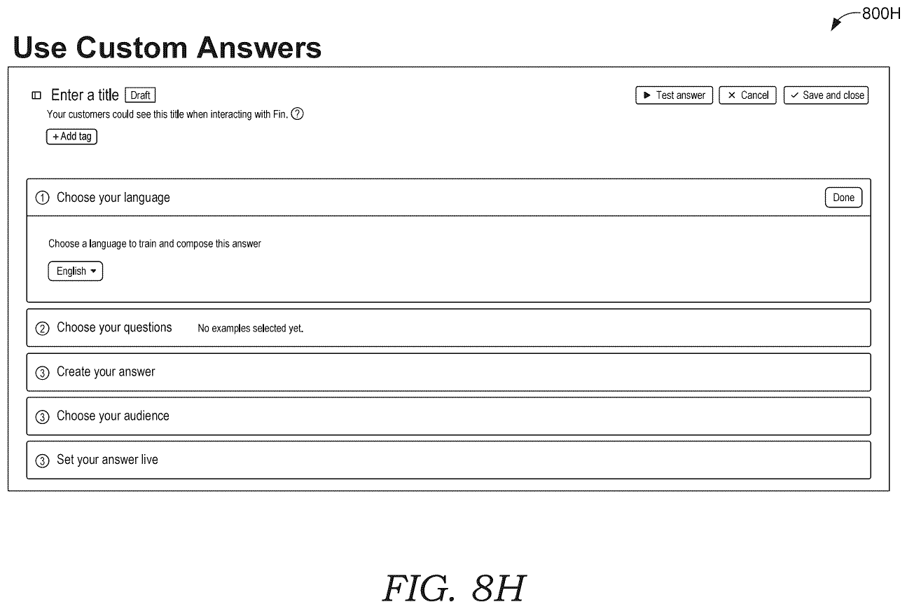

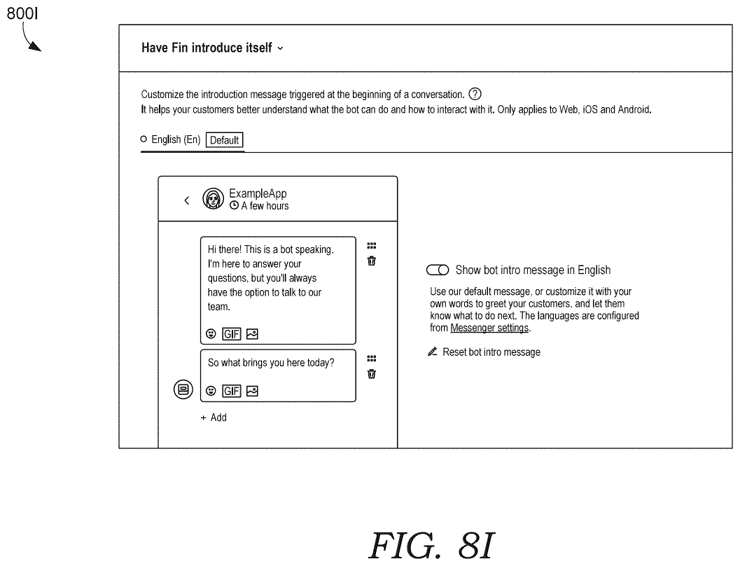

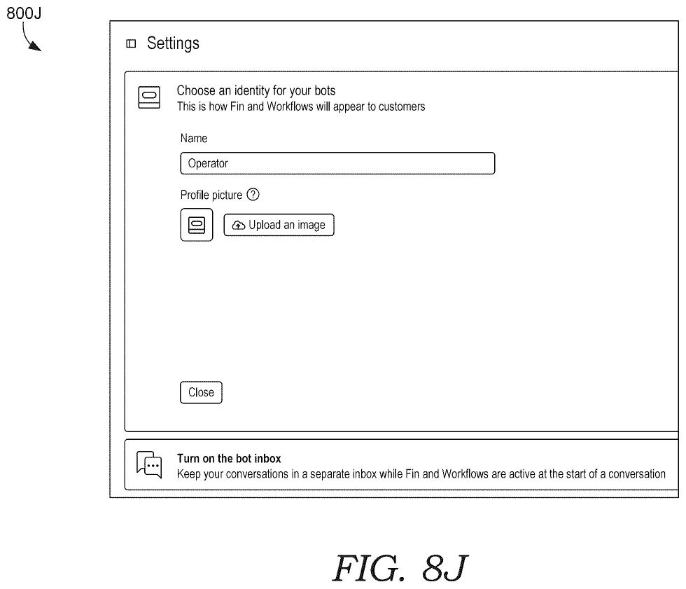

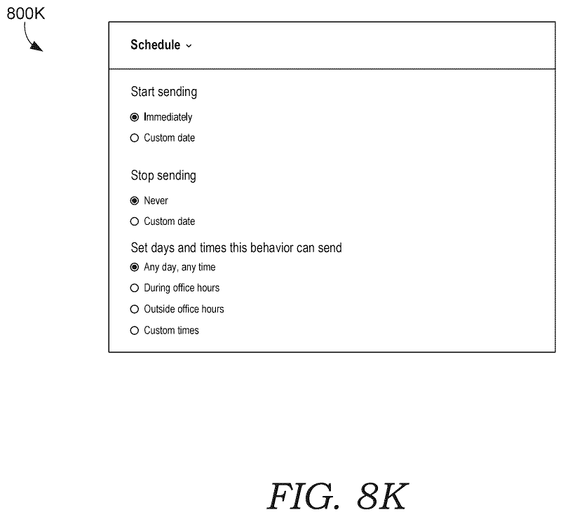

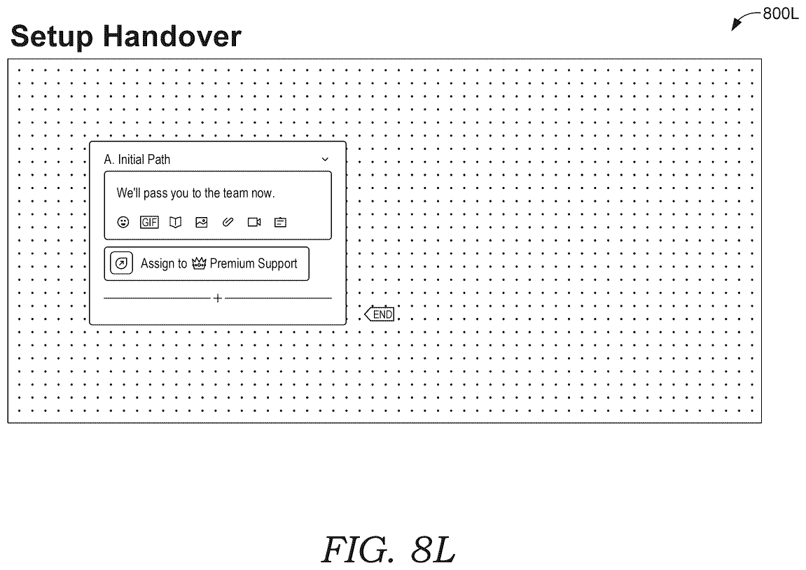

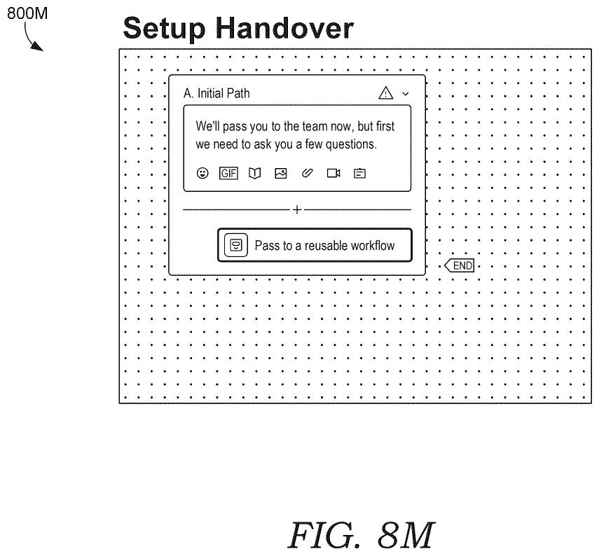

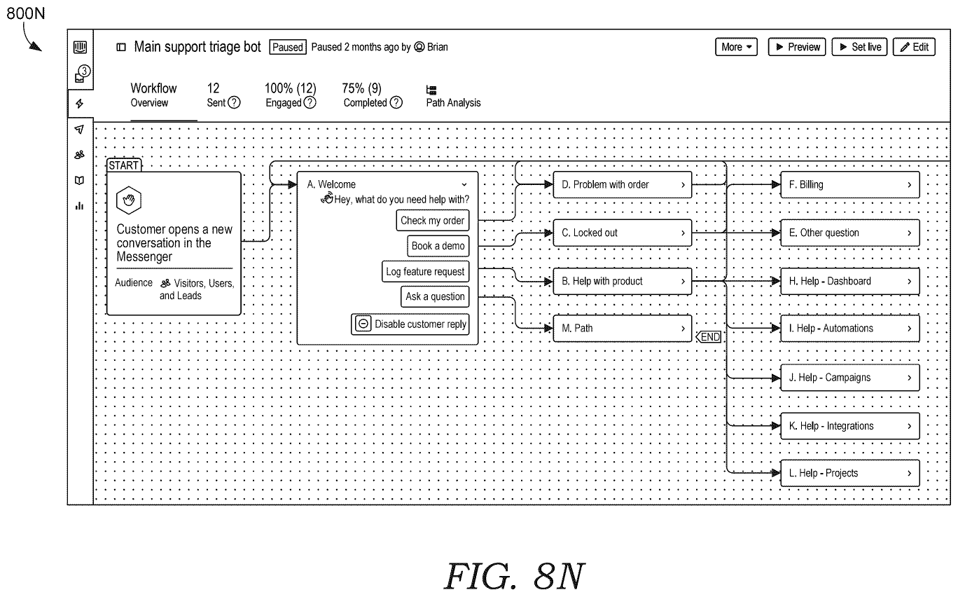

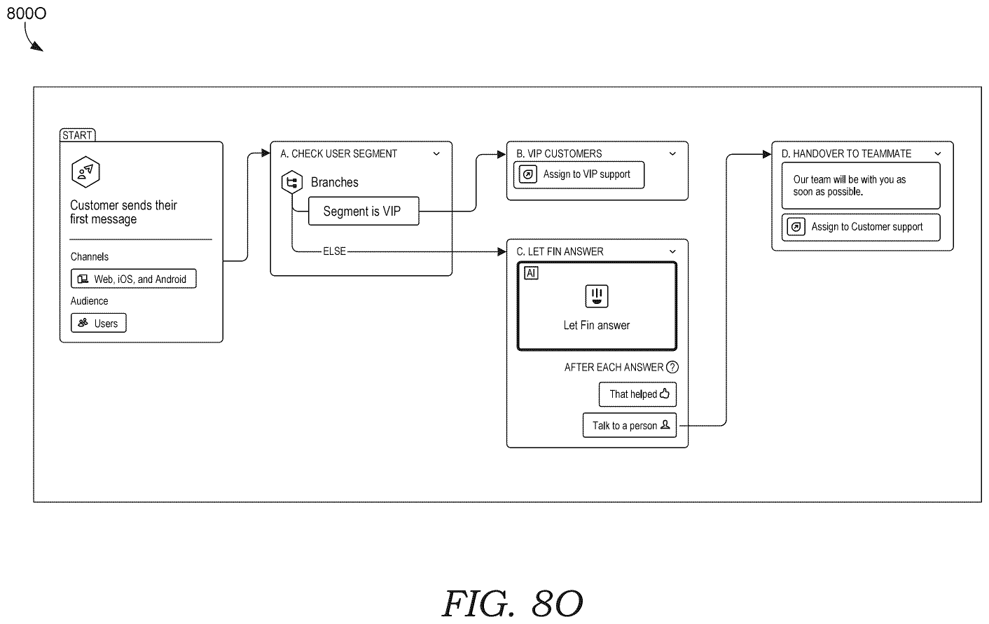

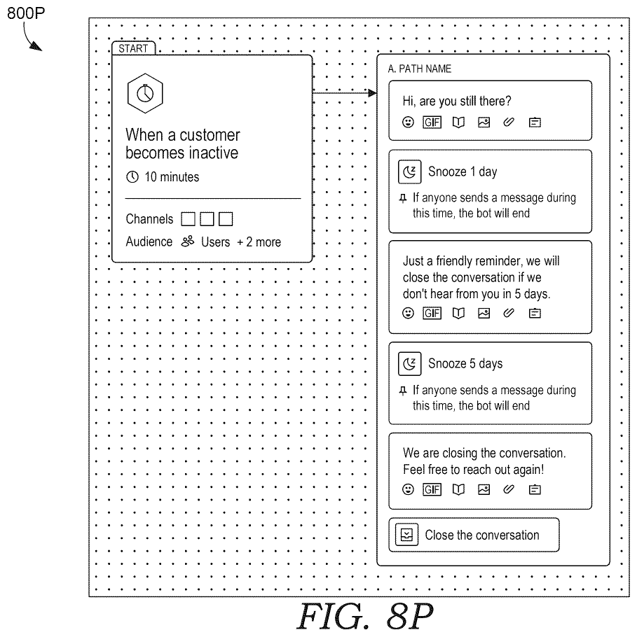

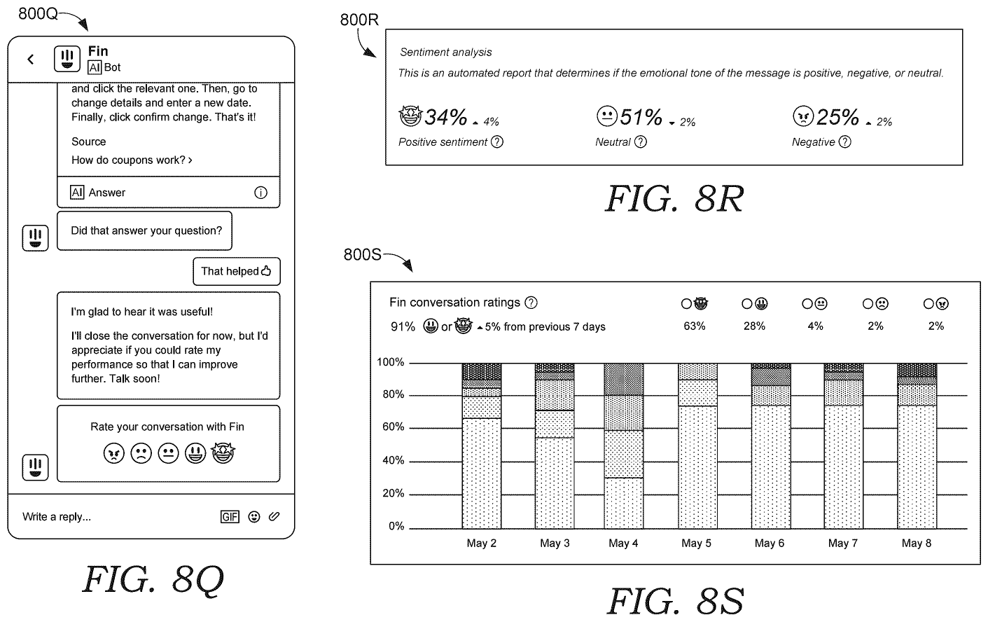

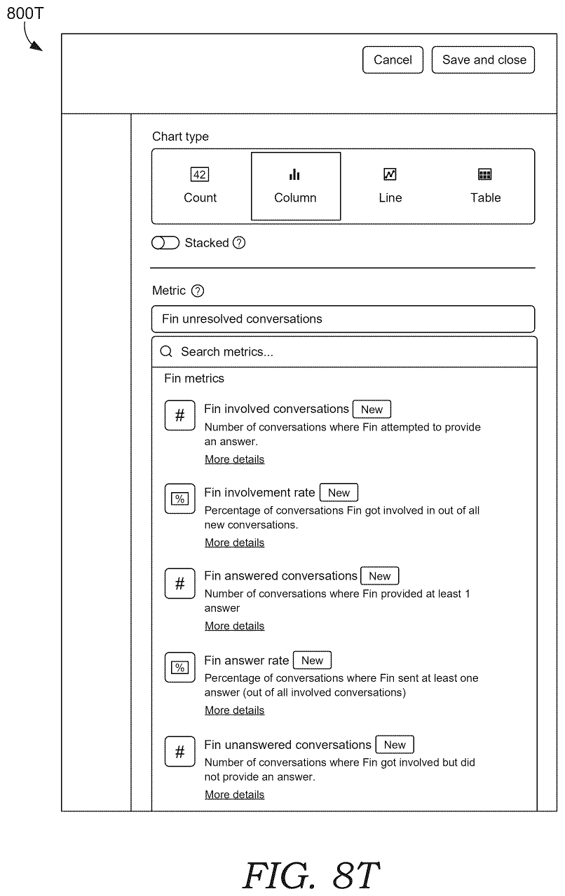

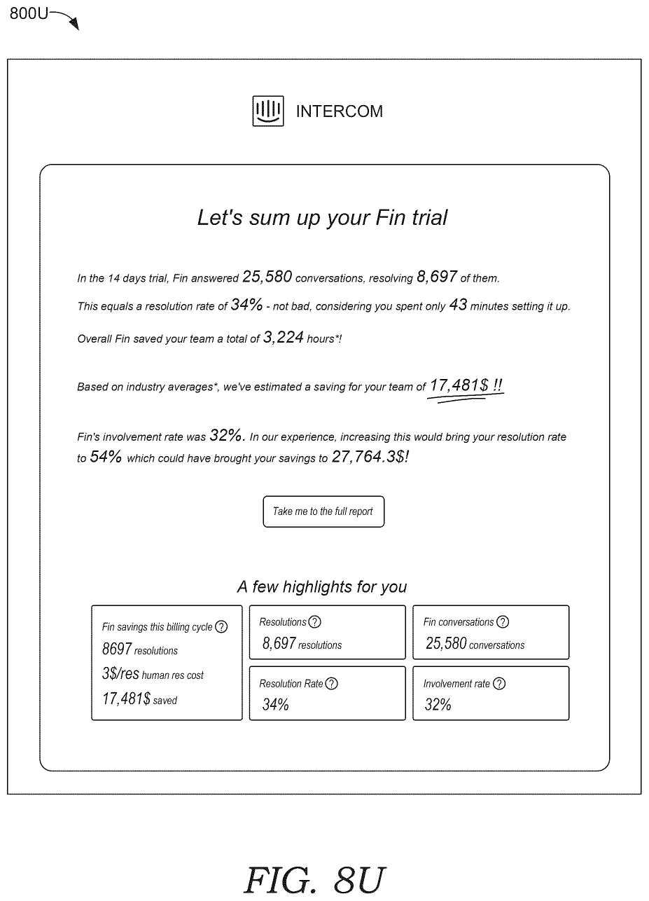

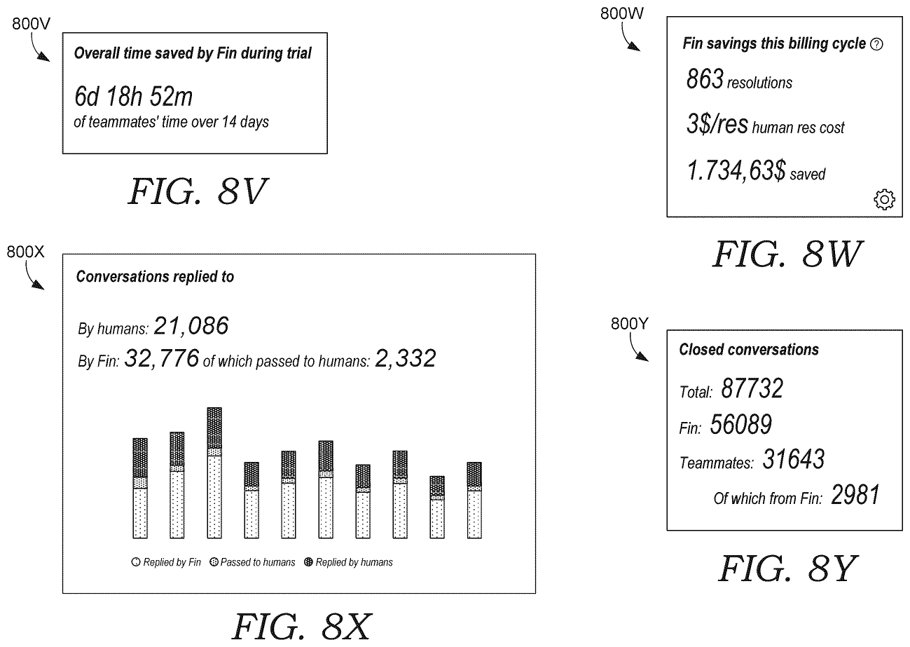

Examples of a chat interface displayed to a customer (e.g., via chat interface 108) and/or CSA (e.g., via chatbot preview tool 128) are shown in FIGS. 6A-6E and 8Q.

### Example Configuration Environment

Returning to FIG. 1, chatbot configuration component 152 facilitates programmatically implementing settings and/or configuration of the chatbot in order to customize the chatbot of chatbot component 151 with chat interface 108 of application 106 of customer device 102. Examples of details regarding settings and/or configuration of the chatbot implemented by chatbot configuration component 152 are discussed in further detail with respect to chatbot tool 170. For example, a chatbot implemented by chatbot component may have a specific configuration based on the type of customer, such as different sets of documents in a knowledge base or different language settings. In some embodiments, multiple chatbots with different configurations can be implemented, for example, in order to address different types of customers. Data regarding the configuration of the chatbot can be stored in any suitable storage location, such as storage 130, customer support device 112, server 150, some combination thereof, and/or other locations as chatbot configuration files 140, workflow configuration files 142, language configuration files 143, and/or third-party application configuration files 144.

Customer data accessing component 156 facilitates programmatically accessing customer data (e.g., customer data files 141) in order to implement a chatbot configuration of a chatbot implemented by chatbot component 151 based on the customer data of the customer. For example, a chatbot may access certain portions of the knowledge based on the status of the customer as a VIP. Customer data can be stored in any suitable storage location, such as storage 130, customer support device 112, server 150, some combination thereof, and/or other locations as customer data files 141. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer.

Knowledge base accessing component 157 facilitates programmatically implementing access to the knowledge base. In some embodiments, knowledge base accessing component 157 accesses portions of the knowledge base based on the configuration of the chatbot implemented by chatbot component 151. For example, the configuration of chatbot component 151 may indicate that only a specific set of documents of the knowledge base should be searched by the chatbot. In some embodiments, knowledge base accessing component 157 automatically syncs content (e.g., such as content provided by content management tool 173 and/or snippets tool 129) provided by the customer support application 116 and/or stored in knowledge base 132. Data regarding the configuration of the chatbot facilitating access to different portions of the knowledge base can be stored in any suitable storage location, such as storage 130, customer support device 112, server 150, some combination thereof, and/or other locations as chatbot configuration files 140.

Route to agent component 158 facilitates programmatically implementing routing of a conversation from a chatbot to a CSA via the customer support component 165 to the communication tool 120 of the customer support application 116. For example, if a customer request to speak to a person or the chatbot decides to route to teammate/escalation action, route to agent component 158 automatically implements the routing of the conversation from the chatbot to a CSA. Data regarding the configuration of the chatbot to route to a CSA can be stored in any suitable storage location, such as storage 130, customer support device 112, server 150, some combination thereof, and/or other locations as chatbot configuration files 140.

Chat workflow implementation component 159 facilitates programmatically implementing chat workflows designed to implement bots, triggers, conditions, and/or rules for chats. For example, a CSA can designed a chat workflow through cat workflow design tool so that the chatbot automatically implements certain actions, such as asking for specific information, before routing to a CSA. Data regarding chat workflows of the chatbot can be stored in any suitable storage location, such as storage 130, customer support device 112, server 150, some combination thereof, and/or other locations as workflow configuration files 142.

Custom answers component 160 facilitates programmatically implementing manually written answers and/or chat workflows to specific questions from customers by prioritizing the custom answers over AI-generated answers from the chatbot. In some embodiments, custom answers are searched using SBERT directly. For example, an embedding generated based on the customer's query can be searched against embeddings of one or more example questions corresponding to a custom answer (e.g., a user of customer support application 116 can input multiple examples of a single question. In some embodiments, the custom answer can include examples of questions, keywords, and/or phrases to automatically call a chat workflow designed in chat workflow design tool 180 and implemented by chat workflow implementation component 159. For example, if a customer requests a refund through chat interface 108, the custom answer for a refund can be determined through SBERT, which implements a chat workflow that automatically calls an API to trigger a refund. Data regarding custom answers can be stored in any suitable storage location, such as storage 130, customer support device 112, server 150, some combination thereof, and/or other locations as custom answer files 139.

Chatbot analysis component 161 facilitates programmatically generating reports by analyzing chatbot performance chatbot conversation monitoring, chatbot customer satisfaction score (CSAT), usage metrics, usage limits notifications, performance/return on investment (ROI) metrics, custom reports, and/or content-level metrics regarding access to content. Data regarding analysis of chatbots can be stored in any suitable storage location, such as storage 130, customer support device 112, server 150, some combination thereof, and/or other locations as metrics files 145.

In an example implementation, chatbot tool 170 provides interface functionality that allows a user (e.g., a CSA) of customer support application 116 to implement settings and/or configuration of the chatbot in order to customize the chatbot of chatbot component. Generally, chatbot tool 170 presents one or more interaction elements that provide various interaction modalities for customizing the chatbot. In various embodiments, these tools are implemented using code that causes a presentation of a corresponding interaction element(s), and detects and interprets inputs interacting with the interaction element(s). An example of chatbot tool 170 is shown in FIG. 8A.

In the example implementation in FIG. 1, chatbot tool 170 includes chatbot introduction customization tool 171 that allows the user to provide a custom introduction for the chatbot, which can be stored in chatbot configuration files 140. An example of chatbot introduction customization tool 171 is shown in FIG. 8I.

Chatbot tool 170 includes chatbot identity customization tool 172 that allows the user to rename the chatbot and/or change the image/icon for the chatbot, which can be stored in chatbot configuration files 140. An example of chatbot identity customization tool 172 is shown in FIG. 8J.

Chatbot tool 170 includes content management tool 173 that allows the selection of content of the knowledge base 132 that the chatbot uses to search for answers. For example, the CSA may not want to utilize certain content as the content may be outdated. As another example, different content can be utilized for different audiences to target the chatbot to different audiences, such as based on customer data or customer segment (e.g., VIP customer). In some embodiments, knowledge base accessing component 157 automatically syncs any content (e.g., such as content provided by content management tool 173) provided by the customer support application 116 and/or stored in knowledge base 132. In some embodiments, content management tool 173 allows the selection of multimodal content stored in knowledge base 132 in order for the chatbot to provide multimodal answers, such as images, audio, and/or video in responses. In some embodiments, content management tool 173 allows the selection of external systems, such as an external application (e.g., an ecommerce store and/or system) through third-party application configuration files 144, in order for the chatbot to utilize external systems to provide answers. An example of content management tool 173 is shown in FIG. 8D.

Chatbot tool 170 includes audience selection tool 174 that allows the selection of audience to target the chatbot, such as based on customer data or customer segment (e.g., VIP customer) based on customer data stored in customer data files 141. Examples of audience selection tool 174 are shown in FIGS. 8B and 8C.

Chatbot tool 170 includes communication channel selection tool 175 that allows the selection of various communication channels, such as Web, mobile, application, telephonic, SMS, messaging applications, social media, email, and/or any communication channel (e.g., as stored in third-party application configuration files 144). In some embodiments, the chatbots can be deployed on any number of communication channels. In some embodiments, different settings/configuration of the chatbot can be applied to different communication channels. For example, only some content of knowledge base 132 may be utilized by chatbot for customers communicating through a specific communication channel. In some embodiments, communication channel selection tool 175 allows the selection of multimodal receiving input user queries and/or outputting responses by the chatbot via audio. An example of communication channel selection tool 175 is shown in FIG. 8E.

Chatbot tool 170 includes chatbot behavior settings tool 176 that allows a user to provide settings for the chatbot regarding how the chatbot should behave when answering multiple questions and/or when to handover the chatbot to a teammate, which can be stored in chatbot configuration files 140. Examples of chatbot behavior settings tool 176 are shown in FIGS. 8F and 8G.

Chatbot tool 170 includes inactive conversations settings tool 177 that allows a user of customer support application 116 to set automatic replies to inactive conversations, which can be stored in chatbot configuration files 140 and/or workflow configuration files 142. For example, inactive conversations settings tool 177 can send auto-replies to snoozed conversations. As another example, inactive conversations settings tool 177 can automate snoozing and set conversation pacing with new actions. As yet another example, inactive conversations settings tool 177 can automatically reroute conversations that receive no response to a human, such as a CSA. In some embodiments, inactive conversations settings tool 177 is implemented through chat workflow design tool 180 as a part of a chat workflow. An example of inactive conversations settings tool 177 is shown in FIG. 8P.

Chatbot tool 170 includes language settings tool 178 allows the chatbot to be multilingual and/or target the chatbot differently to customers in different languages, which can be stored in language configuration files 143. For example, only some content of knowledge base 132 may be utilized by chatbot for customers communicating in a specific language. Example of language settings tool 178 are shown in FIGS. 8G and 8I.

Chatbot tool 170 includes scheduling settings tool 179 that allows a user to provide settings as to when to enable a chatbot, which can be stored in chatbot configuration files 140. For example, the chatbot can be implemented only for certain timeframe. An example of scheduling settings tool 179 is shown in FIG. 8K.

Chatbot tool 170 includes chat workflow design tool 180 allows the user of the customer support application 116 to design chat workflows, which can be stored as workflow configuration files 142. For example, the user can design chat workflows to handoff to support teams or to other bots. For example, a chatbot can include a chat workflow can be designed to automatically handover to a CSA when the chatbot cannot answer the question. As another example, a chat workflow can be designed to automatically implement a chat workflow to request additional information from the customer before handing the chat over to a CSA when the chatbot cannot answer a question. In some embodiments, the chatbot that uses a language model to determine answers from a knowledge base can be implemented in an initial block of the chat workflow. In some embodiments, a chat workflow can be designed to implement the chatbot that uses a language model to determine answers from a knowledge base at a later block in the workflow. For example, the chatbot may determine whether the customer data indicates the customer is not a VIP customer that is automatically assigned to a CSA before implementing the chatbot that uses a language model to determine answers from a knowledge base. Examples of chat workflow design tool 180 are shown in FIGS. 8L, 8M, 8N, 8O, and 8P.

Chatbot tool 170 includes chatbot analysis tool 181 that provides an interface for generating reports analyzing chatbot performance, such as through chatbot conversation monitoring, chatbot CSAT, usage metrics, usage limits notifications, performance/ROI metrics, custom reports, and/or content-level metrics, which can be stored as metrics files 145. Examples of chatbot analysis tool 181 and output of chatbot analysis tool 181 are shown in FIGS. 8Q, 8R, 8S, 8T, 8U, 8V, 8W, 8X, and 8Y.

Chatbot tool 170 includes custom answers tool 182 that provides an interface for a user to implement manually written answers and/or chat workflows to specific questions from customers. For example, a user of the customer support application 116 may provide a specific written answer and examples of potential customer questions that would require the specific written answer so that specific written answer is provided without requiring the chatbot to call the language model. In some embodiments, the custom answer can include examples of questions, keywords, and/or phrases to automatically call a chat workflow designed in chat workflow design tool 180 and implemented by chat workflow implementation component 159. For example, if a customer requests a refund through chat interface 108, the custom answer for a refund can be determined through SBERT based on aspects of the conversation, which implements a chat workflow that automatically calls an API to trigger a refund. An example of custom answers tool 182 is shown in FIG. 8H.

### Example Customer Support Communication Environment

Continuing with FIG. 1, in some embodiments, customer support component 165 provides functionality to enable communication between customer support application 116 and chat interface 108. Data regarding conversations between customers and CSA can be stored in any suitable storage location, such as storage 130, customer support device 112, server 150, some combination thereof, and/or other locations as communication records files 131.

In some embodiments, messages routing component 166 routes messages from conversations from customers, such as conversations between a customer and a chatbot (e.g., through route to agent component 158 of chatbot component 151). In some embodiments, messages routing component 166 routes messages to and/or from customers from various communication channels, such as Web, mobile, application, telephonic, SMS, messaging applications, social media, email, and/or any communication channel. Messages routing component 166 can route messages to message inbox interface 122 and/or chat interface 124 of a customer support application 116 of a CSA.

In some embodiments, AI-assisted chat component 167 assists customer support in responding to customers in chats using AI. For example, a language model may be called to revise an initial response drafted by the CSA to expand the response, rephrase the response, make the response more formal, make the response friendlier, and/or the like. As another example, using a similar process as the answer search state component 154 of chatbot component 151, the AI-assisted chat component 167 can determine answers to customer queries and provide the answers as suggestions to the CSA to respond to the customer query.

In some embodiments, snippets component 168 can programmatically extract conversational snippets from conversations between a customer and a CSA (e.g., from a communication record of communication records files 131, such as a chat log, chat transcript, meeting transcript, email, or other communication between a customer and a CSA). For example, a customer initiates a chat with a CSA through a chat interface 108 of application 106 executing on customer device 102. During the chat, the customer asks the CSA a series of questions and the CSA provides answers to each question through chat interface 124 of application 116 executing on customer support device 112 before the chat is ended. After the chat ends, the chat is stored (e.g., communication records files 131) so that the chat can be accessed in order to extract each question and corresponding answer (“Q&A pairs”) from the chat in a subsequent block. In some embodiments, the conversation can be accessed from the communication record by snippets component 168 during the conversation (e.g., chat) between the customer and the CSA in order to extract Q&A pairs from the conversation during the conversation. Snippets component 168 generates a prompt to language model 110 in order to extract Q&A pairs from the portion of the conversation record and to generate a single, summarized Q&A pair based on the Q&A pairs extracted from the conversation record. In some embodiments, snippets component generates a prompt to language model 110 to tag each Q&A pair of the conversation with contextual metadata corresponding to each of the Q&A pairs and filter irrelevant Q&A pairs of the conversation based on the metadata of each Q&A pair before generating a single, summarized Q&A pair based on the remaining Q&A pairs extracted from the conversation record. Examples of contextual metadata include: (1) contextual metadata corresponding to whether the question was answered by a human (e.g., a CSA) or a bot (e.g., the chatbot); (2) contextual metadata corresponding to the topic of the Q&A pair; (3) contextual metadata corresponding to a score indicating the relevance of the Q&A pair to other customers; and/or (4) contextual metadata corresponding to a dialog classification corresponding to a category of the type of dialogue. Examples of the type of dialogue can include: (a) informational content where an answer in the Q&A pair is directed to general information, knowledge and/or instructions; (b) a clarification where an answer in the Q&A pair is a request for clarification from the user; (c) a CSA action where an answer in the Q&A pair required the CSA to take some action on the background of the conversation; (d) a feature request where an answer in the Q&A pair is directed to future product improvements or feature requests; and/or (e) other categories or a category for an answer in the Q&A pair does not fit into the previous specified types of dialogue.

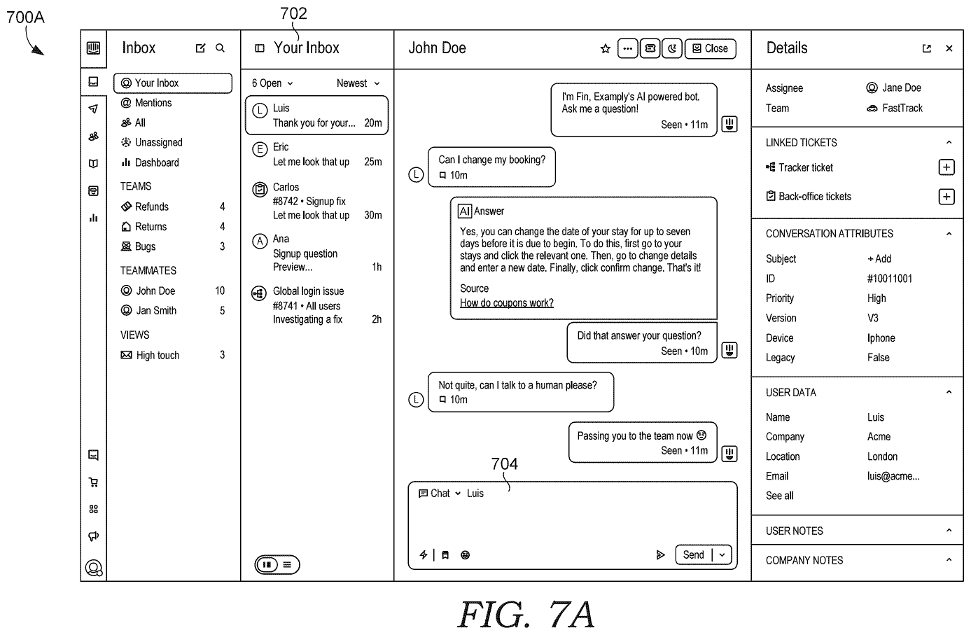

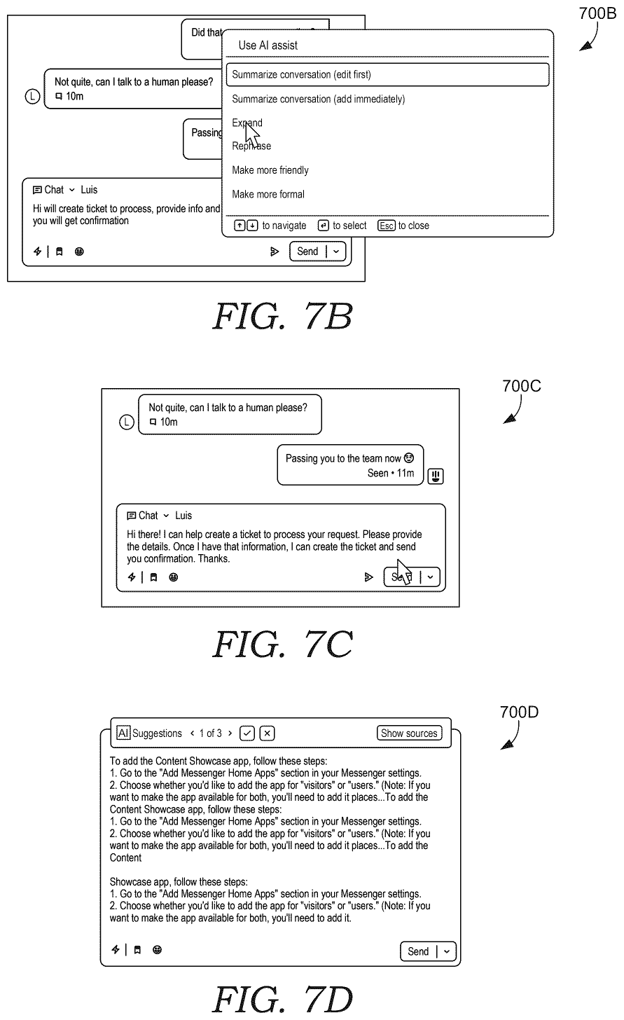

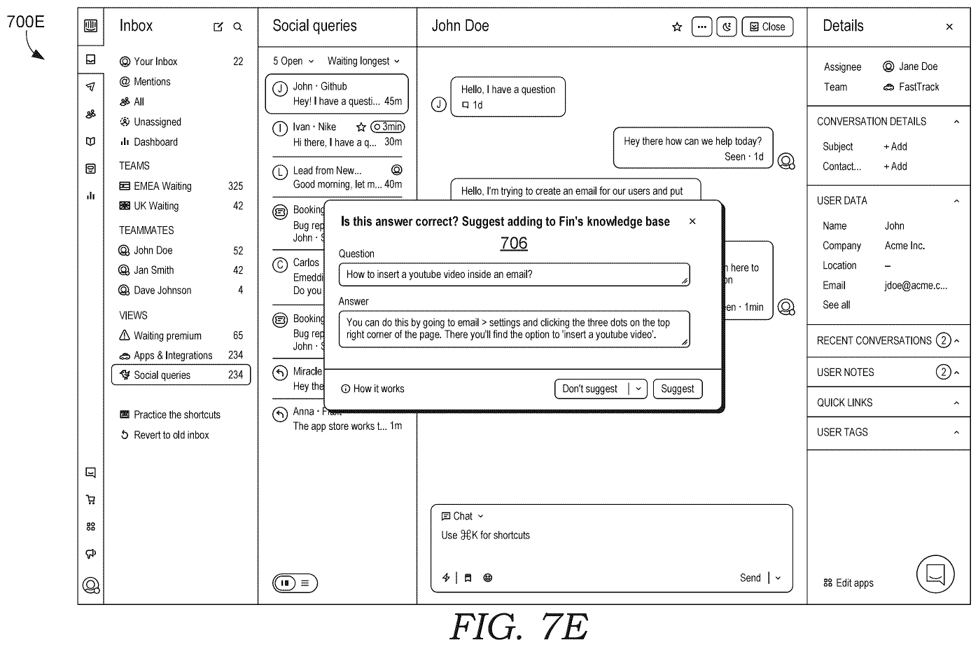

In an example implementation, communication tool 120 provides interface functionality that allows a user (e.g., a CSA) to chat with a customer, chat with a customer with AI-assisted chat capabilities, trigger extractions of snippets, interact with messages from various customers and/or communication channels through their inbox, and/or preview a chatbot through interactions with an interface controlled by communication tool 120. Generally, communication tool 120 presents one or more interaction elements that provide various interaction modalities for its functionality. In various embodiments, these tools are implemented using code that causes a presentation of a corresponding interaction element(s), and detects and interprets inputs interacting with the interaction element(s). An example of communication tool 120 is shown in FIG. 7A.

In the example implementation in FIG. 1, communication tool 120 includes messages inbox interface 122 that allows a user of customer support application 116 to view conversations from various customers and/or communication channels. An example of messages inbox interface 122 is shown in FIG. 7A. Communication tool 120 includes chat interface 124 that allows a user to communicate and/or view a chat with a customer, such as a conversation between a customer and a CSA and/or a chatbot. An example of chat interface 124 is shown in FIG. 7A. Communication tool 120 includes AI-assisted chat tool 126 that assists customer support in responding to customers in chats using AI. Examples of AI-assisted chat tool 126 is shown in FIGS. 7B, 7C, and 7D.

Communication tool 120 includes chatbot preview tool 128 allows the user of the customer support application 116 to preview the chatbot, such as before setting the chatbot live for customers. An example of chatbot preview tool 128 is shown in FIGS. 6A, 6B, 6C, 6D, and 6E.

Communication tool 120 includes snippets tool 129 that provides an interface so that users of customer support application 116 can add snippets determined from conversational data (e.g., communication records files 131) by snippets component 168 to add to the knowledge base 132 (e.g., snippets files 133). In this regard, the answers in snippets of snippets files 133 can be edited, targeted (e.g., by content management tool 173), and managed in the knowledge base utilized by the chatbot to provide answers. An example of snippets tool 129 is shown in FIG. 7E.

### Example Chat Interface

FIG. 6A provides an example chat interface 600A between a chatbot and a user, in accordance with embodiments of the present disclosure. FIG. 6B provides an example chat interface 600B between a chatbot and a user showing the delivery of responses word by word from the chatbot to the user, in accordance with embodiments of the present disclosure. As can be understood, in some embodiments, responses (e.g., answers) from the chatbot are deliver word by word to the end user in order to reduce answer latency. FIG. 6C provides an example chat interface 600C between a chatbot and a user showing a response from the chatbot with a corresponding source of the response, in accordance with embodiments of the present disclosure.

FIG. 6D provides an example chat interface 600D between a chatbot and a user showing responses from the chatbot including a request for feedback, request for clarification, and a response with a prompt to route to a human, in accordance with embodiments of the present disclosure. FIG. 6E provides an example chat interface 600E between a chatbot and a user showing a response from the chatbot that routes the chat with the user to a human, in accordance with embodiments of the present disclosure.

### Example Customer Support Application Interface

FIG. 7A provides an example interface 700A of a customer support application, including, among other things, an inbox and a chat interface, in accordance with embodiments of the present disclosure. As can be understood, example interface 700 provides inbox 702 with a number of messages from various communication channels and chat interface 704 for communicating with customers. FIG. 7B provides an example chat interface 700B of a customer support application, including an AI-assisted chat tool, in accordance with embodiments of the present disclosure. FIG. 7C provides an example chat interface 700C of a customer support application implementing the AI-assisted chat tool on the chat interface of FIG. 7B, in accordance with embodiments of the present disclosure. As can be understood, as the CSA selects expand, the language model is called to automatically expand the response provided by the CSA in example chat interface 700B of FIG. 7B to a longer response in the example chat interface 700C of FIG. 7C

FIG. 7D provides an example chat interface 700D of a customer support application implementing an AI-assisted chat tool to search for answers in knowledge base using a language model, in accordance with embodiments of the present disclosure. As can be understood, the language model is called to provide a suggested response for the CSA to send to the customer based on the conversation between the CSA and the customer.

FIG. 7E provides an example interface 700E for adding a conversational snippet from a communication record to a knowledge base, in accordance with embodiments of the present disclosure. In this example, interface 700E provides a list of chats with a selected chat. As can be understood, the suggestion element 706 of the single, summarized Q&A pair corresponding to the extracted conversational snippet from the conversation of selected chat is displayed to the end user (e.g., the CSA). The end user can then select whether to suggest adding the single, summarized Q&A pair to the knowledge base to store the Q&A pair through suggestion element 706.

### Example Chatbot Configuration Interface

FIG. 8A provides an example interface 800A of a chatbot tool of a customer support application, in accordance with embodiments of the present disclosure. In this example, interface 800A allows the CSA to customize the settings/configuration of the chatbot. For example, interface 800A provides a tool 802 to implement a chatbot using a language model to provide answers from a knowledge base. Interface 800A provides tool 804 including an audience selection tool and a communication channel selection tool. Interface 800A provides tool 806 including a chatbot behavior tool. Interface 800A provides tool 808 for custom answers. Interface 800A provides tool 810 for introduction customization. Interface 800A provides tool for handover. Interface 800A provides tool 814 for scheduling. Interface 800A provides tool 816 for help with the chatbot configuration. Interface 800A provides tool 818 for additional options shown in example interface 800B of FIG. 8B. Interface 800A provides tool 820 as a chatbot preview. Interface 800A provides tool for saving and/or closing out of the chatbot configuration. Interface 800A provides tool 824 to set the chatbot live.

FIG. 8B provides an example interface 800B of an audience selection tool of a chatbot tool of a customer support application, in accordance with embodiments of the present disclosure. FIG. 8C provides another example interface 800C of an audience selection tool of a chatbot tool of a customer support application, in accordance with embodiments of the present disclosure. In the examples, interface 800B of FIG. 8B and interface 800C of FIG. 8C provide tools to tailor the chatbot to different audiences. For example, different chatbots and/or content utilized by the chatbots can be utilized for different audiences to target the chatbot to different audiences, such as based on customer data or customer segment (e.g., VIP customer).

FIG. 8D provides an example interface 800D of a content management tool of a chatbot tool of a customer support application, in accordance with embodiments of the present disclosure. In this example, interface 800D provides at tool to manage the content utilized by the chatbot to provide answers. For example, the CSA may not want to utilize certain content as the content may be outdated. As another example, different content can be utilized for different audiences to target the chatbot to different audiences, such as based on customer data or customer segment (e.g., VIP customer).

FIG. 8E provides an example interface 800E of a communication channel selection tool of a chatbot tool of a customer support application, in accordance with embodiments of the present disclosure. In this example, interface 800E provides a tool to customize the communication channels and audience for which the chatbot is implemented. For example, different settings/configuration of the chatbot can be applied to different communication channels. In this regard, only some content of the knowledge base may be utilized by the chatbot for customers communicating through a specific communication channel.

FIG. 8F provides an example interface 800F of a chatbot behavior settings tool of a chatbot tool of a customer support application, in accordance with embodiments of the present disclosure. In this example, interface 800F provides a tool to determine whether the chatbot should answer multiple questions and when to close and/or handoff to a human. FIG. 8G provides another example interface 800G of a chatbot behavior settings tool of a chatbot tool of a customer support application, in accordance with embodiments of the present disclosure. In this example, interface 800G provides a tool to include a setting for the chatbot to never handover to a human.

FIG. 8H provides an example interface 800H of a custom answers tool of a chatbot tool of a customer support application, in accordance with embodiments of the present disclosure. In this example, interface 800H provides a tool to manually implement written answers and/or chat workflows to specific questions from customers. For example, a CSA may provide a specific written answer and examples of potential customer questions that would require the specific written answer so that specific written answer is provided without requiring the chatbot to call the language model. In some embodiments, the custom answer can include examples of questions, keywords, and/or phrases to automatically call a chat workflow (e.g., as designed in chat workflow design tool of example interface 800N of FIG. 8N).

FIG. 8I provides an example interface 800I of a chatbot introduction customization tool and a language settings tool of a chatbot tool of a customer support application, in accordance with embodiments of the present disclosure. In this example, interface 800I provides to customize introduction of the chatbot. FIG. 8J provides an example interface 800J of a chatbot identity customization tool of a chatbot tool of a customer support application, in accordance with embodiments of the present disclosure. In this example, interface 800J provides a tool to customize the name and image/icon of the chatbot.

FIG. 8K provides an example interface 800K of a scheduling tool of a chatbot tool of a customer support application, in accordance with embodiments of the present disclosure. In this example, interface 800K provides a tool to determine when to implement the chatbot. For example, the chatbot can be implemented only for certain timeframe.

FIG. 8L provides an example interface 800L of a chat workflow design tool of a chatbot tool of a customer support application for setting up a handover from the chatbot to human support, in accordance with embodiments of the present disclosure. In this example, interface 800L provides a chat workflow design tool to hand off the chatbot to a human. For example, a chatbot can include can be designed to automatically handover to a CSA when the chatbot cannot answer the question.

FIG. 8M provides another example interface 800M of a chat workflow design tool of a chatbot tool of a customer support application for setting up a handover from the chatbot to a chat workflow, in accordance with embodiments of the present disclosure. In this example, interface 800M provides a chat workflow design tool to hand off the chatbot to a workflow. For example, a chat workflow can be designed to automatically implement a chat workflow (e.g., as designed in chat workflow design tool of example interface 800N of FIG. 8N) to request additional information from the customer before handing the chat over to a CSA when the chatbot cannot answer a question.

FIG. 8N provides another example interface 800N of a chat workflow design tool of a chatbot tool of a customer support application for designing a chat workflow, in accordance with embodiments of the present disclosure. In this example, interface 800N provides a chat workflow design tool following the hand off to a workflow of interface 800M of FIG. 8M. As can be understood, following handoff from the chatbot, a number of bots, triggers, conditions, and/or rules can be triggered to request additional information from the customer before passing the customer to a CSA.

FIG. 8O provides another example interface 800O of a chat workflow design tool of a chatbot tool of a customer support application for designing a chat workflow that implements the chatbot at a later block in the chat workflow instead of an initial block of a chat workflow, in accordance with embodiments of the present disclosure. In this example, interface 800O provides an example chat workflow implementing the chatbot that uses a language model to determine answers from a knowledge base at a later block in the workflow. For example, the chat workflow may determine whether the customer data indicates the customer is not a VIP customer that is automatically assigned to a CSA before implementing the chatbot that uses a language model to determine answers from a knowledge base.

FIG. 8P provides an example interface 800P of an inactive conversations settings tool of a chat workflow design tool of a chatbot tool of a customer support application for designing a chat workflow, in accordance with embodiments of the present disclosure. In this example, interface 800P provides an example inactive conversations settings. For example, inactive conversations settings may cause the chatbot to send auto-replies to snoozed conversations. As another example, inactive conversations settings may cause the chatbot to automate snoozing and set conversation pacing with new actions. As yet another example, inactive conversations settings may cause the chatbot to automatically reroute conversations that receive no response to a human, such as a CSA.

FIG. 8Q provides an example chat interface 800Q between a chatbot and a user showing a request for feedback, in accordance with embodiments of the present disclosure. In this example, chat interface 800Q provides a rating scale for a customer to rate the chatbot. FIG. 8R provides an example interface 800R of output from a chatbot analysis tool of a chatbot tool of a customer support application, in accordance with embodiments of the present disclosure. In this example, interface 800R utilizes the ratings from customers to provide overall CSAT and/or sentiment analysis of the chatbot. FIG. 8S provides another example interface 800S of output from a chatbot analysis tool of a chatbot tool of a customer support application, in accordance with embodiments of the present disclosure. In this example, interface 800S utilizes the ratings from customers to provide CSAT and/or sentiment analysis of the chatbot over a period of time.

FIG. 8T provides another example interface 800T of a chatbot analysis tool of a chatbot tool of a customer support application, in accordance with embodiments of the present disclosure. In this example, interface 800T enables a user to generate reports providing various metrics of the chatbot. For example, chatbot analysis tool of example interface 800T provides an interface for generating reports analyzing chatbot performance, such as through chatbot conversation monitoring, chatbot CSAT, usage metrics, usage limits notifications, performance/ROI metrics, custom reports, and/or content-level metrics

FIGS. 8U-Y provide example interfaces 800U-800Y of output from a chatbot analysis tool of a chatbot tool of a customer support application, in accordance with embodiments of the present disclosure. As can be understood, interfaces 800U-800Y provide output of various metrics regarding the ROI of the chatbot.

### Example Process Flows

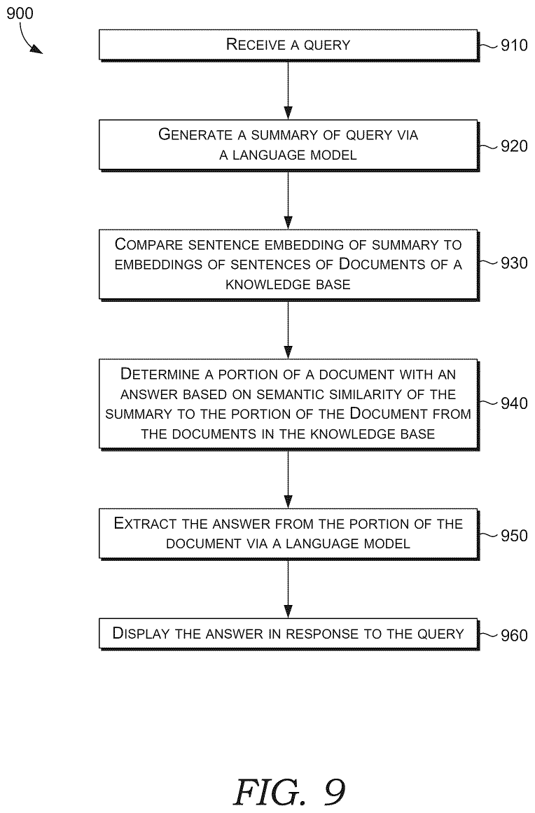

With reference now to FIGS. 9-14, flow diagrams are provided illustrating various methods. Each block of the methods 900-1400 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 9 is a flow diagram showing a method 900 for implementing a specialized chatbot platform that uses language models to determine answers from knowledge bases, in accordance with embodiments of the present disclosure, in accordance with embodiments of the present disclosure. Initially, at block 910, a query is received. At block 920, a summary of the query is generated via language model. At block 930, a sentence embedding of the summary is compared with sentence embeddings of sentences of documents of a knowledge base. At block 940, a portion of a document with an answer is determined based on semantic similarity of the summary to the portion of the document from the documents in the knowledge base. At block 950, the answer is extracted from the portion of the document via the language model. At block 960, the answer is displayed in response to the query.

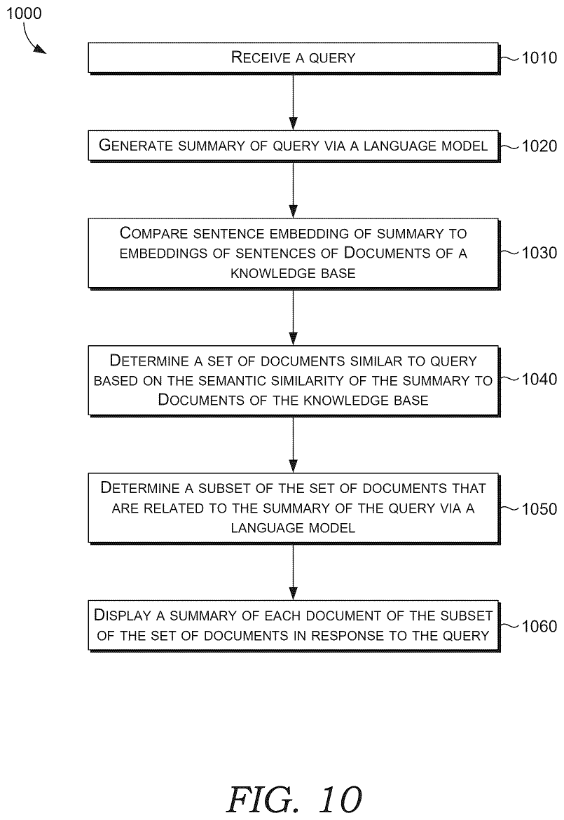

FIG. 10 is a flow diagram showing a method 1000 for implementing a chatbot using a language model to determine a subset of documents from a knowledge base in response to a user's query, in accordance with embodiments of the present disclosure. Initially, at block 1010, a query is received. At block 1020, a summary of the query is generated via language model. At block 1030, a sentence embedding of the summary is compared with sentence embeddings of sentences of documents of a knowledge base. At block 1040, a set of documents similar to the query is determined based on the semantic similarity of the summary to documents of the knowledge base. At block 1050, a subset of the set of documents that are related to the summary of the query are determined by the language model. At block 1060, a summary of each document of the subset of documents is displayed in response to the query.

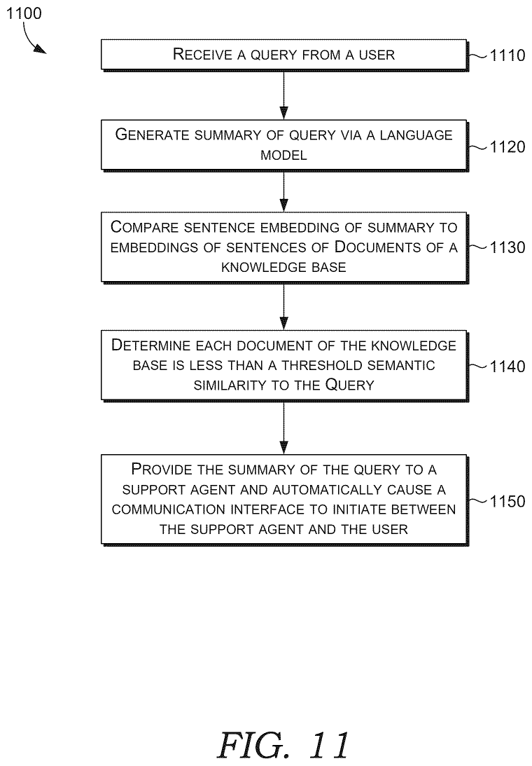

FIG. 11 is a flow diagram showing a method 1100 for implementing a specialized chatbot platform that uses language models to determine answers from knowledge bases and handing off the conversation to a human, in accordance with embodiments of the present disclosure. Initially, at block 1110, a query is received. At block 1120, a summary of the query is generated via language model. At block 1130, a sentence embedding of the summary is compared with sentence embeddings of sentences of documents of a knowledge base. At block 1140, each document of the knowledge base is determined to be less than a threshold semantic similarity to the query. At block 1150, a summary of the query is provided to a support agent and a communication interface is automatically initiated between the support agent and the user.

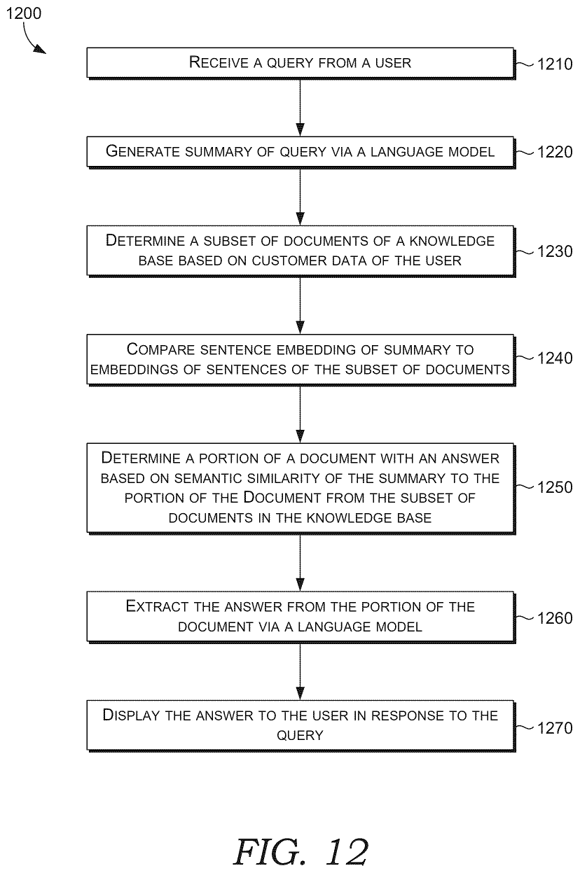

FIG. 12 is a flow diagram showing a method 1200 for implementing a specialized chatbot platform that uses language models to determine answers from knowledge bases based on customer data of the user, in accordance with embodiments of the present disclosure. Initially, at block 1210, a query is received from a user. At block 1220, a summary of the query is generated via language model. At block 1230, a subset of documents of a knowledge base is determined based on customer data of the user. At block 1240, a sentence embedding of the summary is compared with sentence embeddings of sentences of the subset of documents of the knowledge base. At block 1250, a portion of a document with an answer is determined based on semantic similarity of the summary to the portion of the document from the subset of documents in the knowledge base. At block 1260, the answer is extracted from the portion of the document via the language model. At block 1270, the answer is displayed to the user in response to the query.

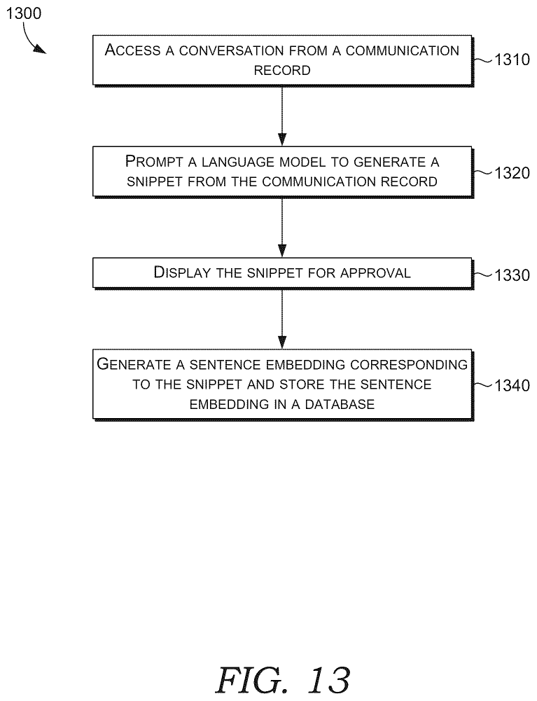

FIG. 13 is a flow diagram showing a method 1300 for using a language model to extract conversational snippets, in accordance with embodiments of the present disclosure. Initially, at block 1310, a conversation is accessed from a communication record. At block 1320, a language model is prompted to generate a snippet from the communication record. At block 1330, the snippet is displayed for approval. At block 1340, a sentence embedding corresponding to the snipped is generated and stored in a database.

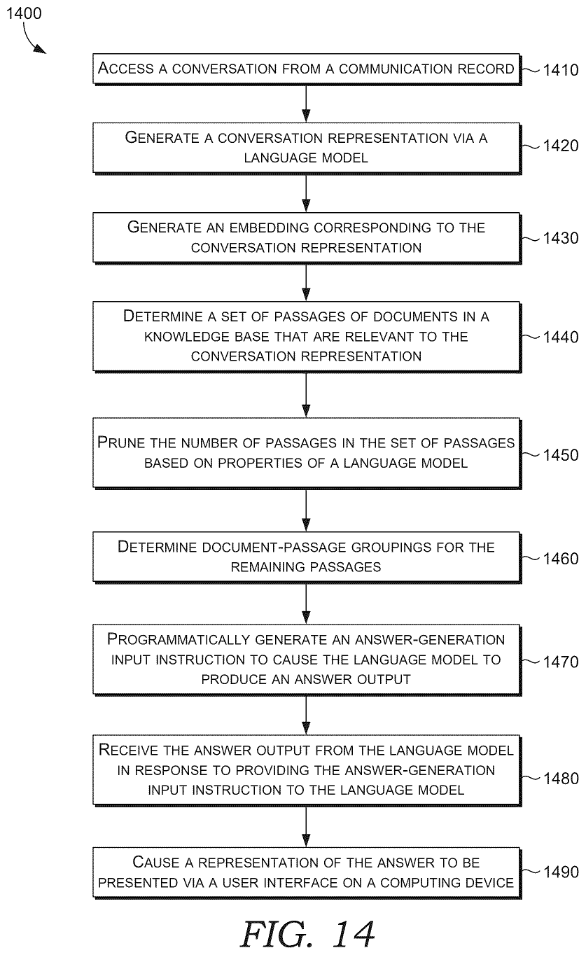

FIG. 14 is a flow diagram showing a method 1400 for implementing an answer assistance computing system by programmatically generating answers for a user, such as a CSA, that are responsive to aspects of a conversation, such as a conversation between the CSA and a customer, and to provide the generated answer to the user. At block 1410 a conversation from a communication record is accessed. Embodiments of block 1410 access a conversation record or conversation history. The conversation history comprises a data file that is a text record of a conversation, which may be occurring in near-real time. For example, as a CSA is communicating with a customer, the chat log or transcript of the discussion is created and comprises a conversation history record. The conversation history may be determined from a chat log or chat history of a chat session or by using automatic speech recognition, such as a speech-to-text software utility on audio information of the communication, such as from a customer who is speaking with a CSA over a phone call.

At block 1420, generate a conversation representation via a language model. Embodiments of block 1420 generate, from the conversation record, a conversation representation. The conversation representation represents a distilled summary and context of the conversation, or a set of one or more extracted queries that encapsulate the customer's issues or questions. In some implementations, the conversation representation is generated using a language model, such as a large language model (LLM) for instance, GPT 3.5 Turbo, or using a small language model. The language model is provided as an input, a portion of the conversation history record and an issue summarization prompt. Issue summarization prompts are designed to instruct a language model in summarizing complex topics, discussions, or content into a concise and coherent summary. In one example, an issue summarization prompt is based on the following instruction:

“““
Chat history:
{chat_history}
---
You have a chat history with a customer of {app_name}.
Your goal is to summarize relevant information about customer's LAST question or issue in
one full, meaningful and clear standalone sentence.
You have to rewrite it on the customer behalf, jump directly to the question or issue. Be
formal.
Keep it short, don't include many details. Only stick to the information in the chat history -
this is very important to my career.
”””

In one embodiment, the portion of the conversation history includes recent conversation parts, such as the back-and-forth messages exchanged in the conversation; for instance, some implementations determine and use the five most recent conversation parts to determine the conversation representation.

At block 1430, generate an embedding corresponding to the conversation representation. Embodiments of block 1430 generate an embedding corresponding to the conversation representation thereby forming a representation embedding. In some embodiments, the embedding is generated or computed using Sentence Bidirectional Encoder Representations from Transformers (SBERT) or another suitable transformer.

At block 1440, determine a set of passages of documents in a knowledge base that are relevant to the conversation representation. Embodiments of block 1440 comprise accessing a knowledge base to identify information relevant to the conversation representation for use to generate an answer responsive to the conversation representation. In various implementations, the knowledge base comprises a repository of documents each containing one or more passages that may be relevant to queries of the conversation representation. For example, documents in the knowledge base can include, without limitation, help center information, such as technical documentation, user manuals, FAQs, policy documents, product guides; internal documentation; conversation histories or portions thereof, which may include portions of past conversations or summaries of conversations between a user, such as a CSA, and a customer regarding an issue and its resolution; other information specifically curated for the knowledge base, and other information sources potentially relevant for addressing customer queries. In some instances, a document may comprise a plurality of related files or electronic documents, as well as multimedia content.

Embodiments of block 1440 comprise accessing documents of the knowledge base corresponding to conversation excerpts. In some implementations, in order to generate each conversation excerpt, the language model is provided as an input, a past conversation history, such as a past conversation record between a CSA and a customer, an issue identification prompt, and a source identification prompt. Issue identification prompts are designed to instruct a language model to identify questions and/or issues from a conversation history record, such as unique questions and/or issues presented by the customer to the CSA and a corresponding response from the CSA to the customer. Source identification prompts are designed to instruct a language model to identify the portion of the conversation history, such as the message from the customer that includes the question and the subsequent message from the CSA providing a response to the customer's question. In this regard, for each question and/or issue identified from each conversation history record by the language model, the identified portions of the conversation histories can be stored as a corresponding conversation excerpt. For example, the conversation excerpt can include the message from the customer that includes the question and the subsequent message from the CSA providing a response to the customer's question, so that past messages can be used to answer future questions from customers.

As described herein, documents in the knowledge base are segmented into discrete units known as passages. For each document in the knowledge base, an embedding is computed for the passages of the document thereby allowing for the computation of semantic similarity between embeddings. Accordingly, passage embeddings are compared to representation embeddings to determine a set of passages that are semantically relevant to a conversation representation.

In some embodiments of block 1440, a query is performed on the knowledge base to determine a set of passages that are relevant to a conversation history record by determining a set of passages in the knowledge base that have corresponding passage embedding that are similar to the representation embedding corresponding to the conversation representation. In particular, the set of the passages that are relevant to the conversation representation may be determined by computing a semantic similarity of the representation embedding to an embedding corresponding to each of the passages of the documents in the knowledge base. Those passages that are sufficiently relevant, such as satisfying a threshold of similarity, are included in the set of passages.

In some implementations, all of the passages are ranked for similarity and only the top certain number of passages, corresponding to the most relevant passages, are included in the set of passages relevant to the conversation representation. For instance, the set of passages may comprise forty-five passages that are ranked in order of similarity, representing relevance, to the conversation the conversation representation. In some implementations, the similarity comparison is performed using the model msmarco-distilbert-base-tas-b if the language corresponding to the embeddings is English and Multilingual-e5-base for other languages.

In some embodiments using a similarity threshold, the similarity threshold is 0.8. In other embodiments using a similarity threshold, pre-determined or configured according to the number or potentially relevant passages (e.g., the threshold may be set higher if there are more passages, so that only the most relevant passages are included in the set, but the threshold may be set lower if there are fewer potentially relevant passages, so that more are included for consideration in generating the answer output response.

At block 1450, prune the number of passages in the set of passages based on properties of a language model. Some embodiments of method 1400 include decreasing the number of passages in the set of passages that will be used by the language model for generating an answer output. Accordingly, embodiments of block 1450 include programmatically pruning the number of passages in the set according to the limitations of the language model or a computation speed to provide a desired user experience. For instance in one embodiment, a programmatic pruning process may be performed automatically to determine the first number of N source documents that contain the passages with the highest relevance to the conversation representation. The value of N may be set to 15, for instance, which would comprise identifying the top 15 source documents with the corresponding high-ranking passages in regards to relevance to the conversation representation. However, N could also be 10, 20, or another number, depending on the implementation or the characteristics of the language model in use. In some implementations, a document relevance is determined for each of the documents and used for determining the number of N documents most relevant to the conversation representation. For example, for each document having passages in the set of passages relevant to the conversation representation, the relevance of the document to the conversation representation is determined based on the relevance of each passage within the document that is in the set of passages.

At block 1460, determine document-passage groupings for the remaining passages. Embodiments of block 1460 use the set of relevant passages, or the passages corresponding to the number of N documents, to generate document-passage groupings. A document-passage grouping indicates a document and each passage of the document that is in the set of relevant passages. For example the indication may comprise a document ID and a passage ID or index number from an index of passages for the document. In some implementations, the indication of a particular passage is based on the document ID and an index or number corresponding to each passage in the document. Accordingly, in instances having a number of N documents that have the passages with the highest relevance to the conversation representation, there will be N document-passage groupings, comprising a grouping of the relevant passages for each document.

In some embodiments of block 1460, each relevant document-passage grouping is determined from a predetermined document-passage grouping. In particular, in some implementations, a pre-determined document-passage grouping is determined for each document in the knowledge base and comprises an indication of the document and indications of each passage occurring within the document. The indications of passages in the predetermined document-passage grouping include all passages that are in the document, including passages that are not necessarily relevant to the conversation representation. Accordingly, in some embodiments, a document-passage grouping is determined by removing from the predetermined document-passage grouping, the indications of those passages that are not in the set of passages relevant to the conversation representation.

At block 1470, programmatically generate an answer-generation input instruction to cause the language model to produce an answer output. Embodiments of block 1470 programmatically generate an answer-generation input instruction for inputting to a language model, such as an LLM, to cause the language model to produce an answer output. In various embodiments, the answer-generation input instruction is generated using one or more of: (a) the conversation representation, (b) the relevant document-passage groupings, or a portion of the relevant document-passage groupings), and (c) an answer-format instruction. For example, the answer-generation input instruction instructs the language model to use the document-passage groupings (or a portion of the document-passage groupings) to generate an answer output that is responsive to the conversation representation (such as a query in the conversation representation) and based on the answer-format instruction. In some embodiments, the language model comprises a GPT-4 LLM, and the answer output is generated using Retrieval-Augmented Generation (RAG). In some embodiments, answer-generation input instruction logic is used to generate the answer-generation input instruction. The answer-generation input instruction logic can include computer instructions, programming routines, rules, or templates used for generating the answer-generation input instruction.

In some embodiments, the number of relevant document-passage groupings included in the answer-generation input instruction is based on a target token length corresponding to the language model. Thus, the number of document-passage groupings may be limited so that only the document-passage groupings having the most relevant passages are included based on the target token length. Accordingly, document-passage groupings having less relevant passages may be excluded from the answer-generation input instruction, if the target token length is small. In some implementations, the target token length is determined using an LLM tokenizer configured for the language model.

Embodiments of block 1470 include programmatically determining an answer-format instruction, which is included in the answer-generation prompt instruction, to direct the language model to include specific information or format aspects of the answer output according to the format instruction. Some embodiments of answer-format instructions include instructions to generate and integrate citations within the answer output. In particular, some implementations of the answer-format instruction instruct the language model to include, in the answer output, a corresponding citation for each portion of the answer output that is generated using a particular passage, from the document-passage groupings. A citation corresponds to at least a portion of the answer output, such as a sentence or a paragraph in the answer output, and indicates the passage used to generate the corresponding portion of the answer output. A citation also may indicate the document that includes the indicated passage. For example, the citations may occur within the answer output following each portion of the answer output corresponding to the citation, or the citations may generated as footnotes or endnotes of the answer output. In one example implementation, the citations are provided in the answer output in the format: [@doc_id=120-1-0], where “120” is a code for the document type, “1” indicates an ID of the source, and “0” indicates the particular passage within that source.

In some implementations, the answer-format instruction specifies that each citation include a direct link to the location of its indicated passage in a document. That is, in these implementations, the citation does not merely link to the document that has the indicated passage, but the citation links directly to the passage within the document. For example, the direct link may comprise an anchor link, hyperlink, a URL, pointer, or similar link.

Further, some embodiments of the answer-format instruction generated in block 1470 include an instruction to direct the language model to include, in a citation, source information regarding the cited document. Source information includes information about the document, for example and without limitation, information regarding the type of document (e.g., a conversation record or snippet of a conversation, help center documentation, internal documentation, log, etc.); a creation date of the document; a last modification date of the document indicating how recently the document was updated; whether the document is internal to the user (for example, the CSA) or accessible to a customer, or publicly accessible; an indication of the number of times the document has been previously cited in past answer outputs, which may be used to determine that a particular document is used often for generating answers; or a CSA user feedback rating based on prior occurrences of the document's passages in past answer outputs. In this way, the citations serve to indicate the information about source of the information used to generate the answer output, thereby enhancing the transparency and trustworthiness of the generated answer.

Further, some embodiments of the answer-format instruction generated in block 1470 include an instruction directing the language model to include, in the answer output, an indication of a likelihood that the answer output is contained entirely within a passage or multiple passages of a document. Similarly, in some embodiments, the answer-format instruction instructs the language model to determine a likelihood that the answer output is contained entirely within a passage of a document (or alternatively to determine a likelihood that the answer output is contained entirely within a document), and based on the likelihood satisfying a confidence threshold, the language model is instructed to include, in the answer output, an indication that the answer output answers the conversation representation. For example, when the CSA user is presented with the answer output, the word “Answer” may be also presented in or with the citation, or presented before or after the answer output, thereby indicating that the provided answer output is contained entirely within the cited passage or the cited document. For example, in response to this instruction, the answer output may include:

“““
<sources
_answer_q_likelihood> 10</sources_answer_q_likelihood>\n<sources>[@doc_id=120-
2-1], [@doc_id=120-1-0]</sources>\n<answer>The color of the sky on Earth is b
lue[@doc_id=120-1-0], while on Venus, the sky is red[@doc_id=120-2-1].</answe
r>\n<missed></missed>
”””

Some embodiments of the answer-format instruction generated in block 1470 include an example of an answer output, an answer output template, a portion of an example answer output, or a portion of an answer output template.

Example aspects of an answer-generation input instruction generated at block 1470 include the following:

```
  “““
================== System Message ================================
You are a customer support answer service for {app_name}, helping a customer support agent.
Your job is to answer questions as accurately and efficiently as possible. You're not talking to a
customer.
{query}
================== AI Message ================================
Here is a list of passages from internal knowledge base in descending order of relevance to your
query:
{internal_passages_text}
Here is a list of passages from public knowledge base in descending order of relevance to your
query:
{passages_text}
================== Human Message ================================
Lets refer to those passages as “The information I've found about your query”
Given that information I want you to reasonably reinterpret my most recent query
and determine if you can answer my query by summarising the relevant information into a
helpful response.
First, using a score between 1 to 10 write
<sources_answer_q_likelihood>score</sources_answer_q_likelihood> to
indicate whether the answer to the query is entirely contained within the source information(s),
10 is very likely, 1 is very unlikely.
If you scored 6.3 or less between the tags then you should just say “<answer></answer>” and
stop,
Otherwise:
Pick the passages which are most relevant to my query and list them like so :
<sources>[@doc_id=123-345-6], [@doc_id=124-456-7]</sources>
Then provide an answer in English between <answer></answer> tags following these rules:
1. Ignore all information in passages you didn't pick.
2. Only use information from the sources you picked that is materially relevant to my query to
construct your answer.
3. Provide as complete and helpful a solution from the relevant information as possible,
assuming I cannot read or reference the information to solve my problem.
4. Do not directly reference the passages in your answer, Instead, at the end of each sentence or
paragraph in your answer, you should always cite the source you used to generate it, in
markdown like this: [@doc_id=123-567-0]. Example:
<answer>This is the first sentence of an answer.[@doc_id=123-345-6] And this is the second
sentence, from a different source.[@doc_id=124-456-7]</answer>
5. Make sure to include any caveats mentioned in the information if relevant to my query.
6. Where possible use the exact wording from the sources, and follow their tone and style.
7. If you need to make an inference from the sources to answer my query, you should qualify and
explain the inference in your answer.
8. Format your answer for optimum scanability and readability (restate the problem if helpful,
process steps as lists, and use paragraph breaks where needed).
9. If there are relevant links in the passages, you should include them in your response.
Then:
Go back over your answer and list any passages you used to generate text for your answer that
you may have missed listing before like so:
<missed>[@doc_id=123-345-1], [@doc_id=124-456-4]</missed>
  ”””
```

At block 1480, receive the answer output from the language model in response to providing the answer-generation input instruction to the language model. In particular, the answer-generation input instruction is be provided as an input prompt to the language model, which generates a response and provides the response as the answer output. The answer output is received from the language model and processed (in block 1490) to determine a representation of the answer (referred to as an answer representation) that can be provided, via a user interface (UI), to the user.

At block 1490, cause a representation of the answer to be presented via a user interface on a computing device. Embodiments of block 1490 process the answer output to determine an answer representation and cause the answer representation to be presented via a user interface on a computing device, such as computing device 1600, described in FIG. 6. For example, the answer output may be presented via a graphical user interface to a CSA. In some embodiments, the answer output includes answer content for presentation and instructions for presentation or formatting of the answer content that are processed to determine the answer representation. Accordingly, the answer representation represents the aspect of the answer output that is presented according to any formatting or instructions included in the answer output. For example, instructions in the answer output, such as instructions related to the citations, are processed to enable the UI to render links to the exact passages of a source that was used to generate a portion of an answer representation. In some implementations, the answer output includes visualization instructions for presenting the answer representation via a UI.

Some implementations of the UI comprise a first UI element for presenting aspects of the conversation history, which may comprise the transcript of an ongoing conversation, and a second UI element for presenting the answer representation. In some instances, the second UI element is positioned proximate the first UI element so that a user (for example a CSA) can view and interface with the conversation and also view the answer representation including citations, thereby enabling the user to access the passages that are indicated by the citations. In some embodiments, passage-level citations are presented in the UI as links which highlight the relevant passage in the original source, thereby enhancing the ability of the user to quickly fact check the answers given by Copilot.

Some implementations of method 1400 operate continuously or as needed during a conversation. Accordingly, the process of method 1499 for generating and providing an answer representation to a user based on a conversation history record is continuously updated as the conversation continues. In this way, the user, such as a CSA, may be continuously presented with an answer representation that is relevant to the current conversation with a customer. For instance, as the conversation evolves and new, more recent conversation parts are added to the conversation history, those more recent conversation parts are used to ultimately determine a new answer representation.

### OTHER EMBODIMENTS

In some embodiments, a computer-implemented method is provided. The method comprises accessing a conversation history record, generating a conversation representation of the conversation history record, and generating an embedding corresponding to the conversation representation thereby forming a representation embedding. The method further comprises, for a plurality of passages within one or more documents in a knowledge base, determining a set of passages relevant to the conversation representation, each passage having a relevance to the conversation representation based on a computed similarity of the representation embedding to an embedding corresponding to the passage. The method further comprises determining a number of N documents in the knowledge base having passages in the set of passages that are most relevant to the conversation representation, the of number N documents comprising at least one document. The method further comprises, for each document of the N documents, determining a document-passage grouping comprising an indication of the document and an indication of each passage within the document that is in the set of passages, thereby forming N relevant document-passage groupings. The method further comprises programmatically generating an answer-generation input instruction for a language model to cause the language model to produce an answer output, the answer-generation input instruction generated based at least on the conversation representation, at least a portion of the n relevant document-passage groupings, and an answer-format instruction that instructs the language model to include, in the answer output, at least a first citation corresponding to at least a first portion of the answer output that is generated using a first passage from the document-passage groupings, the first citation indicating the first passage and a first document that includes the first passage. The method further comprises receiving the answer output from the language model in response to providing the answer-generation input instruction to the language model. The method further comprises causing a representation of the answer output to be presented, as an answer representation, via a user interface (UI) of a computing device.

In some embodiments, a computing system is provided, employing any components of the computerized (or computer, computing, or cloud) system of any of the embodiments described herein. The computing system comprises at least one computer processor, and computer memory having computer-readable instructions embodied thereon, that, when executed by the at least one computer processor, perform operations. The operations comprise access a conversation history record, generate a conversation representation of the conversation history record, and generate an embedding corresponding to the conversation representation thereby forming a representation embedding. The operations further comprise, for a plurality of passages within one or more documents a knowledge base, determine a set of passages relevant to the conversation representation, each passage having a relevance to the conversation representation based on a computed similarity of the representation embedding to an embedding corresponding to the passage. The operations further comprise determine a number of N documents in the knowledge base having passages in the set of passages that are most relevant to the conversation representation, the of number N documents comprising at least one document. The operations further comprise, for each document of the N documents, determine a document-passage grouping comprising an indication of the document and an indication of each passage within the document that is in the set of passages, thereby forming N relevant document-passage groupings. The operations further comprise, programmatically generate an answer-generation input instruction for a language model to cause the language model to produce an answer output, the answer-generation input instruction generated based at least on the conversation representation, at least a portion of the n relevant document-passage groupings, and an answer-format instruction that instructs the language model to include, in the answer output, at least a first citation corresponding to at least a first portion of the answer output that is generated using a first passage from the document-passage groupings, the first citation indicating the first passage and a first document that includes the first passage. The operations further comprise receive the answer output from the language model in response to providing the answer-generation input instruction to the language model. The operations further comprise cause a representation of the answer output to be presented, as an answer representation, via a user interface (UI) of a computing device.

In any combination of the above embodiments of the method or system, the conversation representation of the conversation history record is determined using a secondary language model by providing an input prompt that comprises an issue summarization prompt and a portion of the conversation history record.

In any combination of the above embodiments of the method or system, the language model comprises a large language model (LLM) and the secondary language model comprises an LLM or a small language model.

In any combination of the above embodiments of the method or system, the conversation history record includes at least three and less than ten conversation parts.

In any combination of the above embodiments of the method or system, the conversation history record comprises one of a transcript of at least a portion of a spoken conversation between a customer service agent and a customer or a message log of at least a portion of a messaging conversation between the customer service agent and a customer.

In any combination of the above embodiments the set of passages relevant to the conversation representation includes passages having corresponding embeddings within a threshold similarity to the representation embedding.

In any combination of the above embodiments of the method or system, the computed similarity comprises a semantic similarity; and wherein the relevance of each passage, within the one or more documents in the knowledge base, to conversation representation represents the computed semantic similarity of the embedding corresponding to the passage and the representation embedding.

In any combination of the above embodiments of the method or system, the computed similarity is performed using an msmarco-distilbert-base-tas-b model if the conversation history record is in English, or a Multilingual-e5-base model if the conversation history record is in a language other than English.

In any combination of the above embodiments of the method or system, the method or the operations performed further comprise accessing a second conversation history record; programmatically generate a conversation-excerpt-generation input instruction for the language model to cause the language model to produce a conversation-excerpt output, the conversation-excerpt-generation input instruction generated based at least on the second conversation history record, an issue identification prompt, and a source identification prompt; receiving the conversation-excerpt output from the language model in response to providing the conversation-excerpt-generation input instruction to the language model; and storing the conversation-excerpt output in the knowledge base as a conversation excerpt document, wherein the one or more documents incudes the conversation excerpt document, and the set of passages relevant to the conversation representation is determined using the conversation excerpt document.

In any combination of the above embodiments of the method or system, the issue identification prompt is configured to instruct the language model to identify a question or an issue from a portion of the second conversation history record and the source identification prompt is configured to instruct the language model to identify the portion of the second conversation history record that relates to the question or the issue.

In any combination of the above embodiments of the method or system, the conversation-excerpt-generation input instruction further comprises a conversation-excerpt output format instruction that instructs the language model to generate the conversation-excerpt output to include the portion of the second conversation history record that relates to the question or the issue, an indication of the question or the issue, and a representation of a response provided by a customer service agent in regard to the question or the issue.

In any combination of the above embodiments of the method or system, the representation embedding and each embedding of the plurality of passages is determined using Sentence-Bidirectional Encoder Representations from Transformers (SBERT).

In any combination of the above embodiments of the method or system, the set of passages relevant to the conversation representation comprises between twenty and fifty passages that are ranked in order of relevance to the conversation representation.

In any combination of the above embodiments of the method or system, the number of N documents is fifteen.

In any combination of the above embodiments of the method or system, the number of N documents is determined based on properties of the language model used to generate the answer output.

In any combination of the above embodiments of the method or system, the method or the operations performed further comprise, for each document having passages in the set of passages relevant to the conversation representation, determining a document relevance representing the relevance of the document to the conversation representation, the document relevance determined based on the relevance of each passage within the document that is in the set of passages.

In any combination of the above embodiments of the method or system, the number of N documents comprises the number of N documents having the highest document relevance.

In any combination of the above embodiments of the method or system, each relevant document-passage grouping is determined from a predetermined document-passage grouping, the pre-determined document-passage grouping comprising an indication of the document and indications of each passage occurring within the document, the relevant document-passage grouping determined by removing from the predetermined passage document grouping, indications of passages that are not in the set of passages relevant to the conversation representation.

In any combination of the above embodiments of the method or system, the answer-generation input instruction further includes an instruction directing the language model to use the at least a portion of the N document-passage groupings to generate the answer output that is responsive to the conversation representation and based on the answer-format instruction.

In any combination of the above embodiments of the method or system, the answer-format instruction further comprises at least one of an example answer output format, an answer output template, a portion of an example answer output format, or a portion of an answer output template.

In any combination of the above embodiments of the method or system, the at least the portion of the N document-passage groupings is determined based on a target token length.

In any combination of the above embodiments of the method or system, the target token length is determined using an LLM tokenizer configured for the language model.

In any combination of the above embodiments of the method or system, the first citation includes a direct link to the location of the first passage within the first document comprising a hyperlink, anchor link, URL, or pointer.

In any combination of the above embodiments of the method or system, the answer-format instruction instructs the language model to include, in the answer output, a corresponding citation for each portion of the answer output that is generated using a passage, from the document-passage groupings, each corresponding citation indicating the passage used to generate the corresponding portion of the answer output and indicating the document the includes the passage used to generate the corresponding portion of the answer output.

In any combination of the above embodiments of the method or system, the answer-format instruction instructs the language model to include, in the answer output and associated with the first citation, source information regarding the first document, and wherein the source information indicates a type of document, creation date of the document, a last modification date of the document, whether the document is internal or accessible to a customer, an indication of the number of times the document has been previously cited in past answer outputs, or a user-feedback rating based on prior occurrences of the document's passages in past answer outputs.

In any combination of the above embodiments of the method or system, the answer-format instruction instructs the language model to include, in the answer output, an indication of a likelihood that the answer output is contained entirely within the first passage or the first document.

In any combination of the above embodiments of the method or system, the answer-format instruction instructs the language model to: determine a likelihood that the answer output is contained entirely within the first passage or the first document, and based on the likelihood satisfying a confidence threshold, include, in the answer output, an indication that the answer output answers the conversation representation.

In any combination of the above embodiments of the method or system, the answer output further includes visualization instructions for presenting the answer representation.

In any combination of the above embodiments of the method or system, the UI includes a first UI element presenting aspects of the conversation history record and a second UI element presenting the answer representation, the second UI element is positioned proximate the first UI element enabling presentation of the answer representation concurrent with presentation of aspects of the conversation history record.

In any combination of the above embodiments of the method or system, the conversation history record is updated during an occurrence of a conversation, thereby creating an updated conversation history record.

In any combination of the above embodiments of the method or system, the computer implemented method of claim 1 is repeated using the updated conversation history record as the conversation history record to receive an updated answer output as the answer output from the language model, and the method or the operations performed further comprise causing presentation, via the user interface, of a representation of the updated answer output in place of the answer representation.

In some embodiments, one or more computer storage are provided, the media having computer-executable instructions embodied thereon that, when executed by at least one computer processor, cause computing operations to be performed. The operations comprise access a first and a second conversation history record, generate a conversation representation of the first conversation history record, and generate a first embedding corresponding to the conversation representation thereby forming a representation embedding. The operations further comprise programmatically generate a conversation-excerpt-generation input instruction for a language model to cause the language model to produce a conversation-excerpt output, the conversation-excerpt-generation input instruction generated based at least on the second conversation history record, an issue identification prompt, and a source identification prompt. The operations further comprise receiving the conversation-excerpt output from the language model in response to providing the conversation-excerpt-generation input instruction to the language model. The operations further comprise generate a second embedding corresponding to the conversation-excerpt output thereby forming a conversation-excerpt embedding. The operations further comprise determining that the conversation-excerpt output is relevant to the conversation representation based on a computed similarity of the representation embedding to the conversation-excerpt embedding. The operations further comprise programmatically generate an answer-generation input instruction for the language model to cause the language model to produce an answer output, the answer-generation input instruction generated based at least on the conversation representation, conversation-excerpt output, and an answer-format instruction that instructs the language model to include, in the answer output, at least a citation corresponding to at least a first portion of the answer output that is generated using conversation-excerpt output, the citation indicating at least a portion of the second conversation history record. The operations further comprise receive the answer output from the language model in response to providing the answer-generation input instruction to the language model. The operations further comprise cause a representation of the answer output to be presented, as an answer representation, via a user interface (UI) of a computing device.

### Example Operating Environments

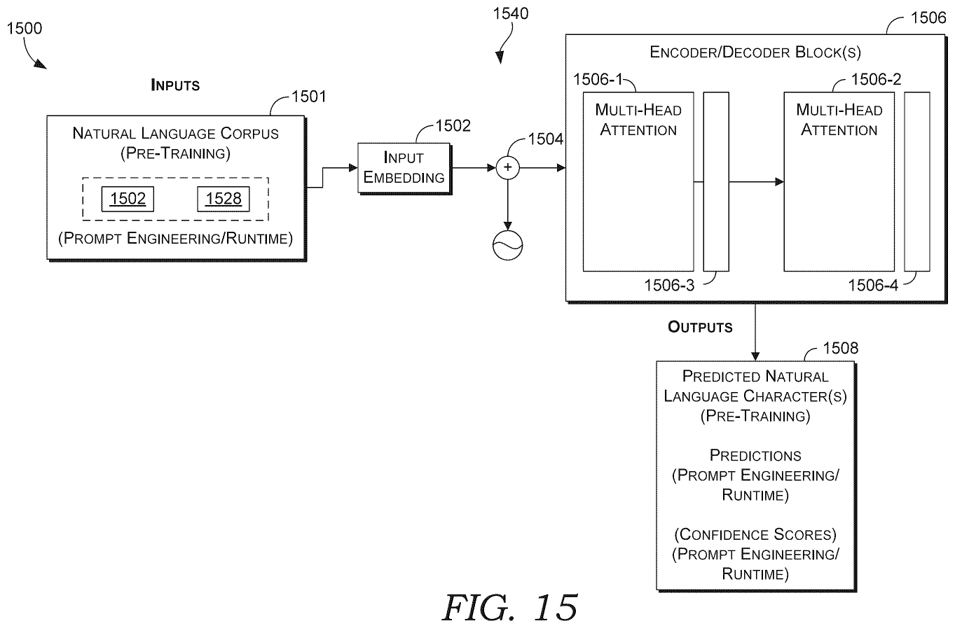

Having described an overview of aspects of the technology described herein and various implementations, several example computing environments are provided, in FIGS. 15 and 16, in which aspects of the technology described herein may be implemented. Turning to FIG. 15 is a block diagram of a language model 1500 (for example, a BERT or SBERT model or Generative Pre-trained Transformer [GPT]-4 model) that uses particular inputs to make particular predictions (for example, answers to questions), according to some embodiments. In one embodiment, the language model 1500 corresponds to the machine learning model 110 of FIG. 1, described herein. For example, model 1500 represents or includes the functionality as described with respect to the machine learning model 110 or language models described in the methods 900-1400 of FIGS. 9-14, respectively. In various embodiments, the language model 1500 includes one or more encoders and/or decoder blocks 1506 (or any transformer or portion thereof).

First, a natural language corpus (for example, various WIKIPEDIA English words or BooksCorpus) of the inputs 1501 are converted into tokens and then feature vectors and embedded into an input embedding 1502 to derive meaning of individual natural language words (for example, English semantics) during pre-training. In some embodiments, to understand English language, corpus documents, such as textbooks, periodicals, blogs, social media feeds, and the like are ingested by the language model 1500.

In some embodiments, each word or character in the input(s) 1501 is mapped into the input embedding 1502 in parallel or at the same time, unlike existing long short-term memory (LSTM) models, for example. The input embedding 1502 maps a word to a feature vector representing the word. But the same word (for example, “apple”) in different sentences may have different meanings (for example, phone versus fruit). This is why a positional encoder 1504 can be implemented. A positional encoder 1504 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / {10000}^{2 i / {d}_{model}} ) \qquad ( 1 )$$

$${PE}_{( pos , 2 i + 1 )} = cos ( pos / 1000 {0}^{2 i / {d}_{model}} ) . \qquad ( 2 )$$

After passing the input(s) 601 through the input embedding 1502 and applying the positional encoder 1504, the output is a word embedding feature vector, which encodes positional information or context based on the positional encoder 1504. These word embedding feature vectors are then passed to the encoder and/or decoder block(s) 1506, where it goes through a multi-head attention layer 1506-1 and a feedforward layer 1506-2. The multi-head attention layer 1506-1 is generally responsible for focusing or processing certain parts of the feature vectors representing specific portions of the input(s) 1501 by generating attention vectors. For example, in Question-Answering systems, the multi-head attention layer 1506-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q \cdot {K}^{T}}{\sqrt{Dimension of vector Q , K or V}} ) \cdot V . \qquad ( 3 )$$

For multi-headed attention, there are multiple weight matrices W^{q}, W^{k} and W^{v} so there are multiple attention vectors Z for every word. However, a neural network may expect one attention vector per word. Accordingly, another weighted matrix, W^{z}, is used to make sure the output is still an attention vector per word. In some embodiments, after the layers 1506-1 and 1506-2, there is some form of normalization (for example, batch normalization and/or layer normalization) performed to smoothen out the loss surface making it easier to optimize while using larger learning rates.

Layers 1506-3 and 1506-4 represent residual connection and/or normalization layers where normalization re-centers and rescales or normalizes the data across the feature dimensions. The feedforward layer 1506-2 is a feed-forward neural network that is applied to every one of the attention vectors outputted by the multi-head attention layer 1506-1. The feedforward layer 1506-2 transforms the attention vectors into a form that can be processed by the next encoder block or make a prediction at 1508. For example, given that a document includes first natural language sequence “the due date is . . . ,” the encoder/decoder block(s) 1506 predicts that the next natural language sequence will be a specific date or particular words based on past documents that include language identical or similar to the first natural language sequence.

In some embodiments, the encoder/decoder block(s) 1506 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 1506 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 1501 may be various historical documents, such as text books, journals, and periodicals, in order to output the predicted natural language characters in 1508 (not make the predictions at runtime or prompt engineering at this point). The example encoder/decoder block(s) 1506 takes in a sentence, paragraph, or sequence (for example, included in the input[s] 1501), with random words being replaced with masks. The goal is to output the value or meaning of the masked tokens. For example, if a line reads, “please [MASK] this document promptly,” the prediction for the “mask” value is “send.” This helps the encoder/decoder block(s) 1506 understand the bidirectional context in a sentence, paragraph, or line at a document. In the case of NSP, the encoder/decoder block(s) 606 takes, as input, two or more elements, such as sentences, lines, or paragraphs, and determines, for example, if a second sentence in a document actually follows (for example, is directly below) a first sentence in the document. This helps the encoder/decoder block(s) 1506 understand the context across all the elements of a document, not just within a single element. Using both of these together, the encoder/decoder block(s) 1506 derives a good understanding of natural language.

In some embodiments, during pre-training, the input to the encoder/decoder block(s) 1506 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 1502). At the output side is the binary output for the next sentence prediction. For example, this component may output 1, for example, if masked sentence 2 followed (for example, was directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 1502) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 1501) that is encoded into a vector (for example, first sentence, second sentence, and so forth, assuming a top-down and right-to-left approach). The position embeddings are vectors that represent the position of a particular word in such a sentence that can be produced by positional encoder 1504. When these three embeddings are added or concatenated together, an embedding vector is generated that is used as input into the encoder/decoder block(s) 1506. The segment and position embeddings are used for temporal ordering since all of the vectors are fed into the encoder/decoder block(s) 1506 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 1506 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 1506 processing the inputs 1502 and/or 1528 in order to make the predictions and generate a prompt response, as indicated in 1504. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving a more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

In some embodiments, the inputs 1501 additionally or alternatively include other inputs, such as the inputs to machine learning models described the embodiment disclosed herein. Alternative to prompt engineering, certain embodiments of inputs represent inputs provided to the encoder/decoder block(s) 1508 at runtime or after the model 1500 has been trained, tested, and deployed. Likewise, in these embodiments, the predictions in the output 608 represent predictions made at runtime or after the model 1500 has been trained, tested, and deployed.

With reference to FIG. 16, an example computing device is provided and referred to generally as computing device 1600. The computing device 1600 is but one example of a suitable computing environment and is not intended to suggest any limitation as to the scope of use or functionality of embodiments of the disclosure, and nor should the computing device 1600 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated within the embodiments of the present disclosure.

With reference to FIG. 16, computing device 1600 includes a bus 1610 that directly or indirectly couples the following devices: memory 1612, one or more processors 1614, one or more presentation components 1616, one or more input/output (I/O) ports 1618, one or more I/O components 1620, and an illustrative power supply 1622. In one example, bus 1610 represents one or more buses (such as an address bus, data bus, or combination thereof). Although the various blocks of FIG. 16 are shown with lines for the sake of clarity, in reality, these blocks represent logical, not necessarily actual, components. For example, a presentation component includes a display device, such as an I/O component. Also, processors have memory. It is recognizes that such is the nature of the art and reiterate that the diagram of FIG. 16 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 16 and with reference to “computing device.

With continued reference to FIG. 16, computing device 1600 includes a bus 1610 that directly or indirectly couples the following devices: memory 1612, one or more processors 1614, one or more presentation components 1616, input/output (I/O) ports 1618, I/O components 1620, an illustrative power supply 1622, and a radio(s) 1624. Bus 1610 represents what may be one or more busses (such as an address bus, data bus, or combination thereof). Although the various blocks of FIG. 16 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 16 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 16 and refer to “computer” or “computing device.”

Computing device 1600 typically includes a variety of computer-readable media. Computer-readable media can be any available media that can be accessed by computing device 1600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1612 includes computer storage media in the form of volatile and/or nonvolatile memory. The memory 1612 may be removable, non-removable, or a combination thereof. Exemplary memory includes solid-state memory, hard drives, and optical-disc drives. Computing device 1600 includes one or more processors 1614 that read data from various entities such as bus 1610, memory 1612, or I/O components 1620. Presentation component(s) 1616 present data indications to a user or other device. Exemplary presentation components 1616 include a display device, speaker, printing component, and vibrating component. I/O port(s) 1618 allow computing device 1600 to be logically coupled to other devices including I/O components 1620, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1600. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1600. The computing device 1600 may be equipped with depth cameras, such as stereoscopic camera systems, infrared camera systems, RGB camera systems, and combinations of these, for gesture detection and recognition. Additionally, the computing device 1600 may be equipped with accelerometers or gyroscopes that enable detection of motion. The output of the accelerometers or gyroscopes may be provided to the display of the computing device 1600 to render immersive augmented reality or virtual reality.

A computing device may include radio(s) 1624. The radio 1624 transmits and receives radio communications. The computing device may be a wireless terminal adapted to receive communications and media over various wireless networks. Computing device 1600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computer-implemented method comprising:
accessing a conversation history record;
generating a conversation representation of the conversation history record;
generating an embedding corresponding to the conversation representation thereby forming a representation embedding;
for a plurality of passages within one or more documents in a knowledge base, determining a set of passages relevant to the conversation representation, each passage having a relevance to the conversation representation based on a computed similarity of the representation embedding to an embedding corresponding to the passage;
determining a number of N documents in the knowledge base having passages in the set of passages that are most relevant to the conversation representation, the of number N documents comprising at least one document;
for each document of the N documents, determining a document-passage grouping comprising an indication of the document and an indication of each passage within the document that is in the set of passages, thereby forming N relevant document-passage groupings;
programmatically generate an answer-generation input instruction for a language model to cause the language model to produce an answer output, the answer-generation input instruction generated based at least on the conversation representation, at least a portion of the n relevant document-passage groupings, and an answer-format instruction that instructs the language model to include, in the answer output, at least a first citation corresponding to at least a first portion of the answer output that is generated using a first passage from the document-passage groupings, the first citation indicating the first passage and a first document that includes the first passage;
receiving the answer output from the language model in response to providing the answer-generation input instruction to the language model; and
causing a representation of the answer output to be presented, as an answer representation, via a user interface (UI) of a computing device.

2. The computer-implemented method of claim 1 wherein the conversation representation of the conversation history record is determined using a secondary language model by providing an input prompt that comprises an issue summarization prompt and a portion of the conversation history record.

3. The computer-implemented method of claim 1 wherein the set of passages relevant to the conversation representation includes passages having corresponding embeddings within a threshold similarity to the representation embedding.

4. The computer-implemented method of claim 1 wherein the computed similarity comprises a semantic similarity; and wherein the relevance of each passage, within the one or more documents in the knowledge base, to conversation representation represents the computed semantic similarity of the embedding corresponding to the passage and the representation embedding.

5. The computer-implemented method of claim 4 wherein the computed similarity is performed using an msmarco-distilbert-base-tas-b model if the conversation history record is in English, or a Multilingual-e5-base model if the conversation history record is in a language other than English.

6. The computer-implemented method of claim 1 further comprising:
accessing a second conversation history record;
programmatically generate a conversation-excerpt-generation input instruction for the language model to cause the language model to produce a conversation-excerpt output, the conversation-excerpt-generation input instruction generated based at least on the second conversation history record, an issue identification prompt, and a source identification prompt; and
receiving the conversation-excerpt output from the language model in response to providing the conversation-excerpt-generation input instruction to the language model;
storing the conversation-excerpt output in the knowledge base as a conversation excerpt document, wherein the one or more documents incudes the conversation excerpt document, and wherein the set of passages relevant to the conversation representation is determined using the conversation excerpt document.

7. The computer-implemented method of claim 6, wherein the issue identification prompt is configured to instruct the language model to identify a question or an issue from a portion of the second conversation history record and wherein the source identification prompt is configured to instruct the language model to identify the portion of the second conversation history record that relates to the question or the issue.

8. The computer-implemented method of claim 7, wherein the conversation-excerpt-generation input instruction further comprises a conversation-excerpt output format instruction that instructs the language model to generate the conversation-excerpt output to include the portion of the second conversation history record that relates to the question or the issue, an indication of the question or the issue, and a representation of a response provided by a customer service agent in regard to the question or the issue.

9. The computer-implemented method of claim 1 wherein the answer-generation input instruction further includes an instruction directing the language model to use the at least a portion of the N document-passage groupings to generate the answer output that is responsive to the conversation representation and based on the answer-format instruction.

10. The computer-implemented method of claim 1 wherein the UI includes a first UI element presenting aspects of the conversation history record and a second UI element presenting the answer representation, the second UI element is positioned proximate the first UI element enabling presentation of the answer representation concurrent with presentation of aspects of the conversation history record.

11. The computer-implemented method of claim 1:
wherein the conversation history record is updated during an occurrence of a conversation, thereby creating an updated conversation history record;
wherein the computer implemented method of claim 1 is repeated using the updated conversation history record as the conversation history record to receive an updated answer output as the answer output from the language model; and
causing presentation, via the user interface, of a representation of the updated answer output in place of the answer representation.

12. The computer-implemented method of claim 1:
wherein the conversation history record comprises one of a transcript of at least a portion of a spoken conversation between a customer service agent and a customer or a message log of at least a portion of a messaging conversation between the customer service agent and a customer;
wherein the representation embedding and each embedding of the plurality of passages is determined using Sentence-Bidirectional Encoder Representations from Transformers (SBERT); and
wherein each relevant document-passage grouping is determined from a predetermined document-passage grouping, the pre-determined document-passage grouping comprising an indication of the document and indications of each passage occurring within the document, the relevant document-passage grouping determined by removing from the predetermined passage document grouping, indications of passages that are not in the set of passages relevant to the conversation representation.

13. The computer-implemented method of claim 1:
wherein the answer-format instruction further comprises at least one of an example answer output format, an answer output template, a portion of an example answer output format, or a portion of an answer output template;
wherein the answer-format instruction instructs the language model to include, in the answer output, a corresponding citation for each portion of the answer output that is generated using a passage, from the document-passage groupings, each corresponding citation indicating the passage used to generate the corresponding portion of the answer output and indicating the document the includes the passage used to generate the corresponding portion of the answer output; and
wherein the answer-format instruction instructs the language model to:
determine a likelihood that the answer output is contained entirely within the first passage or the first document; and
based on the likelihood satisfying a confidence threshold, include, in the answer output, an indication that the answer output answers the conversation representation.

14. The computer-implemented method of claim 1:
wherein the conversation history record includes at least three and less than ten conversation parts;
wherein the set of passages relevant to the conversation representation comprises between twenty and fifty passages that are ranked in order of relevance to the conversation representation;
wherein the number of N documents is determined based on properties of the language model used to generate the answer output;
wherein the at least the portion of the N document-passage groupings is determined based on a target token length;
wherein the target token length is determined using an LLM tokenizer configured for the language model;
wherein the answer-format instruction instructs the language model to include, in the answer output, an indication of a likelihood that the answer output is contained entirely within the first passage or the first document; and
wherein the answer output further includes visualization instructions for presenting the answer representation.

15. A computer system comprising:
at least one computer processor;
computer memory having instructions embodied thereon that when executed by the at least one processor perform operations comprising:
access a conversation history record;
generate a conversation representation of the conversation history record;
generate an embedding corresponding to the conversation representation thereby forming a representation embedding;
for a plurality of passages within one or more documents a knowledge base, determine a set of passages relevant to the conversation representation, each passage having a relevance to the conversation representation based on a computed similarity of the representation embedding to an embedding corresponding to the passage;
determine a number of N documents in the knowledge base having passages in the set of passages that are most relevant to the conversation representation, the of number N documents comprising at least one document;
for each document of the N documents, determine a document-passage grouping comprising an indication of the document and an indication of each passage within the document that is in the set of passages, thereby forming N relevant document-passage groupings;
programmatically generate an answer-generation input instruction for a language model to cause the language model to produce an answer output, the answer-generation input instruction generated based at least on the conversation representation, at least a portion of the n relevant document-passage groupings, and an answer-format instruction that instructs the language model to include, in the answer output, at least a first citation corresponding to at least a first portion of the answer output that is generated using a first passage from the document-passage groupings, the first citation indicating the first passage and a first document that includes the first passage;
receive the answer output from the language model in response to providing the answer-generation input instruction to the language model; and
cause a representation of the answer output to be presented, as an answer representation, via a user interface (UI) of a computing device.

16. The system of claim 15, wherein the operations further comprise:
for each document having passages in the set of passages relevant to the conversation representation, determine a document relevance representing the relevance of the document to the conversation representation, the document relevance determined based on the relevance of each passage within the document that is in the set of passages; and
wherein the number of N documents comprises the number of N documents having the highest document relevance.

17. The system of claim 15, wherein the first citation includes a direct link to the location of the first passage within the first document comprising a hyperlink, anchor link, URL, or pointer.

18. The system of claim 15, wherein the answer-format instruction instructs the language model to include, in the answer output and associated with the first citation, source information regarding the first document, and wherein the source information indicates a type of document, creation date of the document, a last modification date of the document, whether the document is internal or accessible to a customer, an indication of the number of times the document has been previously cited in past answer outputs, or a user-feedback rating based on prior occurrences of the document's passages in past answer outputs.

19. The system of claim 15, wherein the operations further comprise:
access a second conversation history record;
programmatically generate a conversation-excerpt-generation input instruction for the language model to cause the language model to produce a conversation-excerpt output, the conversation-excerpt-generation input instruction including a conversation-excerpt output format instruction and generated based at least on the second conversation history record, an issue identification prompt, and a source identification prompt;
receive the conversation-excerpt output from the language model in response to providing the conversation-excerpt-generation input instruction to the language model; and
store the conversation-excerpt output in the knowledge base as a conversation excerpt document, wherein the one or more documents incudes the conversation excerpt document, and wherein the set of passages relevant to the conversation representation is determined using the conversation excerpt document,
wherein the issue identification prompt is configured to instruct the language model to identify a question or an issue from a portion of the second conversation history record,
wherein the source identification prompt is configured to instruct the language model to identify the portion of the second conversation history record that relates to the question or the issue, and
wherein the conversation-excerpt output format instruction instructs the language model to generate the conversation-excerpt output to include the portion of the second conversation history record that relates to the question or the issue, an indication of the question or the issue, and a representation of a response provided by a customer service agent in regard to the question or the issue.

20. Non-transitory computer storage media having computer-executable instructions embodied therein that, when executed by at least one computer processor, cause the at least one computer processor to perform operations comprising:
access a first and a second conversation history record;
generate a conversation representation of the first conversation history record;
generate a first embedding corresponding to the conversation representation thereby forming a representation embedding;
programmatically generate a conversation-excerpt-generation input instruction for a language model to cause the language model to produce a conversation-excerpt output, the conversation-excerpt-generation input instruction generated based at least on the second conversation history record, an issue identification prompt, and a source identification prompt;
receiving the conversation-excerpt output from the language model in response to providing the conversation-excerpt-generation input instruction to the language model;
generate a second embedding corresponding to the conversation-excerpt output thereby forming a conversation-excerpt embedding;
determining that the conversation-excerpt output is relevant to the conversation representation based on a computed similarity of the representation embedding to the conversation-excerpt embedding;
programmatically generate an answer-generation input instruction for the language model to cause the language model to produce an answer output, the answer-generation input instruction generated based at least on the conversation representation, conversation-excerpt output, and an answer-format instruction that instructs the language model to include, in the answer output, at least a citation corresponding to at least a first portion of the answer output that is generated using conversation-excerpt output, the citation indicating at least a portion of the second conversation history record;
receive the answer output from the language model in response to providing the answer-generation input instruction to the language model; and
cause a representation of the answer output to be presented, as an answer representation, via a user interface (UI) of a computing device.
